(19) United States
(12) Patent Application Publication
(10) Pub. No.: US 2015/0161331 A1
(43) Pub. Date: Jun. 11, 2015

(54) COMPUTATIONAL MEDICAL TREATMENT PLAN METHOD AND SYSTEM WITH MASS MEDICAL ANALYSIS

(71) Applicant: Mark OLEYNIK, Monaco (MC)

(72) Inventor: Mark OLEYNIK, Monaco (MC)

(21) Appl. No.: 14/558,706

(22) Filed: Dec. 2, 2014

Related U.S. Application Data
(60) Provisional application No. 62/059,588, filed on Oct. 3, 2014.
(60) Provisional application No. 61/977,512, filed on Apr. 9, 2014.
(60) Provisional application No. 61/946,339, filed on Feb. 28, 2014.
(60) Provisional application No. 61/911,618, filed on Dec. 4, 2013.

(51) Int. Cl. G06F 19/00

(52) U.S. Cl. CPC G06F 19/322; G06F 19/3443; G06F 19/345

(57) ABSTRACT

The present disclosure is directed toward global medical data analysis methods, systems, and computer program products for analyzing, classifying, and matching mass amounts of medical information from many sources and across different regions. The global medical data analysis system includes a medical main server that contains an intelligent medical engine, which is communicatively coupled to a central database, a confidential electronic medical records database, and further communicatively coupled through a network to hospitals, clinics, and other medical sources. The intelligent medical engine receives voluminous medical record, potentially from different countries, regions, and continents. Electronic Medical records are sourced from hospitals, clinics, and other medical sources, which are fed into the intelligent medical engine for large-scale analysis and correlation of patients' medical records globally. The analysis starts by degrouping (classifying) medical records into multiple levels of subgroups according to patient clinical parameters, disease templates, treatments and outcomes. When a new patient enters the system, that patient's parameters and disease template are matched against the closest subgroups to suggest treatments with potentially favorable outcomes.

### CROSS REFERENCE TO RELATED APPLICATIONS

This application claims priority to U.S. Provisional Application Ser. No. 62/059,588 entitled “Method and System for Intelligence Mass Medical Analysis,” filed on 3 Oct. 2014, U.S. Provisional Application Ser. No. 61/977,512 entitled “Method and System for Intelligence Mass Medical Analysis,” filed on 9 Apr. 2014, U.S. Provisional Application Ser. No. 61/946,339 entitled “Method and System for Intelligence Mass Medical Analysis,” filed on 28 Feb. 2014, and U.S. Provisional Application Ser. No. 61/911,618 entitled “Method and System Intelligence For Mass Medical Analysis,” filed on 4 Dec. 2013, the disclosures of which are incorporated herein by reference in their entireties.

### TECHNICAL FIELD

The present invention relates generally to computer software and more particularly to software tools for analyzing voluminous electronic medical records (EMRs) or electronic health records (EHRs) sourced from numerous sources across multiple geographic regions for intelligent medical processing in optimizing the treatment of patients and in generating computer-generated medical treatment plans.

### BACKGROUND ART

Healthcare is undergoing a major transformation with technology as one of the underpinning forces. Electronic medical records have largely been segregated by different affiliated hospitals, clinics, and doctor's offices and clinics within a geographical territory and by partnership or national government regulations, not to mention the complexity in sharing patient information across geographical boundaries. In the software analytic context, these electronic medical data may be considered as unstructured data, as there are many disparate formats or and types of data that are not integrated and analyzed. The critical analysis of mass electronic medical records to determine patterns and statistical evidence associated with medical treatments and outcomes could have a huge positive impact on the treatment of patients.

Both the medical industry and patients would benefit greatly from the computerized analysis of medical records, which contain significant, real world data regarding diagnoses, treatments, and patient outcomes. Modern medical information, such as medical records, remain vastly segregated by institutions, affiliations, locations, geographies, and regions. Often, doctors will diagnose and treat a patient based on information provided by the patient and the doctor's own experience rather than on statistical evidence showing how similar patients were treated and the outcomes from such treatment. One reason for this is that doctors have relatively limited access to patient information beyond their practice and the published literature. The collective wisdom of doctors' diagnoses and recommended treatment plans on a nationwide, international, or worldwide basis has not been collected, analyzed, and used to provide an practical, evidenced based approach to treating patients.

Accordingly, it is desirable to have a system and method for computationally analyzing a mass amount of medical data from different sources across multiple geographic regions to improve the treatment of patients and develop recommended treatment plans for patients. This system and method could be used to analyze treatments and medical outcomes for patients with particular diseases, which would allow doctors to base their treatment decisions on computational and statistical evidence showing how similar patients were treated and the outcomes from such treatment.

### SUMMARY OF THE DISCLOSURE

Embodiments of the present disclosure are directed to computer-intensive probabilistic global medical data methods, systems, and computer program products for optimizing a patient treatment plan for a particular symptom, disease, or patient profile by analyzing, classifying, and matching and degrouping a mass amount of electronic medical records from a large array of medical sources in the same region or across different geographical regions. The global medical data analysis computer system comprises a medical main server that includes an intelligent medical engine for optimizing the treatment plan process. The global medical data analysis computer system is communicatively coupled to a central database, a confidential personal database, and further communicatively coupled through a network to one or more of the following: hospitals, academic medical centers, clinics, and other sources of medical data. The intelligent medical engine may receive voluminous medical records globally from different countries, regions, and continents. The electronic medical records, which are sourced from hospitals, academic medial centers, clinics, and other medical sources around the world, are fed into the intelligent medical engine for large-scale computational analysis and correlation with one or more of patients' medical records. The intelligent medical engine includes a store module, an analytical module, a classification component, a matching module, a learning module, an input data module, and a display module. The intelligent medical engine incorporates a learning module for interactively processing and learning of the patient's and other electronic medical records and the prescribed treatment plans over time for optimizing the recommended treatment protocol.

The intelligent medical engine is configured for degrouping (also referred to as “filtering”) of a patient's symptom, disease, or patient profile against a large amount of electronic medical records. Degrouping means finding meaningful subgroups (subsets) of a group of patients which share the same or similar values on one or more clinical parameters and who have the same or similar medical outcome to a given treatment. In one embodiment, the filtering process, or degrouping process, comprises multiple levels of filters as a mechanism to reduce the number of related electronic medical records into smaller subgroups whose members share at least some clinical parameters, diseases, and/or treatment outcomes. For example, the degrouping of the existing electronic medical records against a patient's electronic medical record (including symptoms or disease) can include a first level filter using one or more significant parameters associated with the patient's disease to produce one or more first subgroups of similarly matched electronic medical records. At the second level filter, as a method to further reduce the number in the one or more first subgroups, the degrouping method filters the one or more first subgroups against the patient's electronic medical records by using side disease, chronic disease, complication parameters to produce one or more second subgroups (which may be equal but typically less than the first subgroup) of similarly matched patient electronic records. At the third level filter, the degrouping method further filter the one or more second subgroups by using the third set of parameters to produce one or more third subgroups (which may be equal but typically less than the second subgroup). At the fourth level filter, the degrouping method could further scale down the number of electronic medical records in the one or more third subgroups by using the fourth set of parameters, such as lifestyle parameters, (e.g., eating habits, exercise routine, smoker, overweight, stress, etc.) to produce one or more fourth subgroups (which may be equal but typically less than the third subgroup) of similarly matched patient electronic records. Additional degrouping levels are possible to reduce the number of similar matching subgroups to produce a desirable number in the subgroup relative to the patient's particular disease or symptoms in order to create a computer-generated the treatment protocol based on the computational analysis if the medical data. In general, degrouping results in a smaller set of items than those before the degrouping operation as additional criteria are added which have to be met by the items in the degrouped subset.

Degrouping methods can be implemented with respect to significant and indirect variables (also referred to as “parameters”), variables over a period of time (on a two-dimensional graph), two or three-dimensional images (e.g., X-Ray, MRI, CT scan images), or any combination of the above. In one embodiment, a degrouping method filters other patients' objective medical data from a database with a particular patient's objective medical data by using significant variables at a first level degrouping and indirect variables at a second level degrouping. In another embodiment, another degrouping method compares how the significant parameters evolve over time associated with a patient's objective medical data with other patients' objective medical data on the same significant parameter over the same period of time. Any meaningful deviation from one of the significant parameters over a specified time period, between the patient's objective medical data and other objective medical data, may provide the basis for degrouping that particular subgroup from the patient's objective medical data. In a further embodiment, an alternate degrouping method filters subgroups by comparing the patient's objective medical data, which includes illustrating the significant parameters in three-dimensional organ images, with other patients' objective medical data, which includes illustrating the significant parameters in three-dimensional organ images.

The collection and analysis of mass amount of patients' objective medical data, wherein each of a patient's objective medical data can include a standardized electronic medical record without the patient's confidential information, such as a social security number. The use of objective medical data also alleviates some privacy concerns because a person's confidential information is not revealed. The standardization of objective medical data enables the intelligent medical engine to process, correlate, analyze, and match voluminous electronic medical data sourced from medical hospitals, academic medical centers, clinics, and other sources of medical data. The standardization of objective medical data refers to any structure for consistently classifying or categorizing clinical parameters in a manner allowing the objective medical data to be stored, organized, and searched in a database format. Transformation of objective medical data can occur at different junctures of the process including, for instance, when a patient's objective medical data and the associated code are transmitted from a hospital to the intelligent medical engine, during the modification of the patient's medical data in the degrouping process, etc.

Numerous real-world applications of the standardized objective medical data and degrouping method implemented on an intelligent medical engine are feasible. One application would involve a physician using the devices and method of the invention to develop a treatment plan based on the medical outcomes of other patients with the same disease and significant medical parameters. In another application, a general physician places a disease capsule at his or her office to conduct an annual or regular medical examination (or annual checkup) by having a patient lie down on a platform for moving into the disease capsule in order to perform various medical readings for subsequent use in comparing with the patient's medical data stored in the intelligent medical engine. In a second application, a wearable device is placed on a patient for monitoring and treating the patient. The wearable device has a synthetic vessel or a port that is connectable to the patient for monitoring the patient's condition, injecting medication into the patient, or extracting blood from the patient. For example, a medical device is implanted underneath the patient's skin, which has one end connected to a blood vessel and another end connected to a female connecter, where a female connecter has a surface enclosure (also referred to as a valve, which the female connector is closed when not in use) to place an external male connecter into the female connecter to extract blood. The surface enclosure ensures that the blood and other fluids are contained within the patient's body. A patient's condition is continuously monitored by the wearable device, which transmits the patient's medical conditions to the intelligent medical engine for alerting a doctor, hospital, or ambulance when necessary. Other embodiments of the wearable device include embedding one or more sensors on a garment or underwear for wireless communication with a wearable mobile device.

Broadly stated, a computer-implemented method for processing electronic medical records, comprises storing a plurality of objective medical data for a plurality of patients, each patient's objective medical data being structured into multiple elements for use in storing the objective medical data, each patient's objective medical data containing at least parameters of the patient, diseases of the patients, treatments that the patient underwent and outcomes of the treatments; degrouping the plurality of patients' objective medical data to classify the plurality of objective medical data into subgroups, the classifying step including at least one level of classifications based on each patient's parameters, disease, and treatment that each patient underwent for the disease, and the outcome of the treatment, iteratively repeating the process, once for each subgroup in each level, until a set of subgroups smaller than the previously generated subgroups are identified wherein the patients in the smaller subgroups have substantially similar clinically-relevant parameters and substantially similar outcomes; receiving a new patient's disease template with the new patient's objective medical data based on the patient's disease, the new patient's template including at least the clinically-relevant parameters of the new patient, and at least one disease of the new patient; and matching the new patient's parameters and disease to the corresponding parameters and disease of the degrouped subgroups to select the most similar ones and determine the likely outcomes of potential treatments for the new patient based on the outcomes of treatments for the patients in the subgroups.

The structures and methods of the present disclosure are disclosed in the detailed description below. This summary does not purport to define or limit the invention in any way. The invention is defined by the claims. These and other embodiments, features, aspects, and advantages of the invention will become better understood with regard to the following description, appended claims, and accompanying drawings.

### BRIEF DESCRIPTION OF THE DRAWINGS

The invention will be described with respect to specific embodiments thereof, and reference will be made to the drawings, in which:

FIG. 1 is a global medical data analysis system for receiving, analyzing, correlating, and generating a large volume of patients' medical records and treatments in accordance with the present disclosure.

FIG. 2 is a software system diagram illustrating the intelligent medical engine in the medical main server that provides computing power to process, analyze, classify, match, and learn voluminous objective medical data from various medical sources across multiple geographical regions in accordance with the present disclosure.

FIGS. 3A-B are block diagrams illustrating the process utilized by the intelligent medical engine to analyze, classify, match and degroup objective medical data in accordance with the present disclosure; and FIG. 3C is a pictorial diagram illustrating the multiple levels of the degrouping process in accordance with the present disclosure.

FIG. 4A is a pictorial diagram illustrating the multiple levels of the degrouping process into subgroups with respect to FIGS. 3A-B in accordance with the present disclosure; FIG. 4B is an exemplary menu for executing the degrouping process by comparing a patient's template with subgroups of other patients' objective medical data with multiple levels of filtering with a different set of parameters in accordance with the present disclosure; FIG. 4C is a block diagram illustrating changes in one or more subgroups' significant parameters and the treatment outcome as a response to different treatment protocols; FIG. 4D is a graphical diagram illustrating the dynamics and changes of the different significant parameters for two subgroups to the same treatment protocol; and FIG. 4E is a block diagram illustrating three exemplary timeline scenarios for the same or different patient in accordance with the present disclosure.

FIG. 5 is a system diagram illustrating portable medical monitoring devices to monitor patients relative to objective medical data in accordance with the present disclosure.

FIG. 6 is an exemplary process flow of 24/7 monitoring patients relative to the objective medical data in accordance with the present disclosure.

FIG. 7A is an exemplary diagram of a wearable device for monitoring and treatment of the patient's current medical data relative to the objective medical data at the medical main server in accordance with the present disclosure; FIG. 7B is an exemplary diagram of a pair of connecting devices to access the vascular system in accordance with the present disclosure; and FIG. 7C is an exemplary diagram of an implantable port and treatment device in accordance with the present disclosure.

FIG. 8 is an exemplary diagram of an implantable device for monitoring and treatment of a patient's current medical data relative to the objective medical data at the medical main server in accordance with the present disclosure.

FIG. 9 is an exemplary diagram of a diagnosis capsule machine with unified health examination and disease diagnosis functions in accordance with the present disclosure.

FIG. 10 is a block diagram illustrating an automated process in which the intelligent medical engine receives, stores, analyzes, and classifies objective medical data with an interactive machine-learning process for optimization in accordance with the present disclosure.

FIG. 11 is a block diagram illustrating the process initiated by a medical personnel for rapidly comparing a patient's new symptom with a database with a large volume of existing objective medical data in accordance with the present disclosure.

FIG. 12 is a block diagram illustrating the process initiated by a consumer for selecting doctor objective data based on a query in accordance with the present disclosure.

FIG. 13 is a block diagram illustrating exemplary predefined searching categories with respect to FIG. 12 in accordance with the present disclosure.

FIG. 14 is a block diagram illustrating the process by a consumer to retrieve his or her own electronic medical records from any location in the world in accordance with the present disclosure.

FIG. 15 is a flow diagram illustrating the process of 24/7 monitoring patients relative to objective medical data with respect to FIG. 13 in accordance with the present disclosure.

FIG. 16 is a flow diagram illustrating the process for storing, compiling, and analyzing a patient's three-dimensional profile over time to assist a doctor in making a treatment decision based on multiple different data points in view of changing images in accordance with the present disclosure.

FIG. 17 is a flow diagram illustrating the process for storing, compiling, and analyzing key parameters in a patient's template over time to assist a doctor in making a decision based on multiple different data points in view of changes in significant parameters in accordance with the present disclosure.

FIG. 18 is a flow diagram illustrating the process sensing medical data with electronic underwear, or the textile electrodes of garments for monitoring patients relative to objective medical data in accordance with the present disclosure.

FIGS. 19A-Q illustrate an exemplary list of fields and sub-fields for a general practitioner to examine a primary patient examination protocol in accordance with the present disclosure.

FIG. 20 is an exemplary flow chart illustrating the process of standardizing clinical records in accordance with the present disclosure.

FIG. 21A is a block diagram illustrating an exemplary clinical parameter and code list for standardization of clinical records in accordance with the present disclosure; FIG. 21B is a flow diagram illustrating the process of standardization process for visual representations from a medical imaging equipment in accordance with the present disclosure; and FIG. 21C is a block diagram illustrating an exemplary clinical parameter and code list for standardization of clinical visual representation records in accordance with the present disclosure.

FIG. 22 is an exemplary structure of a standardized clinical parameter form in accordance with the present disclosure.

FIG. 23 is an exemplary standardized blank clinical parameter form in accordance with the present disclosure.

FIG. 24A is an exemplary instruction of first step to create an exemplary clinical parameter form for lung cancer in accordance with the present disclosure; FIG. 24B is an exemplary instruction of the second step to create an exemplary clinical parameter form for lung cancer in accordance with the present disclosure; FIG. 24C is an exemplary instruction of the third step to create an exemplary clinical parameter form for lung cancer in accordance with the present disclosure; FIG. 24D is an exemplary instruction of the fourth step to create an exemplary clinical parameter form for lung cancer in accordance with the present disclosure; FIG. 24E is an exemplary instruction of the fifth step to create an exemplary clinical parameter form for lung cancer in accordance with the present disclosure; FIG. 24F is an exemplary instruction of the sixth step to create an exemplary clinical parameter form for lung cancer in accordance with the present disclosure; FIG. 24G is an exemplary instruction of the seventh step to create an exemplary clinical parameter form for lung cancer in accordance with the present disclosure; FIG. 24H is an exemplary instruction of the eighth step to create an exemplary clinical parameter form for lung cancer in accordance with the present disclosure; and FIG. 24I is an exemplary instruction of the ninth step to create an exemplary clinical parameter form for lung cancer in accordance with the present disclosure.

FIGS. 25A-M are block diagrams illustrating an exemplary clinical parameter form for lung cancer in accordance with the present disclosure.

FIGS. 26A-S are block diagrams illustrating an exemplary clinical parameter form with myocardial infarction (MI) in accordance with the present disclosure.

FIGS. 27A-M are block diagrams illustrating an exemplary clinical parameter form with appendicitis in accordance with the present disclosure.

FIG. 28 is a block diagram illustrating an exemplary computing device for use in the global medical data analysis system in accordance with the present disclosure.

### DETAILED DESCRIPTION

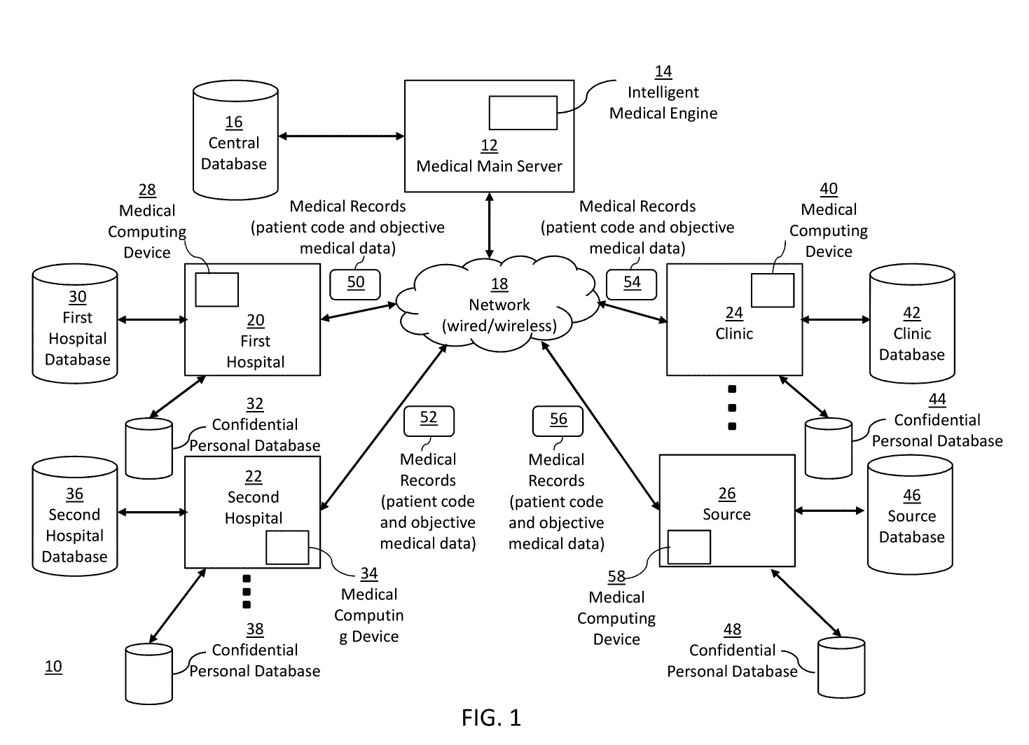

A description of structural embodiments and methods of the present invention is provided with reference to FIGS. 1-28. It is to be understood that there is no intention to limit the invention to the specifically disclosed embodiments but that the invention may be operated using other features, elements, methods, and embodiments that are known to those of skill in the art. Like elements in various embodiments are commonly referred to with like reference numerals.

The following definitions apply to the elements and steps described herein. These terms may likewise be expanded upon.

Course of Treatment—refers to a prescribed regimen, therapy, or other treatment for a patient's medical condition. The course of treatment includes the treatment protocols and treatment plans for the patient.

Degroup—refers to the method of separating a group of patients (or the electronic medical records corresponding to patients) into subgroups based on finding patients with shared values of one or more parameters (e.g. age, gender, weight, cholesterol level, blood glucose level, white-cell count, etc.) and who have resulted in the same or similar response to at least one treatment (e.g. to a statin drug treatment, or to chemotherapy regimen targeted at reducing tumor diameter, etc.).

Diagnosis—refers to any medical classification of any medical condition, infectious disease, mental illness, or other condition or illness, including chronic illnesses. Examples of diagnoses include diabetes, cancer, heart disease, atherosclerosis, stroke, etc.

Significant parameters (also referred to as “direct parameters”)—refers to parameters of each disease according to World Health Organization (WHO) classification that are known in medical field as predicting, affecting, or resulting from the treatment, prognosis, and progression of the patient's medical condition or disease.

Indirect parameters (also referred to as non-significant parameters)—refers to parameters, other than the direct parameters, of each disease according to World Health Organization classification that are relevant to disease, prognosis, and treatment of the patient's medical condition or disease.

Objective Medical Data—refers to objective data regarding a patient's medical history and medical condition. Objective medical data includes, but is not limited to, a patient's symptom, disease (if applicable), patient's profile, medical history, medical equipment examination data, lab results, lifestyle habits, but excluding information that would reveal the identity of the patient, for example, the patient's legal name, social security number, fingerprints, etc. Objective medical data can be a material part of an emerging standard like Good Data Collection and Recording Practice (GDCRP).

Patient Disease Template—refers to a collection of the parameters relevant to disease, prognosis, and treatment of a patient's medical condition(s) or disease according to the International Classification of Diseases (ICD), www.who.int/classifications/icd/en, by World Health Organization.

Recommended Treatment Protocol(s)—refers to result of processes performed by software based on one or more sets of criteria in analyzing and choosing among different selected treatment protocols.

Second Level Parameters—refers to a second set of parameters used in the degrouping process. These parameters can include parameters relating to potential or actual complications associated with a disease, parameters relating to side or chronic diseases, parameters relating to other medical conditions or diseases of the patient, and parameters relating to cellular and genetic markers of a medical condition or disease (e.g., tumor markers, genetic markers, particular molecules expressed by particular cell lines, etc.).

Standardized Clinical Form—refers to a form used to collect objective medical data for an individual patient.

Standard Treatment Protocol—refers to a medical treatment course (e.g. therapies, medications, or other treatments) generally accepted in the medical profession for the treatment of a patient with a particular disease

Treatment Plan—refers to a set of one or more treatment protocols over a period of time.

The present disclosure provides methods for compiling and storing medical records and for utilizing the electronic medical records for identifying a course of treatment for a patient based on stored data for other patients as well as diagnosing, treating, and/or monitoring the patient's medical conditions and disease. In the invention, the electronic medical records can be accessed easily and instantly by health care providers globally. The electronic medical records enable health care providers to develop treatment plans for patients, reduce misdiagnosis, improve quality of service, improve medical outcomes of patients, and control medical costs.

The present disclosure involves methods of obtaining, assembling, utilizing, and storing medical records of patients that can be accessed by health care providers and patients globally with ease. The electronic medical records are sortable and searchable electronically and instantaneously. The compiled medical records enable health care providers to diagnose, treat, and/or monitor or track medical diseases or conditions of various patients. Moreover, the patients can access their information and monitor their conditions.

The present disclosure provides a method for diagnosing and identifying an appropriate course of treatment for a patient. The method includes obtaining and inputting information regarding a patient's existing symptoms into the computer system. In one embodiment, the disease and course of treatment are based on the patient's existing symptoms and conditions entered into the computer system and the patient's medical history already in the computer system and on stored data for other patients with similar medical history, symptoms, and diseases. The computer system outputs the disease and recommended course of treatment based on the entered information and the iterative process of comparing with stored objective medical data obtained for other patients. The computer system can generate output information that requires further analysis, request additional information and/or medical tests, as well as requiring inputting information by consulting other health care providers or specialists.

New medical procedures are often developed for treating patients that can at a minimum improve a patient's quality of life during the course of treatment, if not treat and cure the patient. However, new medical procedures are not acceptable unless there is data to support their effectiveness. Such data can be compiled and stored in the computer system and made accessible to all health care providers. The data would be considered supporting evidence of effectiveness of a new medical procedure for consideration by other health care providers for use in treating other patients.

The present disclosure provides a method of monitoring and/or tracking a patient's symptoms, diseases, and the progress with a course of treatment prescribed by the health care provider. When a patient begins a treatment plan, it is necessary to monitor the patient to assess the patient's response to the treatment plan. Sometimes it is necessary to monitor the patient to determine whether the patient is allergic to a therapeutic agent. Alternatively, when a disease cannot be made or a course of treatment cannot be identified without additional medical information from a patient, it is necessary to monitor and/or track a patient's symptoms or conditions, so that an appropriate disease can be made and/or a course of treatment can be identified. The patient's information can be entered and accessed instantaneously by the patient. As an example, a patient with cardiovascular disease can obtain his blood pressure daily and enter it into the computer system and a health care provider can easily access the blood pressure of the patient. Also, once a course of treatment has been identified, the health care provider can easily access the blood pressure of a patient during the entire course of treatment.

Often during the course of treatment, a patient may be treated by various health care providers. For example, a patient may be seen by a primary physician, a specialist, a specialist at a specialized hospital, and a physician for follow-up care or at a rehabilitation center. In one embodiment, the present disclosure provides a method of accessing the entire medical history of the patient by any health care provider or the patient directly and instantly.

During the course of treatment, the information collected relating to a patient's condition at each visit to a health care provider's office is entered into the computer system and stored. In another embodiment, the present disclosure provides a method of monitoring a patient's progress and quality of life through the course of treatment by any health care provider. The disclosed method maximizes the capture of data and reduces the loss of data during the course of treatment, which enables enhanced follow-up care and improves quality of life and medical outcomes for the patient.

The present disclosure provides methods of assessing the risk of a subject/patient in developing a disease or condition in the future or in having a disease or condition recur during or after treatment (with time). Information, such as family medical history and subject's medical history can be inputted into the computer system for estimating the subject's risk for developing a disease or condition in the future. Based on the assessment, the health care provider can recommend a specific therapeutic agent, a change in diet, weight loss, and exercise for preventing the development of the disease or condition. For example, an asymptomatic subject with a family history of heart disease, is characterized as follows: high blood pressure, a high total cholesterol level (over 370 mg/dl (milligrams per deciliter)), a high LDL level (above 100 mg/dl), and a high triglyceride level (above 100 mg/dl), and overweight. These factors are inputted into the computer system as parameters for iterative comparison with the stored data of similar patients. The computer system can estimate the risk of the asymptomatic subject in developing a heart disease in the future. The computer system compares the information of the asymptomatic subject with the medical information of other patients with similar factors and through the process of degrouping provides an estimate of risk of the subject in developing a heart disease. Based on the risk assessment, the health care provider can recommend taking Lipitor or other cholesterol lowering medication and changing lifestyle, such as exercising and reducing the amount of cholesterol consumed in the subject's diet.

The present disclosure also provides methods of assessing a patient's prognosis as the patient's medical data is inputted into the computer system while undergoing treatment. The patient's medical data is compared with information of other patients and through the process of degrouping provides the prognosis of the patient's disease or condition. Likewise, the present disclosure provides methods of assessing the recurrence of a patient's disease or condition during or subsequent to treatment. The patient is monitored, and the patient's medical information is inputted into the computer system regularly, compared with the medical information of other patients, and through the process of degrouping, an assessment of the recurrence of potential disease or condition is provided. As an example, a cancer patient in remission may be monitored by the methods provided herein and assessed for recurrence of cancer with time.

The methods provided herein can be dynamic in that the patient's medical data can be gathered and inputted into the computer system regularly for comparison with the medical information of other patients. Through the process of regular degrouping, the treatments for the patient can be modified to provide the optimal course of treatment.

The methods described herein can be used to diagnose, treat, identify a course of treatment for and/or monitor any medical disease or condition. Examples of such medical diseases or conditions include, but are not limited to, allergies, autoimmune diseases, bacterial diseases, viral diseases, endocrine diseases, cancer, cardiovascular diseases, pregnancy, psychological and mental disorders, and neurological diseases. Examples of specific diseases conditions include but are not limited to cholera, diphtheria, lyme disease, tetanus, tuberculosis, typhoid fever, hepatitis, measles, mumps, ebola, dengue fever, yellow fever, Addison's disease, hyperthyroidism, lupus, septic shock, hemodynamic shock, malaria, inflammatory bowel diseases (IBDs) such as Crohn's disease and ulcerative colitis, inflammatory bone diseases, mycobacterial infections, meningitis, fibrotic diseases, ischemic attack, transplant rejection, atherosclerosis, obesity, diseases involving angiogenesis phenomena, autoimmune diseases, osteoarthritis, rheumatoid arthritis, ankylosing spondylitis, juvenile chronic arthritis, multiple sclerosis, HIV, non-insulin-dependent diabetes mellitus, allergic diseases, asthma, chronic obstructive pulmonary disease (COPD), stroke, ocular inflammation, inflammatory skin diseases, psoriasis, atopic dermatitis, psoriatic arthritis, bipolar disorder, schizophrenia, cold, and flu.

Examples of cancer include but are not limited to lung cancer, breast cancer, leukemia, prostate cancer, ovarian cancer, pancreatic cancer, liver cancer, skin cancer, and colon cancer.

Examples of neurological diseases include but are not limited to Alzheimer's disease, Parkinson's disease, Parkinsonian disorders, amyotrophic lateral sclerosis, autoimmune diseases of the nervous system, autonomic diseases of the nervous system, dorsal pain, cerebral edema, cerebrovascular disorders, dementia, nervous system nerve fiber demyelinating autoimmune diseases, diabetic neuropathies, encephalitis, encephalomyelitis, epilepsy, chronic fatigue syndrome, giant cell arteritis, Guillain-Barre syndrome, headaches, multiple sclerosis, neuralgia, peripheral nervous system diseases, polyneuropathies, polyradiculoneuropathy, radiculopathy, respiratory paralysis, spinal cord diseases, Tourette's syndrome, central nervous system vasculitis, and Huntington's disease.

FIG. 1 is a global medical data analysis system 10 for receiving, analyzing, correlating, and generating a large volume of patients' medical records and treatments. The global medical data analysis system 10 comprises a medical main server 12 that includes an intelligent medical engine 14, which is communicatively coupled to a central database 16, and further communicatively coupled through a network 18 to a first hospital 20, a second hospital 22, a clinic 24, and a source 26. Each of the hospitals, clinics, or medical sources is communicatively coupled to two databases: a first confidential personal database, which stores personal information, and a second database, which stores objective medical data for use by a hospital, a clinic, or a medical source. In this embodiment, a medical computing device 28 in the first hospital 20 is communicatively coupled to a first hospital database 30 and a confidential personal database 32. A medical computing device 34 in the second hospital 22 is bidirectional communicatively coupled to a second hospital database 36 and a confidential personal database 38. Additional hospitals in different counties, cities, states, countries, regions, and continents are also part of the global medical data analysis system 10 and are represented by the multiple dots in the figure. A medical computing device 40 in the clinic 24 is bidirectional communicatively coupled to a clinic database 42 and a confidential personal database 44. A medical computing device 58 in a source 26 is bidirectional communicatively coupled to a source database 46 and a confidential personal database 48. Each of the confidential personal database 32, 38, 44, 48 contains personal data (e.g., legal name, social security number, fingerprint, etc.) associated with patients. A computing device as used herein includes, but is not limited to, a desktop computer, a notebook computer, and a mobile device, such as a portable device (including a smartphone like iPhones, a mobile phone, a mobile device like iPods, a tablet computer like iPads, and a browser-based notebook computer like Chromebooks) with a processor, a memory, a screen, with connection capabilities of Wireless Local Area Network (WLAN) and Wide Area Network (WAN). The mobile phone is configured with a full or partial operating system (OS) software, which provides a platform for running basic and advanced software applications.

The intelligent medical engine 14 receives voluminous sets of electronic medical records (each medical record includes a patient code and objective medical data) 50, 52, 54, 56 globally from different countries, regions, and continents. The sets of electronic medical records 50, 52, 54, 56 are sourced from hospitals 20, 22, one or more clinics 24, and other medical sources 26 around the world, which are fed into the intelligent medical engine 14 for large-scale analysis and correlation of patients' medical records. The intelligent medical engine 14 is configured to receive one or more electronic medical records, such as those that originated from the sets of electronic medical records 50, 52, 54, and/or 56. In one embodiment, each of the sets of electronic medical records 50, 52, 54, and 56 includes a code (also referred to as a “patient code”) and objective medical data. In one embodiment, objective medical data includes all of a patient's medical information with verification process and quality checking, such as a patient's symptom, disease (if applicable), patient's profile, medical history, medical equipment examination data, lab results, lifestyle habits, but excluding information that would reveal the identity of the patient, for example, the patient's legal name, social security number, fingerprints, etc. The intelligent medical engine 14 is configured to perform analytical processes on the received electronic medical records by comparing, based on a set of parameters, the electronic medical records with the data that has previously been stored in the central database 16. The outcome of the analysis can be stored in the central database 16 or sent back to a doctor, nurse, or medical personnel in the first hospital 20, the second hospital 22, the clinic 24, or the source 26.

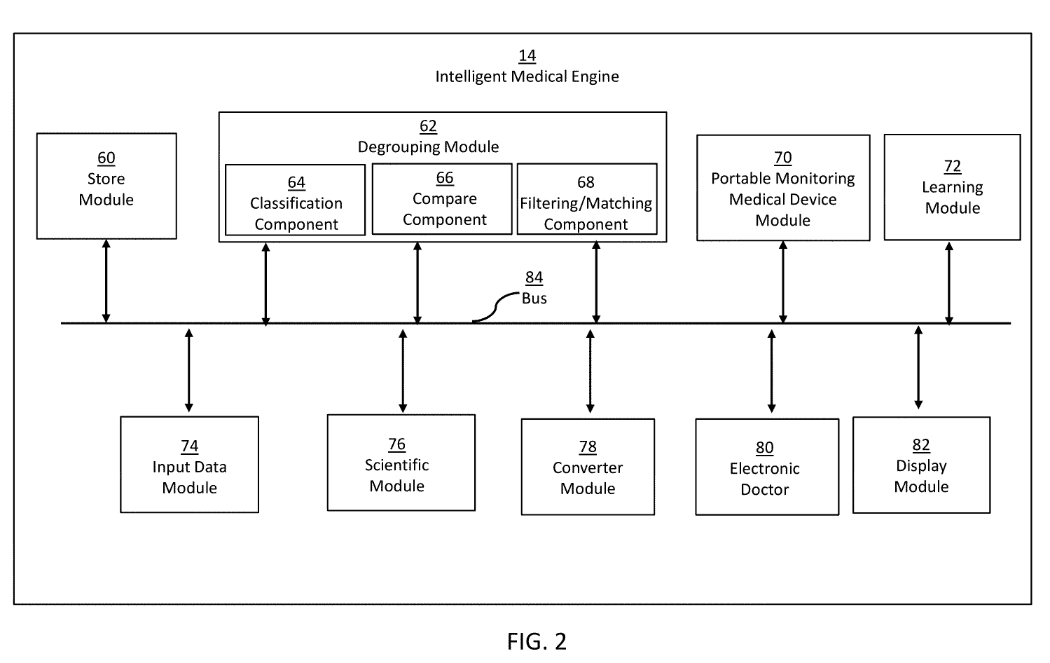

FIG. 2 is a block diagram illustrating the intelligent medical engine 14 in the medical main server 12 that provides computing power to process, analyze, classify, match, and learn voluminous objective medical data from a high number of medical sources around the world. The intelligent medical engine 14 includes a store module 60, a degrouping module 62, a portable monitoring medical device module 70, a learning module 72, an input data module 74, a scientific module 76, a converter module 78, an electronic doctor 80, and a display module 82. The degrouping module 62 is configured to degroup the electronic medical records and includes a classification component 64, a compare component 66, a matching component 68 (also referred to as “filtering component”. The store module 60 is configured to store objective medical data received from the first hospital 20, the second hospital 22, the clinic 24, and the source 26 in the central database 16. The classification component 64 is configured to analyze the different segments of medical records, such as the geographic location of the patient, the medical history of the patient, and the disease or symptom of the patient, significant parameters associated with the patient's disease, side or chronic parameters associated with the patient's disease, non-significant parameters associated with the patient's disease, lifestyle parameters associated with the patient's disease, and other parameters associated the patient's disease. The compare component 66 is configured to compare each patient from the received objective medical data in order to match the received patient's objective medical data with existing stored objective medical data in the central database 16. The filtering component 68 (also referred to as “matching component”) is configured to provide different levels of filtering or matching parameters between the received patient's electronic medical record (or “the patient's objective medical data”) and the mass amount of objective medical data stored in the central database 16. The learning module 72 is configured to provide a learning mechanism to the degrouping process, as well as modification of the parameters, in adjusting to the degrouping process (or algorithm) to attain the optimal treatment plan for a particular patient's electronic medical record and the associated disease. The input data module 74 is configured to receive the sets of electronic medical records 50, 52, 54, 56, and other input information, such as template protocols on standard medical treatment developed and generally accepted by medical professionals for a specific disease. In one embodiment, each electronic medical record comprises a patient disease template, which refers to a collection of the parameters relevant to disease, prognosis, and treatment of the patient's medical condition or disease. In another embodiment, each electronic medical records comprise a patient template, which refers to a computerized record of the patient's information structured into sections (a.k.a. “fields”) including at least some of: 1) patient attributes (e.g. age, gender, weight), 2) presenting symptoms (e.g. “rash”, “fever”, “abdominal pain”), 3) laboratory tests (e.g. “HDL-level” “LDL-level”, “blood glucose”, “bacterial cultures”), 4) disease/diagnoses (e.g. “influenza”, “type-II diabetes”, “pulmonary tumor”), treatment protocols (e.g. “X-radiation-therapy+dose+time”, “cyclosporine+dose+time”), 5) outcomes of treatments (e.g. “tumor-growth-in-check”, “remission”, “death”), and 6) additional clinical information. The combination of (1), (2), and (3) are often termed the patient parameters. A patient template for a specific patient may have some or all of the fields filled in. One objective of the input data module 74 is to receive medical information relating to each disease, thereby serving as a library with medical profiles for all diseases. The scientific module 76 is configured to generate a new, improved, or synthetic treatment protocol (or treatment plan). The converter module 78 (also referred to as “universal converter”) is configured to convert various types of medical record formats to achieve standardization of objective medical data. The electronic doctor 80 is configured to operate as an artificial intelligence/computer doctor that provides a patient's prognosis based on the patient's current input medical data compared to the existing data from the central database 16. The display module 82 is configured to display information into a computer display. The store module 60, the degrouping module 62 (which includes the classification component 64, the compare component 66, the filtering component 68), the portable monitoring medical device module 70, the learning module 72, the input data module 74, the scientific module 76, the converter module 78, the electronic doctor 80, the display module 82, are bidirectional and communicatively coupled to one another via a bus 84.

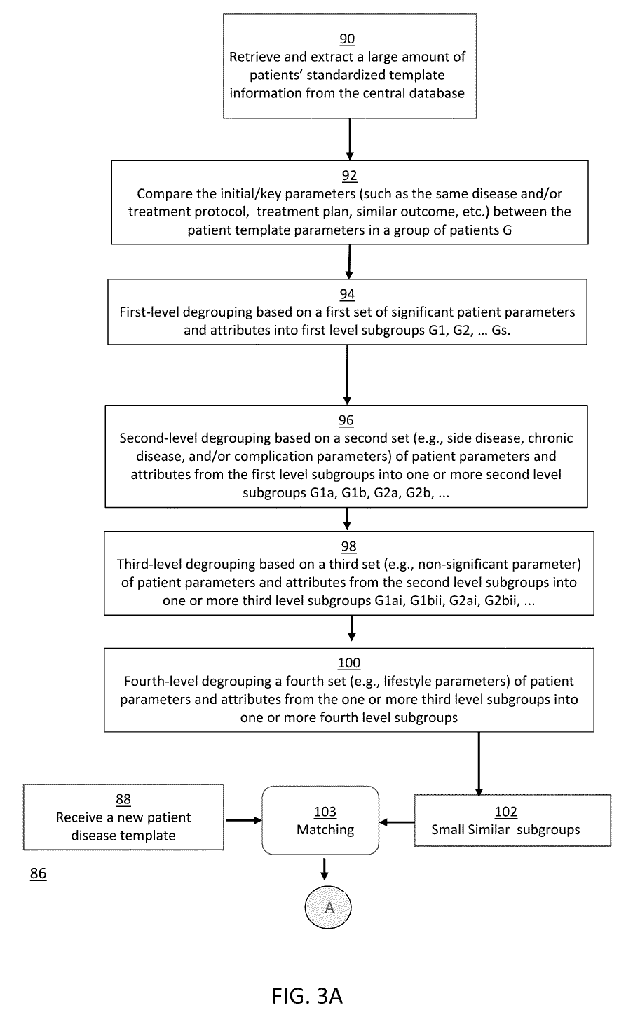

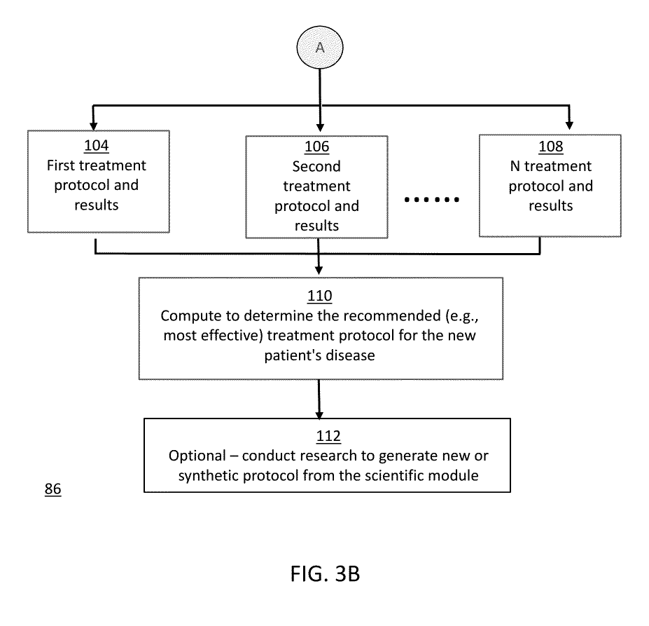

FIGS. 3A-B are block diagrams illustrating the degrouping process 86 executed by the intelligent medical engine 14 for rapidly comparing a patient's electronic medical record, such as the patient's symptom or disease, against other electronic objective medical records stored in the central database 16. In one embodiment, the mass amount of electronic objective medical records undergo a degrouping process to classify into a plurality of subgroups. At step 90, the intelligent medical engine is configured to retrieve and extract a mass amount of other patients' objective medical data (or other patients' standardized template information) stored in the central database 16. At step 92, for the mass amount of other patients' electronic objective medical records, the intelligent medical engine 14 is configured to compare some initial key parameters, such as the disease of the patient and optionally a treatment plan (or a treatment protocol) to objective medical data in the central database 16. The central database 16 stores a large volume of patients' objective medical data on a standardized format from patients globally. At step 92, the intelligent medical engine 14 is configured to compare key parameters, such as main disease with an optional treatment protocol (if applicable), from the patient template with the parameters of the objective medical data from the central database 16 and to classify into subgroups. After a population of the objective medical data from the central database 16 has been identified, the analysis to match the patient template with the selected population of the objective medical data in order to degroup into subgroups is conducted through different levels, generally from more generic characteristics to detailed characteristics, such as comparisons starting with significant parameters, side diseases, chronic diseases, complication, indirect parameters, the patient's general condition and the lifestyle of a patient, and so on. At the first level comparison in step 94, the intelligent medical engine 14 is configured to compare a first set of significant parameters (also referred to as primary parameters) between the patient template and the subgroups to degroup into one or more first level subgroups. The significant parameters may relate to, for example, one or more main diseases, such as the different stages defined in a particular disease, from the objective medical data in the subgroups as classified in step 92. Degrouping is a process used to filter one or more first subgroup(s) and refine into another one or more second subgroup(s) based on a set of parameters. At the second level degrouping in step 96, the intelligent medical engine 14 is configured to compare a second set of parameters (also referred to as secondary parameters), such as second disease parameters (including side disease, chronic disease, and complication parameters), between the patient template and the first level subgroup(s) to degroup into one or more second level subgroups, which the one or more second level subgroups represent a reduction in the number of people from the one or more first level subgroups. At the third level degrouping in step 98, the intelligent medical engine 14 is configured to compare a third set of key parameters (also referred to as tertiary parameters), such as indirect parameters, between the patient template and the one or more second level subgroup(s) to degroup into one or more third level subgroups, which the one or more third level subgroups represent a reduction in the number of people from the one or more second level subgroups. Exemplary third-level parameters include a patient's general conditions, e.g., overweight, sleep deprivation, depression, family stress, work stress, etc. At the fourth level degrouping in step 100, the intelligent medical engine 14 is configured compare a fourth set of key parameters (also referred to as quaternary parameters), such as lifestyle parameters, between the patient template and the one or more third level subgroups to degroup into one or more fourth level subgroups, which the one or more fourth level subgroups represent a reduction in the number of people from the one or more third level subgroups. Examples of quaternary parameters relate to lifestyle habits (e.g., smoking habits, drinking habits, etc.) and living conditions. These different levels of comparison in steps 94, 96, 98, 100 are used as a filter to refine the matching characteristics of the current patient template with the existing objective medical data in the subgroups as necessary. Additional levels beyond the quaternary parameters are contemplated and within the spirit of the present disclosure. At step 102, the intelligent medical engine 14 has determined, filtered, and identified a small number of objective medical data, or a small similar group from the central database 16, which has the closest matching characteristics to the parameters from the patient template. To phrase in another way, whereby the large amount of objective medical data in the central database 16 may be degrouped into a first array of groups, where the first array of groups may be further degrouped into a second array of subgroups from the first array of groups, where the second array of subgroups may be further degroup into a third array of subgroups from the second array of subgroups, and so on through steps 96, 98, and 100 until a small subgroup (or group) has been identified, which has the most similar characteristics to the patient template.

At step 88, the intelligent medical engine 14 is configured to receive and extract a particular patient's object medical data (or the patient's standardized template information) received from a sender, such as the first hospital 20, the second hospital 22, the clinic 24, or the source 26. At step 103, the intelligent medical engine 14 is configured to match the received patient disease template at step 88 and the small group with similar objective medical data in step 102 provides several different protocols that are available for possible treatment of the patient. From the small group of similar medical objective data, the intelligent medical engine 14 is configured to extract one or more treatment protocols and results, illustrated in step 104 with a first protocol and results, step 106 with a second protocol and results, and step 108 with N protocol and results. At step 110, the intelligent medical engine 14 is configured to compute and determine the most efficient protocol in each group from the different treatment protocols and results in steps 104, 106 and 108.

In an alternative embodiment, the degouping process may be executed in parallel with a patient's disease template. The intelligent medical engine 14 is configured to receive and extract a particular patient's object medical data (or the patient's standardized template information) received from a sender, such as the first hospital 20, the second hospital 22, the clinic 24, or the source 26. The intelligent medical engine 14 is configured to retrieve and extract a mass amount of other patients' objective medical data stored in the central database 16. The intelligent medical engine 14 is configured to compare some initial key parameters, such as the disease of the patient, in the patient template and with the parameters of other patient's objective medical data to select a population of the objective medical data in the central database 16 that may be relevant to the received patient's objective medical data. The central database 16 stores a large volume of patients' objective medical data on a standardized format from patients globally. The intelligent medical engine 14 is configured to compare key parameters, such as main disease with an optional treatment protocol (if applicable), from the patient template with the parameters of the objective medical data from the central database 16 and to classify into subgroups. After a population of the objective medical data from the central database 16 has been identified, the analysis to match the patient template with the selected population of the objective medical data in order to degroup into subgroups is conducted through different levels, generally from more generic characteristics to detailed characteristics, such as comparisons starting with significant parameters, side diseases, chronic diseases, complication, indirect parameters, the patient's general condition and the lifestyle of a patient, and so on. At the first level comparison, the intelligent medical engine 14 is configured to compare a first set of significant parameters (also referred to as primary parameters) between the patient template and the subgroups to degroup into one or more first level subgroups. The significant parameters may relate to, for example, one or more main diseases, such as the different stages defined in a particular disease, from the objective medical data in the subgroups as classified. Degrouping is a process used to filter one or more first subgroup(s) and refine into another one or more second subgroup(s) based on a set of parameters. At the second level degrouping, the intelligent medical engine 14 is configured to compare a second set of parameters (also referred to as secondary parameters), such as second disease parameters (including side disease, chronic disease, and complication parameters), between the patient template and the first level subgroup(s) to degroup into one or more second level subgroups, which the one or more second level subgroups represent a reduction in the number of people from the one or more first level subgroups. At the third level degrouping, the intelligent medical engine 14 is configured to compare a third set of key parameters (also referred to as tertiary parameters), such as indirect parameters, between the patient template and the one or more second level subgroup(s) to degroup into one or more third level subgroups, which the one or more third level subgroups represent a reduction in the number of people from the one or more second level subgroups. Exemplary third-level parameters include a patient's general conditions, e.g., overweight, sleep deprivation, depression, family stress, work stress, etc. At the fourth level degrouping, the intelligent medical engine 14 is configured compare a fourth set of key parameters (also referred to as quaternary parameters), such as lifestyle parameters, between the patient template and the one or more third level subgroups to degroup into one or more fourth level subgroups, which the one or more fourth level subgroups represent a reduction in the number of people from the one or more third level subgroups. Examples of quaternary parameters relate to lifestyle habits and living conditions. These different levels of comparison are used as a filter to refine the matching characteristics of the current patient template with the existing objective medical data in the subgroups as necessary. Additional levels beyond the quaternary parameters are contemplated and within the spirit of the present disclosure. The intelligent medical engine 14 has determined, filtered, and identified a small number of objective medical data, or a small similar group from the central database 16, which has the closest matching characteristics to the parameters from the patient template. To phrase in another way, whereby the large amount of objective medical data in the central database 16 may be degrouped into a first array of groups, where the first array of groups may be further sub-degrouped into a second array of subgroups from the first array of groups, where the second array of subgroups may be further degroup into a third array of subgroups from the second array of subgroups, and so on until a small subgroup has been identified, which has the most similar characteristics to the patient template. The small group with similar objective medical data provides several different protocols that are available for possible treatment of the patient associated with the patient template. From the small group of similar medical objective data, the intelligent medical engine 14 is configured to extract one or more treatment protocols and results with a first protocol and results, step with a second protocol and results, and with N protocol and results. The intelligent medical engine 14 is configured to compute and determine the most efficient protocol in each group from the different treatment protocols and results.

Optionally, the scientific module 76 in the intelligent medical engine 14 is configured to investigate and generate new or synthetic protocols to enhance the overall treatment protocols available for matching at step 112. For example, a medical company could make clinical trials or conduct some research concerning a disease to discover a new scientific protocol that can be independent or dependent on the available protocols.

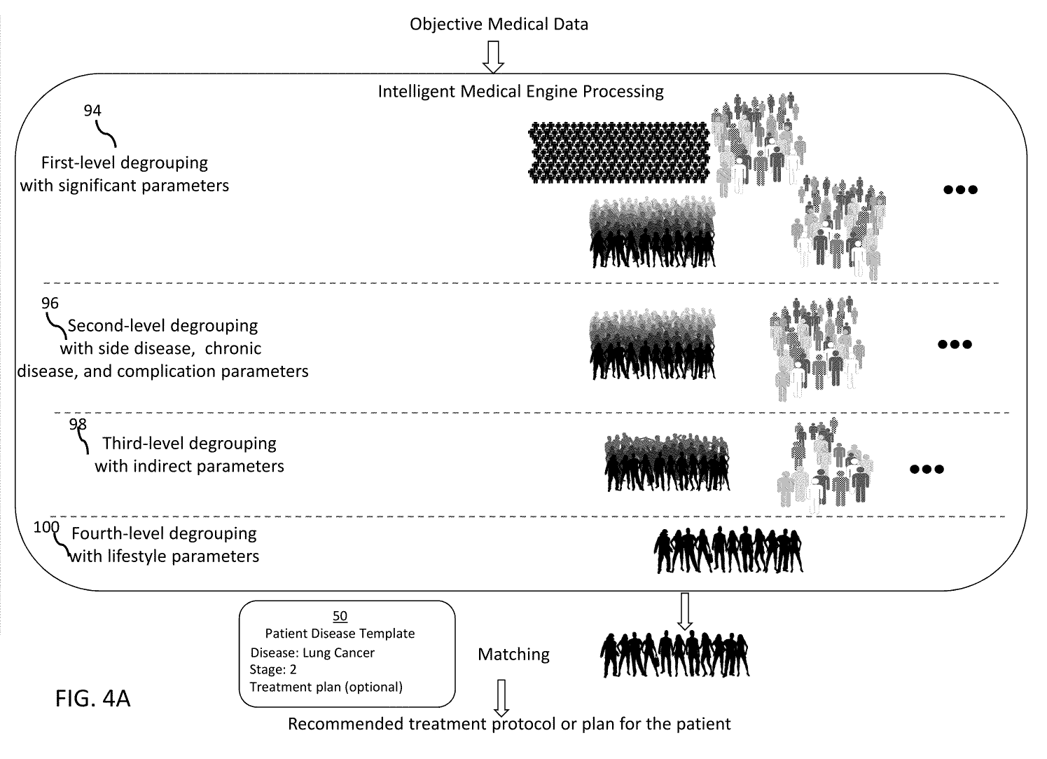

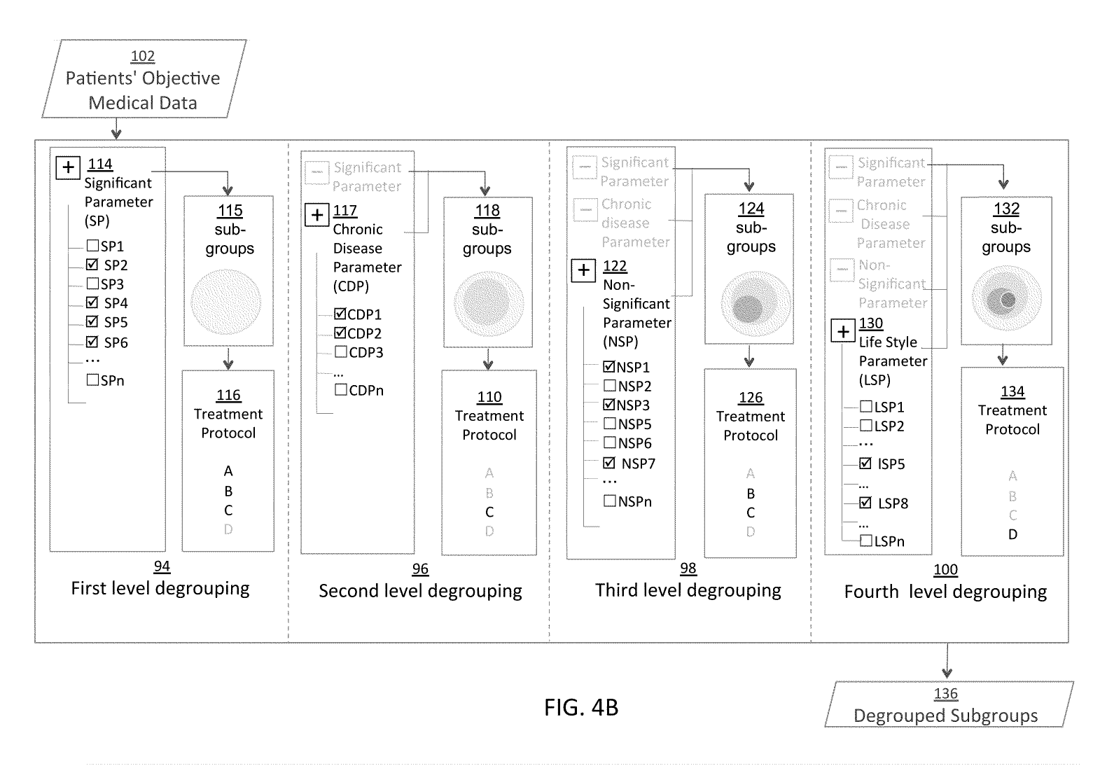

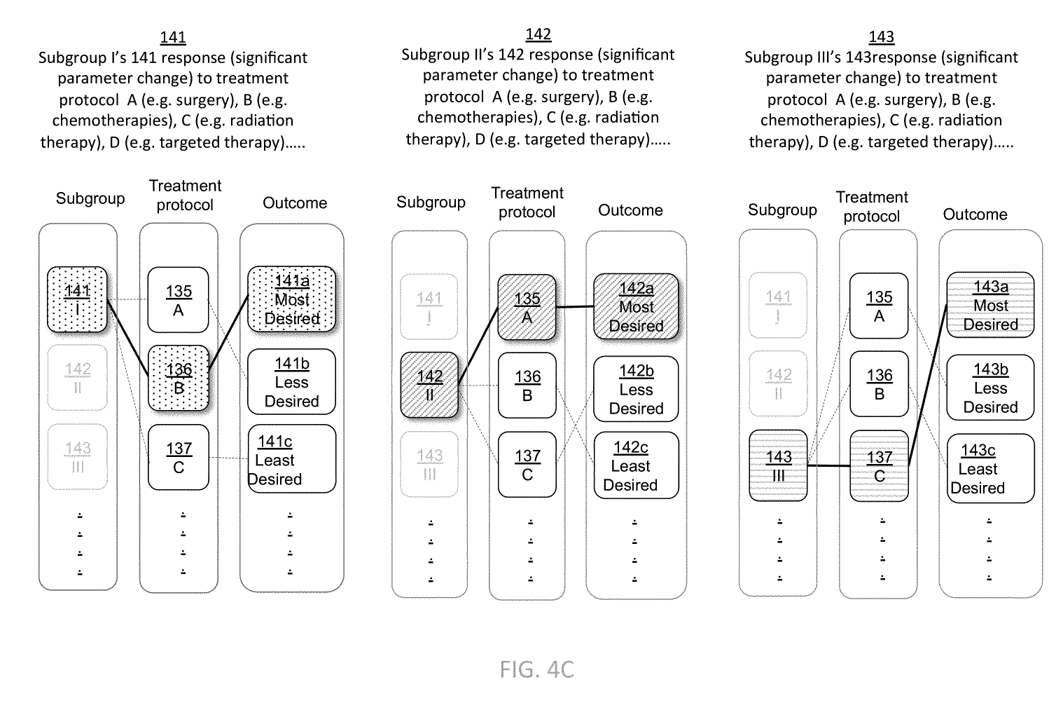

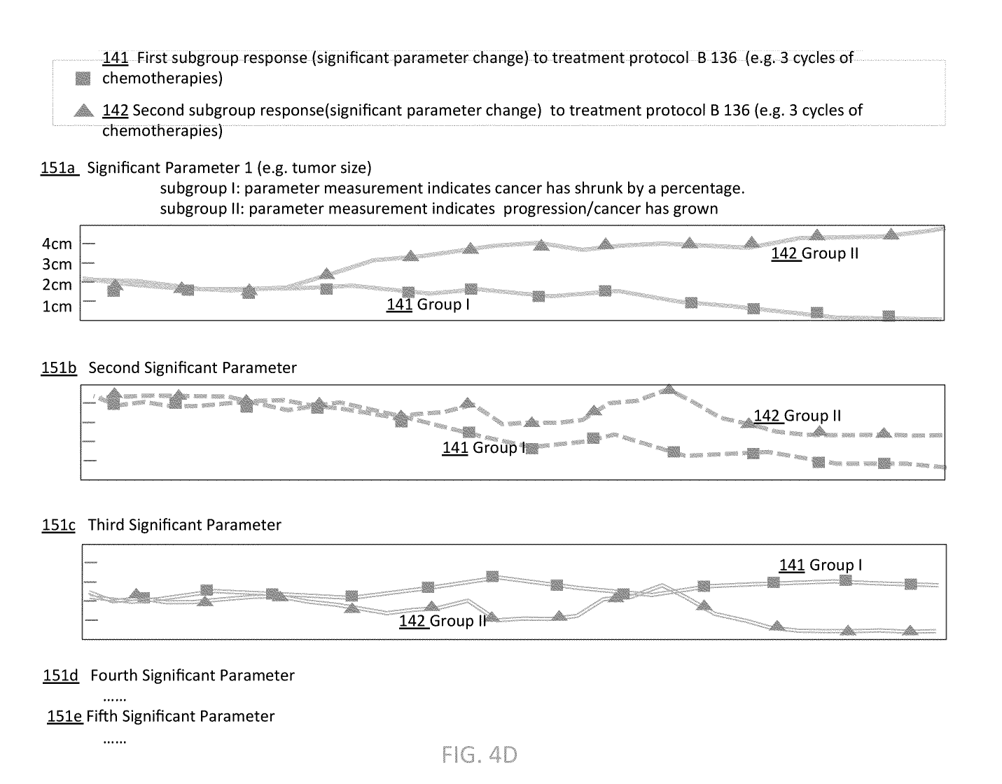

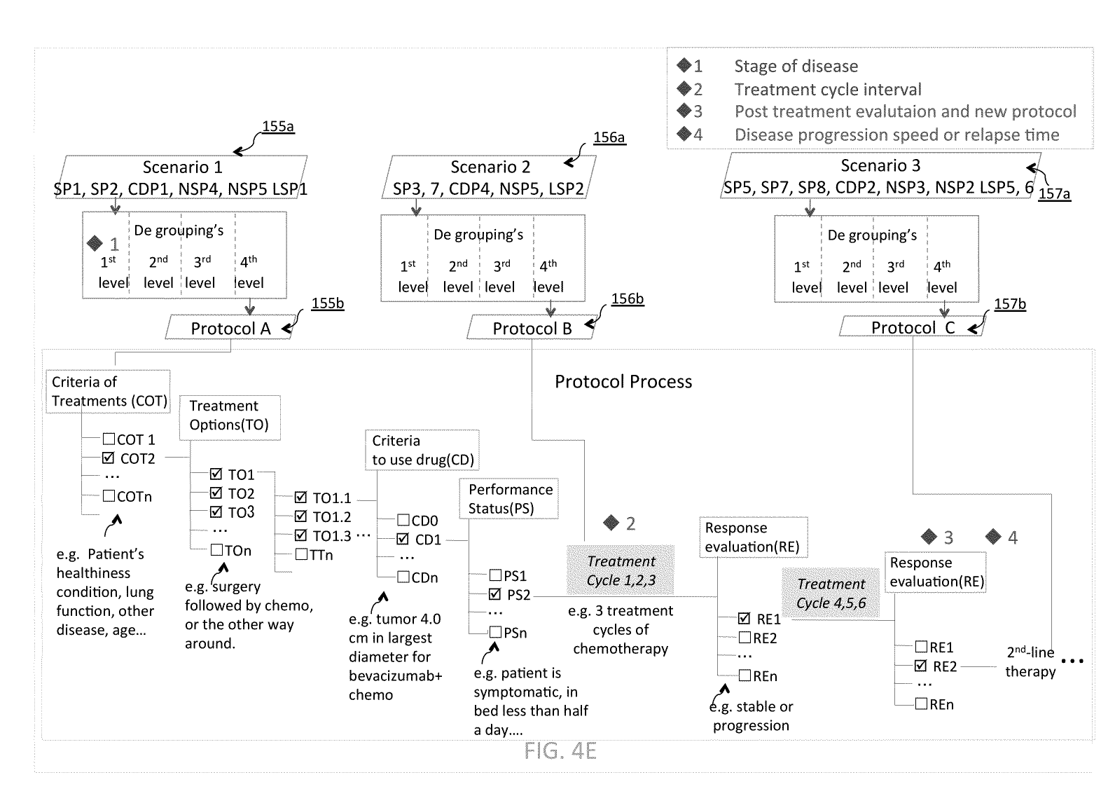

FIG. 4A is a pictorial diagram illustrating the multiple levels of the degrouping process with respect to FIGS. 3A-B. The intelligent medical engine 14 is configured to execute the computer degrouping process by providing a first level degrouping 94, a second level degrouping 96, a third level degrouping 98, and a fourth level degrouping 100 to produce one or more recommended treatment plans for the patient by drawing upon a large pool of other patients' objective medical data from the central database 16. The four-level degrouping process is intended as an illustration, but additional degrouping levels or a reduced number of degrouping levels can be practiced without departing from the spirit of the present invention.

In one embodiment, degrouping is the process of finding subsets of a population who both have common value(s) on a observable or measurable parameter(s) (e.g. age, weight, white-blood-cell count, cholesterol, etc.) and a common medical outcome to, for instance, a treatment (e.g. a statin regimen, or a particular chemotherapy). One embodiment of the invention involved automated degrouping, which requires automatically identifying the parameters that separate the group into subgroups, wherein each subgroup reacts more homogeneously to at least one particular medical treatment.

In order to perform systematic degrouping in different areas of medicine, one powerful embodiment is to rely on information theory. Consider degrouping based on a single parameter. Let G be the original (typically large) group of patients. Let A be the desired medical outcome of a treatment or procedure (e.g. tumor diameter shrinkage as a result of chemotherapy, or lowered LDL blood cholesterol level as a result of statin drug dosage). Let p be the probability of the target outcome for a typical patient in group G. The Shannon Entropy of G is defined for a group of patients G and is computed from the following equation, wherein p(t(qᵢ)=R) is the probability that a patient qᵢ receiving treatment t will have outcome R, and H(G) is the entropy of the group of patients G:

$$H ( G ) = - {\sum }_{i = 1 , … \vert G \vert} p ( t ( {q}_{i} ) = R ) {log}_{2} ( p ( t ( {q}_{i} ) = R ) ) .$$

Entropy is a measure of “disorder” or variability. The smaller the entropy the more homogenous the group. Since degrouping strives for subgroup homogeneity, the method degroups G based on the parameter that generates the most homogenous subgroups, i.e. the one that maximally reduces the entropy. For this purpose, we use conditional entropy, which is the entropy of the subgroup of G when a particular parameter x a has a value above (or below or equal to) a given threshold value.

H(G|x>thresh(x))

For instance, the above G could be all the patients over 60 years old, or all the diabetics whose average blood glucose level exceeds a medically-defined threshold x. Then, the next step is to find the parameter that maximally reduces the total entropy i.e. the sum of the entropies of the resulting subgroups, separated by virtue of the value of the selected parameter.

Mathematically, this separation process to automate the degrouping is called the information gain, which is defined as:

I(G,A)=H(G)−Argmin_{xεX}[H(G|x>thresh(x)]

In other words the degrouping process seeks the parameter x which has the greatest information gain, i.e. the greatest reduction in entropy when used as the criterion to degroup. Since there are many potential parameters of patients, a large fraction of which are recorded in their electronic medical records, the degrouping process may each one automatically to determine which produces the maximal information gain with respect to the desired medical outcome, and therefore determine which parameter degroups the original group G into the most homogenous subgroups with respect again to the medical outcome in question.

An alternate embodiment is to define multiple levels of degrouping based on selected candidate parameters ahead of time, based on clinical knowledge. In this embodiment the information gain is calculated and optimized at each level, saving computation and speeding-up the response time because only a few parameters are considered per level, namely those predefined as belonging to each level, as illustrated, for example, in FIGS. 3A-B, 4A-E, and 22-27.

A related and more comprehensive embodiment is based on an extension of the conditional Shannon entropy based on multiple patient parameters x₁, . . . xₖ as follows:

H(G|x₁>thresh(x₁), . . . ,xₖ>thresh(xₖ)

And then the information gain becomes:

I(G,A)=H(G)−Argmaxₓ_{ᵢ}_{εX}[H(G|x₁>thresh(x₁), . . . ,xₖ>thresh(xₖ)].

This extended method is computationally more complicated because in order to find a group of attributes which together optimally degroup a group of patients G different combinations of attributes must be considered. One embodiment is to consider all possible combinations of parameters up to a target number N. Another embodiment is to rely on clinical knowledge to pre-select which combinations of parameters are sensible to consider, so as to reduce the computational burden and speed up response time.

In all cases degrouping can be cascaded, that is, a group G may be degrouped into subgroups G₁, G₂ and Gs and either of these subgroups may be further degrouped, e.g. subgroup G₁ into subgroups G_{1,a} G_{1,b} and G_{1,c} and G_{2,a} G_{2,b}, respectively. The degrouping process further continues (or repeated) until sufficiently homogenous subgroups are found with respect to the medical outcomes) from one or more treatments, as illustrated in FIG. 4A. The automated degrouping cascade into smaller and more homogenous subgroups is particularly useful when explicit levels of degrouping are not provided ahead of time, or when a clinician wishes to explore multiple ways of analyzing the electronic medical data.

For example, to evaluate a patient's risk of atherosclerosis to determine treatment, a doctor would look at several blood factors (or parameters) to determine the patient's risk.
LDL—Ideally, your LDL cholesterol level should be less than 130 mg/dL (3.4 mmol/L), and preferably under 100 mg/dL (2.6 mmol/L).
HDL—your HDL cholesterol level should be 60 mg/dL (1.6 mmol/L) or higher
Triglycerides—The American Heart Association (AHA) recommends that a triglyceride level of 100 mg/dL (1.1 mmol/L)
C-Reactive protein—High risk (above 3.0 mg/L), Average risk (1.0 to 3.0 mg/L)

In one embodiment, the disease and course of treatment for a patient is obtained based on data in the system which is obtained from other patients with similar medical history, symptoms, and conditions and their success and/or failure with a specific course of treatment. Through the iterative process of comparison, classification, and degrouping of parameters inputted for the patient, the system provides a disease and course of treatment for the patient. As an example, patients diagnosed with cancer have several options for treatment, such as hormonal therapy, radiation therapy, biologically targeted therapy, chemotherapy, and surgery. However, depending on the patient's medical history, previous diagnostic test results, and the particular type of cancer, one or more of the options may not be appropriate. The methods disclosed herein enable a physician to access the information on other patients. Based on the medical information and the success rate of the course of treatments for other patients with similar medical history, symptoms, and conditions compiled in the system, a health care provider can recommend one or more suitable options for treatment to the cancer patient seeking treatment.

The iterative process used by the system involves several levels of degrouping for identifying a course of treatment including a treatment protocol or treatment plan for a patient diagnosed with a disease such as cancer. The factors and symptoms associated with a patient diagnosed with cancer are inputted as parameters into the system. Examples of the parameters associated with cancer used for the first level degrouping may include direct parameters such as: (1) the type of cancer cells; (2) the stage of the cancer; (3) the grade of the cancer, (4) and patient general condition, e.g. the Karnofsky Performance Scale Index, http://www.pennmedicine.org/homecare/hcp/elig_worksheets/Karnofsky-Performance-Status.pdf. Examples of the parameters used for the second level degrouping may include information of the cancer at the molecular level, such as the presence of specific tumor markers, and complications associated with cancer. Examples of the parameters used for the third level degrouping may include the patient's other medical conditions. Examples of the parameters used for the fourth level degrouping may include the patient's lifestyle and habits. The degrouping may be performed and stored in the computer system and may be updated periodically. The degrouping may be performed prior to or after inputting a new patient disease template into the computer system. The medical information is obtained as a patient disease template. A new patient template refers to a person who has not been processed before through the intelligent medical engine 14, or a person who has been processed before by the intelligence medical engine 14 but now has a new disease (or a new treatment plan, or a treatment protocol).

As an example, the first level parameters for breast cancer may include the tumor features such as the following: (1) invasive or in situ; (2) if invasive, whether the tumor has metastasized; (3) ductal or lobular; (4) stage (extent of tumor); and (5) grade (appearance of the cancer cells).

The exemplary second level parameters for breast cancer may include the presence of tumor markers, such as estrogen receptor (ER), progesterone receptor (PR), human epidermal growth factor receptor 2 (HER2), cancer antigen 15-3 (CA 15-3), cancer antigen 27.29 (CA 27.29), and carcinoembryonic antigen (CEA), urokinase plasminogen activator (uPA), and plasminogen activator inhibitor (PAI-1). The presence of tumor markers provides information about the tumor at a molecular level and is often used for determining the course of treatment. For illustrative purposes, the presence of ER and PR indicates that the breast cancer cells need estrogen and progesterone for growth, and that hormone therapy (blocking these hormones) may be an effective treatment. The presence of the protein HER2 in a breast cancer patient indicates that anti-HER2 (Herceptin) treatments to block HER2 may be an effective treatment. The cancer antigens, CA 15-3, CA 27.29, and CEA, are found in patients with metastatic breast cancer. A higher than normal level of uPA and PAI-1 may indicate that the cancer is aggressive.

The exemplary third level parameters for breast cancer may include the patient's general conditions such as age, personal history of breast cancer (if recurrence) and ovarian cancer, family history of breast cancer, inherited risk and genetic risk (presence of mutations in breast cancer genes 1 or 2 (BRCA 1 or 2)), exposure to estrogen and progesterone, hormone replacement therapy after menopause, oral contraceptives, and race and ethnicity.

The exemplary fourth level parameters may include the lifestyle and habits of the patient such as weight, level of physical activity, alcohol consumption, and food consumption (fruits and vegetables vs. animal fats). At the end of the fourth level of degrouping, the computer system provides the medical objective data of a similar group of patients.

The medical information for the new patient are inputted into the computer system are compared with the objective medical data that have been classified into subgroups by degrouping to obtain a match for identifying a course of treatment including a treatment protocol or treatment plan. The computer system analyzes the data and provide the most effective or optimal course of treatment including a treatment protocol or treatment plan for the new patient.

Although reference is made to objective medical data and patient parameters, an alternate embodiment of the invention is based on augmenting the patient parameters with additional attributes, which are transformation and combinations of the observable patient parameters. For instance parameter values can be converted into percentiles of the total patient population or of the degrouped subgroup patient population. A variant is to renormalize attributes into the 0 to 1 scale over the patient population as a whole, or the degrouped subgroup patient population. The normalization computation for attribute a and parameter p, corresponding to the equation:

$$a = \frac{actual ( p ) - min ( p )}{max ( p ) - min ( p )}$$

Additionally, attributes may include ratios of patient parameters or other functional combinations such as products, differences, averages, sums, and so on.

The benefit of the degrouping process for the patient is the use of the information, after the patient has found his or small subgroup. The matching with the degrouped subgroups provides the full information about all available treatment plans, with indication of the most efficient one. The matching output summarizes long-term and short-term results for each available treatment plan, including information about clinical condition dynamics at any period of time, information about the significant parameters average dynamics at any period of time, any particular parameters average dynamic at any period of time, mortality information in this group in any period of time. The possibility to investigate any of all full patients files from your group to see particular dynamic of any each patient parameters. The degrouping process provides statistical data to understand the risks in the short and long term period of time for any complications, side, chronic or main diseases, with statistical percentage of each in investigated by patient period. This degrouping information gives a patient the potential possibility to minimize or prevent possible complications and disease before it starts. The degrouping information also facilitates a patient to find the best doctor or the best hospital, in any area, which has the best results in your particular subgroups. All these incentives serve as strong motivation for the patients to buy subscription for use this analytic computer system.

FIG. 4B is a block diagram illustrating an exemplary menu for executing the degrouping process by processing a mass amount of patients' objective medical data 102. During a first level degrouping 94, the intelligent medical engine 14 is configured to filter a group of patients G by using one more significant parameters 114 to degroup G into first level subgroups G1, G2 . . . Gs 115. The first set of significant parameters 114 include primary parameters relating to the diagnosis or disease, such as tumor size, invasion, lymph nodes, metastasis, symptoms, chest pain, and short of breath. In the diagram as shown, the list of symbols SP1 to SPn denote existing significant parameters 114 for a particular disease, e.g. a patient diagnosed with lung cancer stage 2, has a positive significant parameter (or value in range of) such as blood discharge symptoms (SP2), a tumor size of more than 3 cm but less than or equal to 5 cm across (SP4), metastasis to ipsilateral peribronchial and/or hilar lymph nodes (SP5), hemoglobin level (SP6) and other SP12, SP14. The reduced one or more subgroups with the specified significant parameters 114 are associated with corresponding set of treatment protocols 116, such as sleeve resection surgery (protocol A), chemotherapy (protocol B), or radiation therapy (protocol C), in this particular instance.

During the next or second level degrouping 96, the intelligent medical engine 14 is configured to perform a second level of degrouping based on a second level parameters (including side disease, chronic (historical) disease, and/or complication parameters) 117 to degroup the first level subgroups G1, G2 . . . Gs to one or more second level subgroups 118 G1a, G1b, G2a, G2b . . . 118. The side disease, chronic disease and/or complication parameters 117 include chronic obstructive pulmonary disease (CDP1) and tuberculosis (CDP2) in this particular instance. The reduced one or more second level subgroups 118 with the specified second level parameters 117 are associated with a corresponding set of treatment protocols 110, such as for radiation therapy (protocol C) and targeted therapy (protocol D), excluding sleeve resection (protocol A) and chemotherapy (protocol B) from the first-level degrouping. These protocol would possibly optimize the desirable outcome of the patient's response to the treatment.

During the next or third level degrouping 98, the intelligent medical engine 14 is configured to conduct a third level degrouping based on a set of third level indirect (or non-significant) parameters to degroup from one or more second level subgroups to one or more third level subgroups 124. Indirect parameter includes the feeling of weakness (NSP1), Xerostomia (NSP3), and Sweating (NSP7). The reduced one or more third level subgroups with the specified indirect parameters 122 is associated with a corresponding set of treatment protocols 126.

During the next or fourth level degrouping 100, the intelligent medical engine 14 is configured to execute a fourth level degrouping by using a set of lifestyle parameters 130 and optionally, the corresponding treatment protocols 134, to degroup from one or more third level subgroups to one or more fourth level subgroups 132. The lifestyle parameters 130 includes, for example, smoking (LSP5), a firefighter occupation (LSP8), in this subgroup, chemotherapy (treatment protocol B) maximizes the desirable outcome of the procedure.

A doctor submits the patient's clinical parameters form to the intelligent medical engine 14 at the medical main server 12 for run a degrouping process. The intelligent medical engine 14 is configured to compare the patient's parameters against other patient's electronic medical records in the central database 16, and filters out irrelevant groups with less similar sets of parameter, resulting in reduced one or more subgroups 108 with common parameters.

FIG. 4C is a block diagram illustrating subgroups' significant parameter change and treatment outcome as a response to different treatment protocols. There are three exemplary subgroups I 141, subgroup II 142 and subgroup III 143, with significant parameters (e.g. size of tumor, blood cell count) change as a response to the procedure of different treatment protocols 135A, 135B, 137C to measure the outcome of the treatment procedure. In this example, the most desired outcome 141a of a cancer treatment refers to a complete or partial response, either all of the cancer or tumor has disappeared, or the tumor has shrunk by a percentage but the disease remain. The less desired outcome 141b refers to a stable condition on the growth of the disease, where the tumor size has remain the same or the tumor has neither grown meaningfully nor shrunk meaningfully. The least desired outcome 141c refers to the disease progression, where the tumor of the cancer has grown and the disease area has expanded. For example, the response (significant parameter change) by the subgroup I 141 to treatment protocol B 136 is to have an outcome that is the most desirable treatment, with the treatment protocol A 135 as the less desired outcome 141b, and the treatment protocol C 137 as the least desired outcome 141C. For subgroup II 142, the treatment protocol A 135 results in the most desired outcome 142a, with the treatment protocol C 137 as the less desired outcome 142b, and the treatment protocol B as the least desired outcome 142c. Subgroup III 143 has the treatment protocol C as the most desired outcome, with the treatment protocol A 135 as the less desired outcome 143b, and the treatment protocol B as the least desired outcome 143c.

FIG. 4D is a graphical diagram illustrating the dynamics of how the significant parameters change for two subgroups with the same treatment protocol. The rectangular box denotes the first subgroup 141, and the triangle shape denotes the second subgroup. For subgroup I 141, the first significant parameter 151a may pertain to, for example, tumor size change during the treatment cycle of treatment protocol B 136, and for example, chemotherapy, where the significant parameter reading not indicates that tumor has shrunk by a percentage. For subgroup II 142, the significant parameter 151a may change within the treatment cycle of protocol B 136, e.g. chemotherapy, where the reading of the significant parameter indicates that the cancer has grown. Other significant parameters 151b, 151c, 151d, and 151e provide further exemplary dynamics of the changes in certain significant parameters that affect the characteristics in the classification of subgroups.

FIG. 4E is a block diagram illustrating three exemplary scenario 155a, 156b, 157a for the same patient or a different patient. The degrouping process is a continuous dynamic change between parameters and treatment protocol. The first timeline juncture, shown by the symbol ♦1, refers to the stage progression of a disease, such as lung cancer, e.g. the stage IIA represents the one stage of the disease over the entire cancer cycle from stage I through stage IV. The second timeline juncture, shown by the symbol ♦2, refers to a treatment protocol or a treatment plan with three treatment cycles of chemotherapy in 3 months. The third timeline juncture, shown by the symbol ♦3, refers to a treatment response evaluation and a new treatment protocol during or after the treatment cycles. If the response of the evaluation is a change of significant parameter such as tumor size, blood cell count, then the treatment protocol which maximizes desirable treatment outcome to the group with common parameters is prescribed. The fourth timeline juncture, shown by the symbol ♦4, refers to disease progression speed or relapse time, for example, 5 years of post surgery and chemotherapy. There are three exemplary scenarios 155a, 156a, 157a, which reflects the same patient in different states over the entire treatment plan and prognosis, and the corresponding treatment protocol A 155b, B 156b, C 157b, e.g. A patient in the first scenario 155a who is diagnosed with a lung cancer stage 2, with significant parameters and corresponding protocol A 155b, such as the evaluation of treatment option and use of drug due to old age, drug/agent allergy history). After a period of time, the same patient in third scenario 157a in which the post-treatment significant parameters measurement indicates that the disease amount has remained unchanged, producing a new corresponding treatment protocol C (2nd-line therapy/change to a different drug) 157b. Alternatively, these three timeline scenarios 155a, 156a, 157a may represent three different number of patients where each patient is a representative for one scenario with the significant parameters and treatment protocols associated with that patient's disease template.

If the degrouping process yields subgroups wherein the patients' response to a selected treatment are not statistically significantly different from each other, then in one embodiment these subgroups should be merged. Statistical significance can be measured in many ways; a standard way is to apply the well-known t-test, preferably two-sided (or two-tailed) t-test at a given significance level. In a specific embodiment this significant level would be p<0.05.

The degrouping process has been described as occurring over a potentially-large collection of objective medical data. However as that data changes over time, primarily through new objective medical records being added—whether pertaining to existing patients, new patients, or both, the degrouping process may need to be repeated periodically to refresh the subgroups, and possibly create new ones. In one embodiment additional degrouping is triggered when a plurality of objective medical data corresponding to new or existing patients is added to the storage of the system so as to create a significant change in the entropy of any subgroups. Changes can be clinically significant at different levels for different diseases, but in general a change is said change to be deemed significant if larger than three percent (3%) with respect to patient responses to treatment based on the new objective patient medical data.

As would be appreciated by physicians and others of skill in the art, the outcomes treatments may be characterized by a single token (e.g. “Ebola-free” or “remission”), by a number, (e.g. the resulting viral load after HIV treatment with protease inhibitors and other anti-viral drugs), or by a vector, representing different values at different points in time (e.g. the same viral load measured every few months, or the tumor diameter measured every few weeks after radiation treatment). This vector corresponds to the trajectory of a patient's disease as that patient undergoes treatment, as it measures the outcome of the treatment at multiple time points.

Given a hierarchical degrouping, whether via pre-determined degrouping levels, or via an automated degrouping cascade process, the disclosure provides for ways to use these degroupings to find previous patients with the same or similar parameters to those of a new patient for whom the clinician wishes to determine one or more effective treatment options. In general terms, given a new patient Q with a set of measured parameters {yᵢ, y₂, . . . , yₖ} and a disease for which the clinician wishes to determine one or more effective treatment options, the method of the disclosure compares the patient parameters with the those of each subgroup of patients, wherein those subgroups were established by any embodiment of the degrouping method discussed previously with respect to each candidate treatment. The comparison can take place at one-level of degrouping or at multiple levels of degrouping, including levels pre-established based on medical knowledge such as in FIG. 4A, or multiple levels resulting from automated cascaded degrouping. The result of the comparison is to find the one or more treatment options that proved most effective with respect to desired outcomes for those patients in the subgroups whose parameters most closely match the parameters of the new patient.

One embodiment of this general subgroup matching process is to find the minimal p-norm sum of the differences of parameters between patient and subgroup, as follows:

$$BestMatch ( Q , G ) = {Argmin}_{{g}_{j} ∈ G} [ {\sum }_{i = 1 , … , k} {‖ {g}_{j} ( {x}_{i\_} ) - {y}_{i} ‖}_{p} ]$$

Where Q(yᵢ) are the parameters of the new patient; gj are the subgroups of G, i.e. the results of degrouping group G; gⱼ(xᵢ) are the parameters of each subgroup, p is the norm. If p=1, the BestMatch formula sums the differences of parameters, if p=2, BestMatch sums the squared differences (yielding a least-squared criterion), and if p=0, the BestMatch merely counts the number of differences. The Argmin operator returns the subgroup gⱼ with the smallest differences in parameters to those of the new patient, i.e. the most similar subgroup with respect to the parameters that matter in selecting a treatment option.

A further embodiment uses the BestMatch method at each level of degrouping to first find the best subgroups at the top level, then the next level, and so on until the lowest levels. The levels are defined via medical knowledge as exemplified in FIG. 4A or are those determined automatically by cascaded degrouping as disclosed earlier. The method can be used to find the single best sub group, sub-subgroups, etc., providing the treatment option(s) most consistent with the electronic medical data, or it can be set to provide in the best few subgroups providing a larger number of potential treatment options.

The present disclosure provides a method of monitoring a new patient's disease and if necessary adjusts the course of treatment or treatment protocol based on the progression of the patient's conditions. The computer system has stored medical records for various patients with similar disease or condition who have undergone treatment. The stored medical records include information for the various patients over the course of treatment which can be used for comparison with the new patient's medical condition over time. As an example, localized breast cancer is treated by surgery followed by chemotherapy, radiation therapy, or hormone replacement therapy (for ER positive tumors) to prevent recurrence of the tumor. After surgery for breast cancer, a significant parameter to be monitored may be the recurrence of the tumor during and after the course of treatment. The present disclosure provides a method that enables inputting and comparing the breast cancer patient's medical conditions after surgery over time with the medical data of other patients with similar medical conditions for determining the possibility of recurrence and identifying the appropriate course of treatment to prevent the recurrence. The present method also enables identifying the appropriate course of treatment if the cancer recurs. The treatment plan for the new patient provided by the methods disclosed herein can be modified depending on the new patient's symptoms. The methods disclosed herein can be routinely adjusted to provide the optimal course of treatment for the new patient.

FIG. 4E is a pictorial diagram illustrating one example of the degrouping method which reflects a continuous dynamic process as between a treatment protocol and corresponding parameters, such as significant parameters. The patient's significant parameters respond to the applied treatment plan (e.g., a surgery, medication, or both) and moves along the timelines, such as from timeline 1 to 2 or from timeline 3 to 1, indicating disease progression or recovery, as response to the applied treatment protocol. The recommend treatment plan is selected to optimally produce the desired medical outcome, such as shrinkage in tumor diameter as a result of chemotherapy. The symbol ♦ refers to timeline/speed in which the parameters the subgroup respond to the applied treatment plan. The symbol ★ refers to a recommended treatment protocol, which may provide the most desirable treatment outcome for this subgroup(s) of patients in response to the applied treatment protocol.

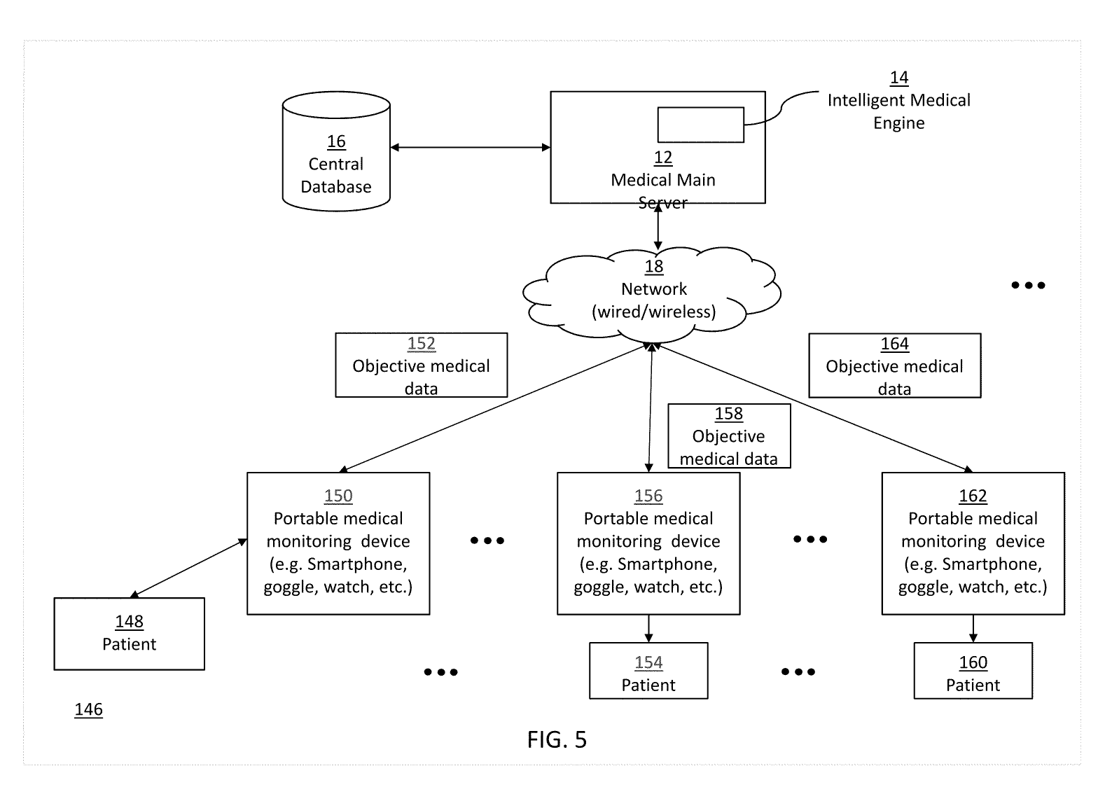

FIG. 5 is a system diagram 146 illustrating portable medical monitoring devices 150, 156, 162 to monitor patients 148, 154, 160 with respect to objective medical data 152, 158, 164. The portable medical monitoring device 150 is associated with the patient 148 as a portable monitoring device that monitors and tracks changes in the patient's medical condition and can alert the patient, health care provider, and/or ambulance of any such meaningful changes relative to the patient's object medical data. The monitoring of patient 148 by the portable medical monitoring device 150 is continuous in taking inputs from the patient medical condition and sending the patient's medical data to the medical main server 12 for comparison with the patient's 148 objective medical data 152. When the medical main server 12 determines that the real time medical data received from the portable medical monitoring device 150 associated with the patient 148 exceeds a threshold level of particular objective medical data 152, the medical main server sends an alert to the portable medical monitoring device 150 to notify the patient's medical doctor, or other healthcare provider, about the potentially dangerous medical condition, as well as alerting the patient of the reading. For example, each of the portable medical monitoring devices 150, 156, 162 monitors the respective patient's, 148, 154, 160, as to the particular patient's blood pressure, heart rate, etc. Similar types of operations for portable medical monitoring devices 156, 162 also apply respectively to the patient 154, 160, the medical main server 12 and the associated objective medical data 158, 164.

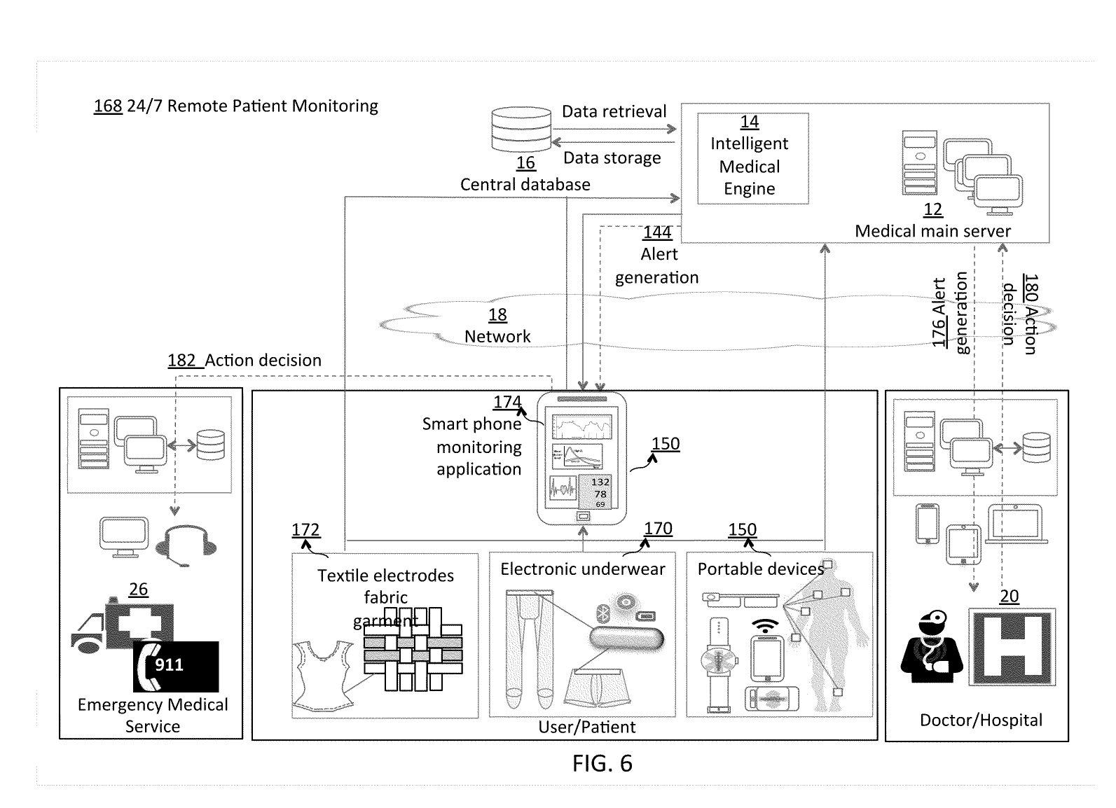

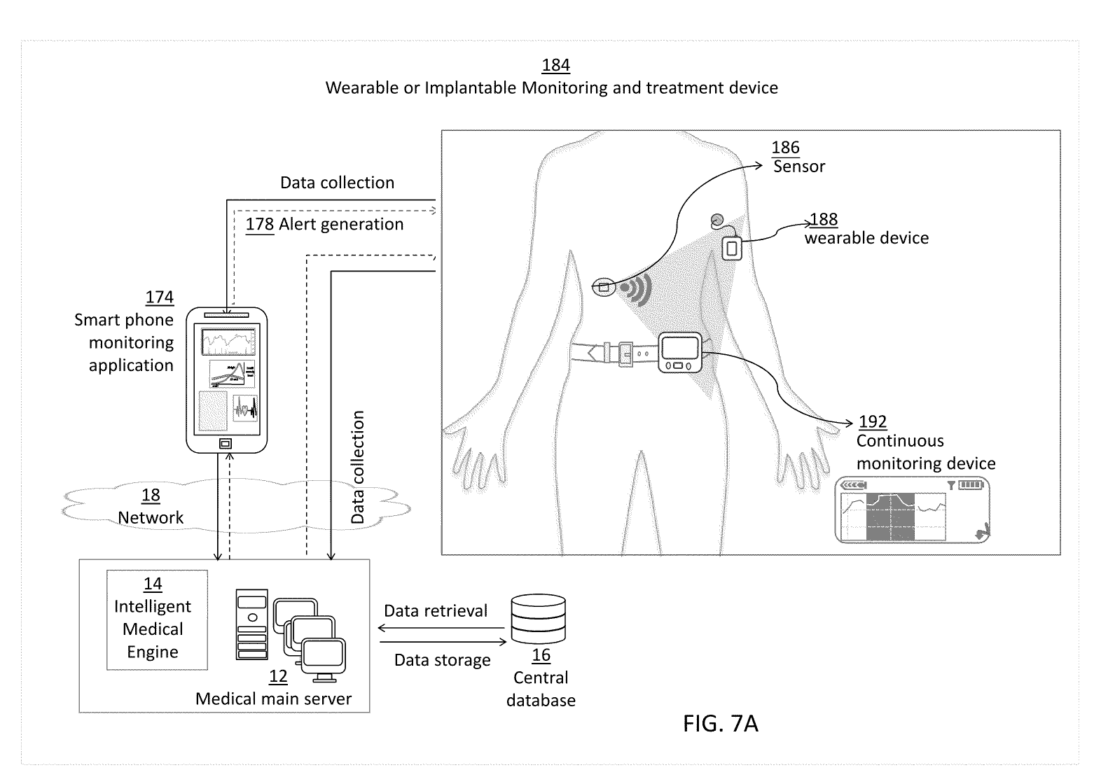

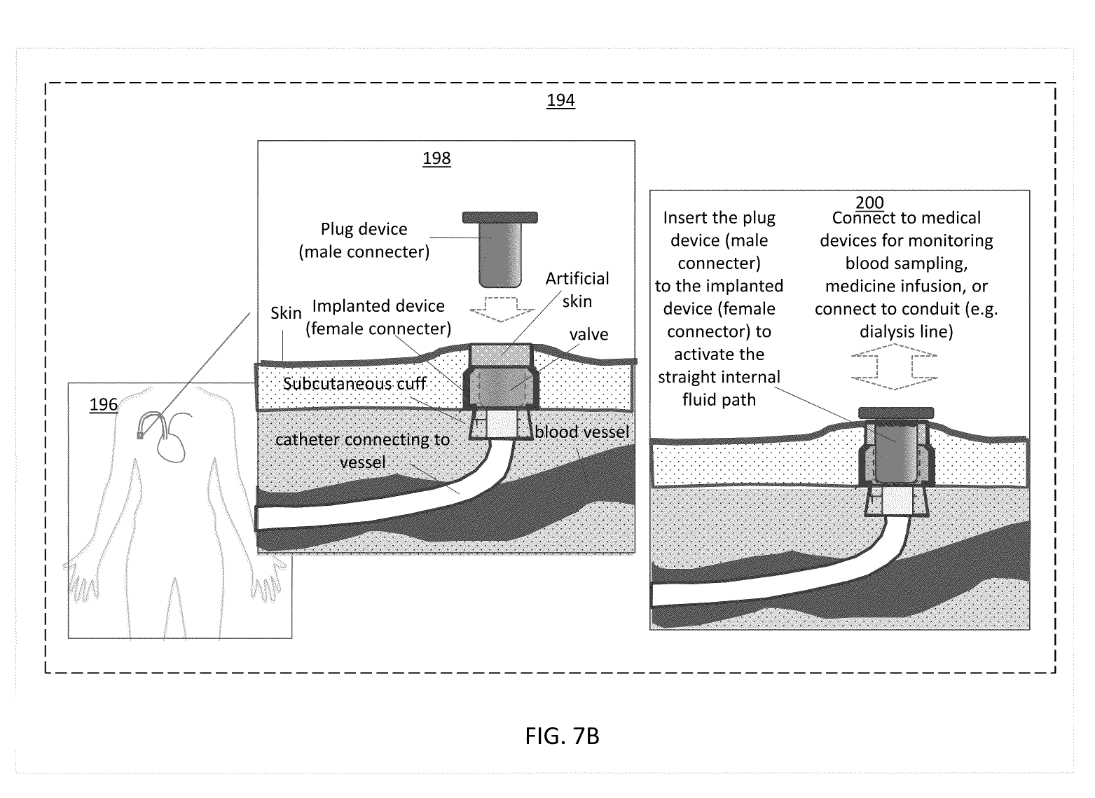

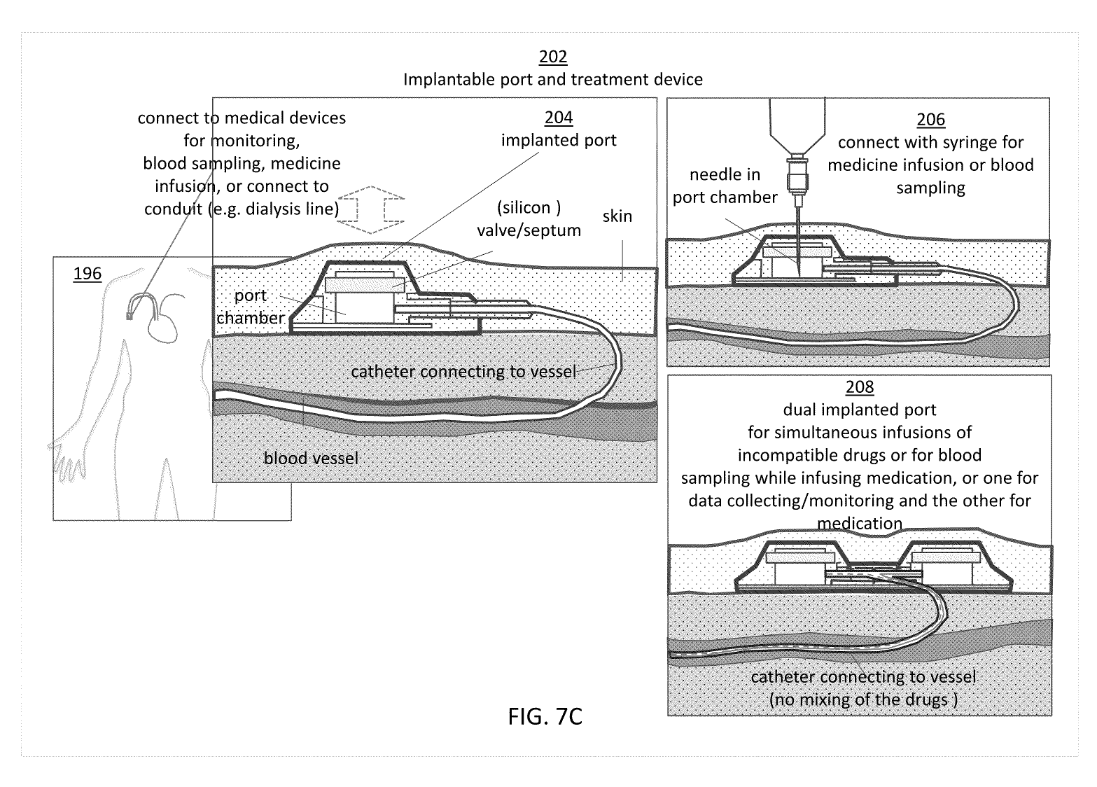

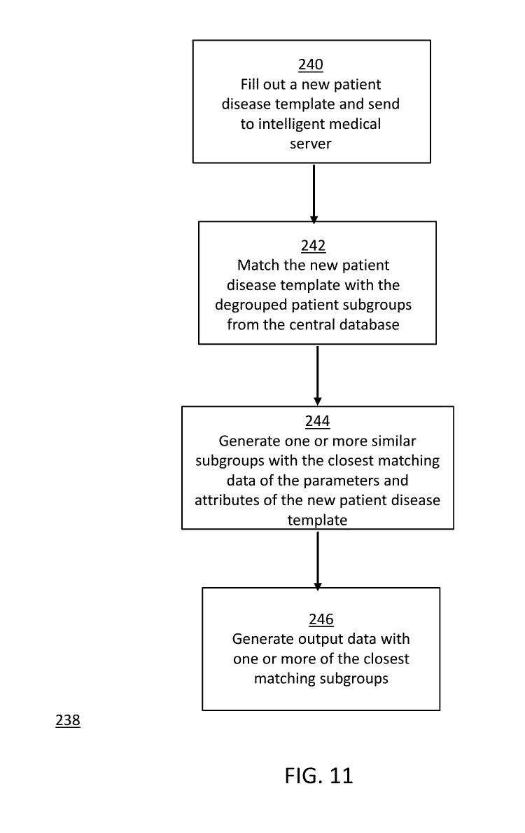

FIG. 6 is an illustration of an exemplary process flow of 24/7 (168) monitoring patients relative to the objective medical data with the steps with respect to FIG. 11. The patient is monitored by a portable medical monitoring device 150 (e.g. smartphones, tablets, glasses/goggles, watches, wearable devices, medical stickers), or electronic underwear 170 attached with electronic device (e.g. sensor), or textile electrodes fabric garment 172, where the portable medical monitoring device 150 operates in conjunction with an implantable device as shown and described in FIGS. 7A-C as a method to read a patient's blood pressure, heart rate, and other vital medical data. The real time medical data reading is collected from a portable medical monitoring device, or an electronic device affixed to the electronic underwear, or by the textile electrodes of a garment, and transmitted to a mobile device 150. The patient can opt to install a smartphone monitoring application 174 by which the data can be displayed or incorporated into an overview or a dashboard to monitor vital signs of the patient and to change setting in real time such that medical data is transmitted from the mobile device 150 to the medical main server 12. The real time objective medical data is analyzed relative to the patient's previously stored objective medical data in the central database 16. If the condition evokes a medical alert, a notification 176 is sent to the patient's medical doctor about the potentially dangerous medical condition for action decision 180 (e.g. to retrieve patient's data for further investigation from patient's records or call the patient), and a notification 178 send to the patient of the reading for action decision 182 (e.g. to call an ambulance). The resulting data is stored in the central database 16 to the existing patient's EMR System if the condition does not evoke a medical alert. The resulting data is stored in the central database as well. Optionally, the analyzed data is sent to the patient's smartphone to update/refresh the overview or a dashboard display by smartphone monitoring application 174.

FIG. 7A is an exemplary diagram of a wearable or implantable monitoring and treatment device 184 for monitoring and treatment with reference to FIG. 6. A wearable device of synthetic vessel or with port 188 (e.g. cannula), or a micro needle patch can provide a means to inject something (e.g. drug) into a person, or extract something (like blood) from the person. The device can be worn on the arm, thigh, abdomen, or other infusion site. Optionally, a sensor 186 is inserted underneath the skin for continuous measurement (e.g. glucose levels) and the data is sent to the continuous monitoring device 192 via wireless radio frequency. A notification or alert 178 is then sent to the person for manual or automatic drug (e.g. insulin) delivery. The data of measurement and infusion is sent to the intelligent medical engine 14 (with smartphone) to be analyzed and stored. The infusion and sensor devices can be removed and placed on equipment on a daily or specific basis to reload, recharge, and refill, such as pills, needle, etc. The wearable device 188 provides another source to provide patients' parameters in objective medical data to the central database 16 for degrouping processing by the intelligent medical engine 14.

FIG. 7B is an exemplary diagram of connecting devices in a process 194 to access the vascular system. A pair of vascular access devices, which comprises an implanted port device and a plug device 198. The implanted port device is placed under the skin of a human 196 by a surgeon. It has artificial skin septum, which when not being accessed, acts as a self-sealing valve. The plug device (male connector) can be inserted into the port device (female end) to activate the straight internal fluid path for blood sampling or medicine infusion, as well as data collecting or monitoring, and neither use of syringe nor professional training is required. A user or patient can plug in the device and medical data 200 (e.g. blood sample) can be collected and the data of measurement and medicine infusion is sent to the intelligent medical engine 14 (with smartphone), or hospital/lab for monitoring, analysis or disease.

FIG. 7C is an exemplary diagram of an implantable port and treatment device 202. An implanted port 204 can give treatment into a person, such as chemotherapy, blood transfusions, antibiotics and intravenous (IV) fluids, can also extract something (like blood) from the person for blood sampling since the port can be left in the body underneath the skin, with catheter in the blood vessel 208, or monitor, can be collected and the data of measurement and medicine infusion status is sent to the intelligent medical engine (with smartphone), or hospital/lab for monitoring, analysis or disease purpose, e.g., medicine can be injected into the vessel using syringe with needle into port chamber 206 to deliver the medicine at different times or constantly through the catheter, which is already in the blood vessel.

The implantable port and treatment device 202 allows easy accessibility to a patient's blood parameters, such as cytokine, other proteins, or other cells, which are capable of providing cell signaling to the implantable port and treatment device 202, which in turn communicate such information to the portable device 188 for 24/7 monitoring of the patient. With online monitoring from the transmitted data from the portable device 188, a physician or nurse can observe the patient's changing blood cell parameters over time. Cytokines are a broad and loose category of small proteins (˜5-20 kDa) that are important in cell signaling. Cytokines are released by cells and affect the behavior of other cells, and sometimes the releasing cell itself. Cytokines include chemokines, interferons, interleukins, lymphokines, tumour necrosis factor but generally not hormones or growth factors. Cytokines are produced by a broad range of cells, including immune cells like macrophages, B lymphocytes, T lymphocytes and mast cells, as well as endothelial cells, fibroblasts, and various stromal cells; a given cytokine may be produced by more than one type of cell. One key aspect of Cytokines is their dynamics, changes in relative concentration of different cytokines are indicative of disease progression or remission, including early indicators of organ or tissue transplant rejection (e.g. see Starzl et al., 2013).

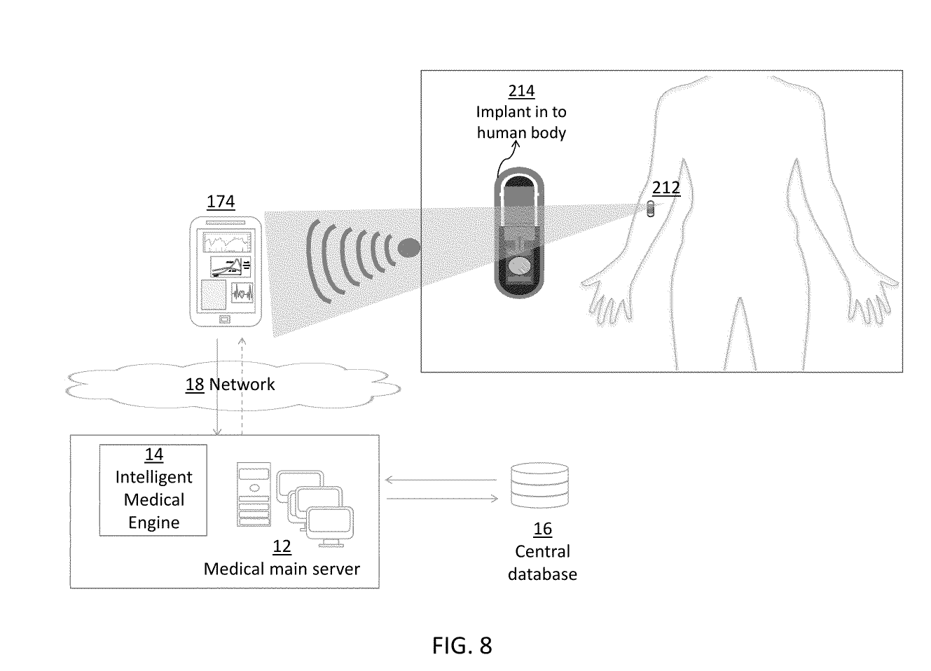

FIG. 8 is an exemplary diagram of an implantable device for monitoring and treatment 210. An implant into the human body 214 (e.g. implantable device RFID Chip 212) can be used for monitoring general health, as to be used to retrieve medical information in the event of an emergency, as well as the effect of treatments. For example, in vascular-port applications, the chip can be used to properly identify the vascular port in a patient in order to ensure that the appropriate amount of chemotherapy drugs are infused into the body to personalize medicine and medical care through the use of implantable port underneath the skin of a patient, as described and shown in FIGS. 7B-C.

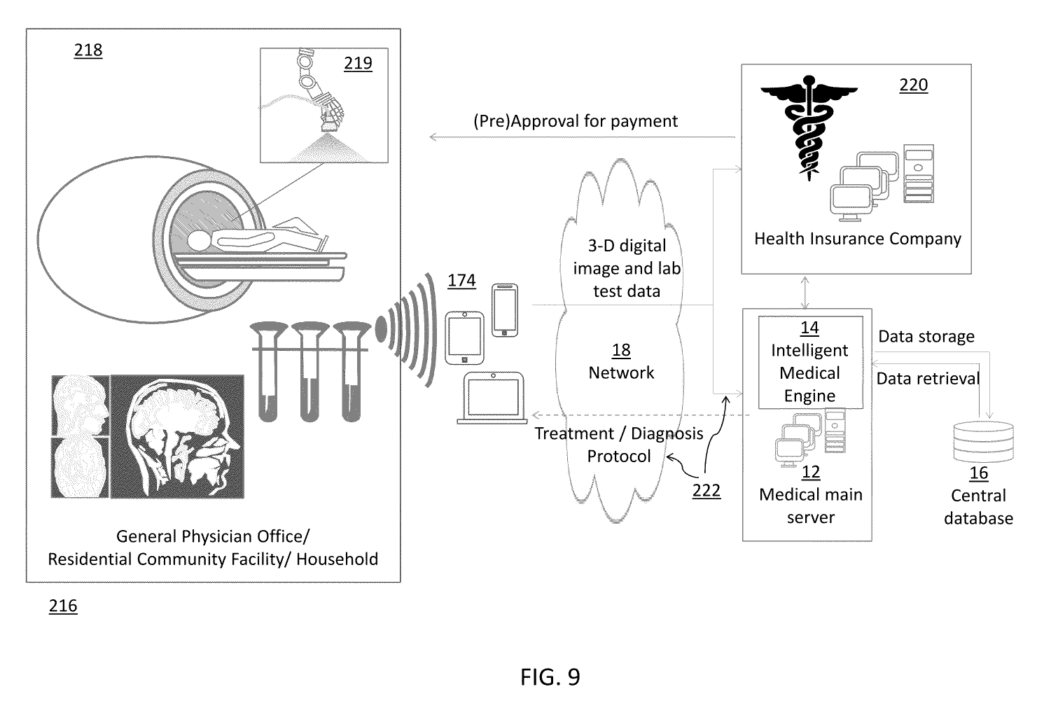

FIG. 9 is an exemplary diagram of a diagnosis capsule machine 216 with unified health examination and diagnosis functions that can be used at primary care providers, which includes but not limited to general practitioners and family doctors. A primary care provider's office 218 would have a diagnosis capsule 216 which is capable to conduct an health examination laboratory tests, e.g. complete blood count, Chemistry panel, Urinalysis (UA), and medical imaging programs such as MRI (Magnetic Resonance Imaging), CT/CAT (Computerized Axial Tomography scan) to x-ray, and electrocardiogram (EKG or ECG) ultra sound. The machine costs less expensive to produce and purchase, equipped with multiple detectors fitting in the machine for parallel data acquisition, and can be placed at a private practice clinic, residential community facility, or even a household for health check-up, disease and treatment, with patient's information linked to health insurance company 220 for pre-approval of payment. The diagnosis capsule improves efficiency and effectiveness of the health care process by reducing patient's time and cost to visit hospital or lab, providing a doctor with real time and complete results of tests at operation, eliminating administrative work at insurance companies, and reducing processing and approval time. The real time lab test data and pictures from inside the human body, along with the 3-D digital image data, as treatment/disease protocol 222, are sent to the intelligent medical engine 14 (via smartphone, tablet, notebook or computer) to be compared, analyzed and stored in the central database 16. The diagnosis capsule machine 216 provides another source to provide patients' parameters in objective medical data to the central database 16 for subsequent degrouping processing by the intelligent medical engine 14.

Optionally, the diagnosis capsule machine 216 is equipped with a robotic arm/hand 219 for moving a medical device (such as ultrasound, x-ray, etc.) and moving the medical device on to the patient as the patient lies on the a flat surface of the diagnosis capsule machine 216. An integrated diagnosis capsule machine 216 which is capable of performing multiple medical functions that would typically require several medical equipment to perform each medical function separately.

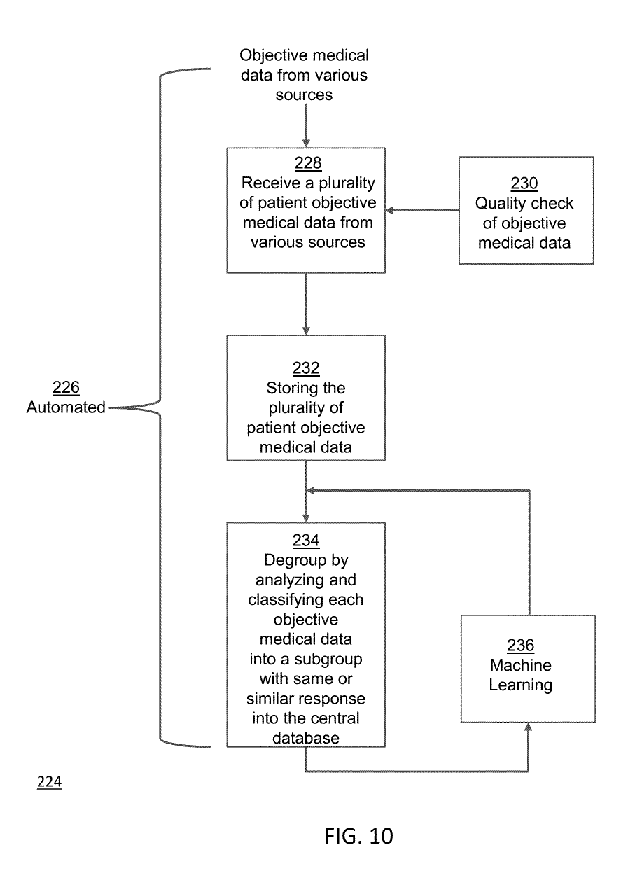

FIG. 10 is a block diagram 224 illustrating an automated process 226 in which the intelligent medical engine 14 receives, stores, analyzes, and classifies medical objective data with an interactive machine-learning process for optimization. At step 228, the intelligent medical engine 14 is configured to receive a plurality of objective medical data from various medical sources, such as the first hospital 20, the second hospital 22, the clinic 24, and the source 26. The intelligent medical engine 14 is configured to conduct a quality check of objective medical data at step 230. At step 232, the intelligent medical engine 14 is configured to store the plurality of objective medical data. At step 234, the intelligent medical engine 14 is configured to analyze and classify objective medical data into a group that contains the same subset (or the same set) of clusters as the newly entered objective medical data into the central database 16. At step 236, the learning module 72 is configured to provide a machine-learning function to the overall automated process 226 by constantly adjusting parameters and new data to improve the analyzing and classifying of groups of medical objective data.

FIG. 11 is a block diagram illustrating the process 238 initiated by a medical personnel for rapidly comparing a patient's new symptom with a large pool of existing objective medical data. A medical personnel, such as a doctor or a nurse, fills out a patient template form on a computing device at step 240 when the patient visits a doctor's office. The medical personnel sends the patient template form from the computing device to the intelligent medical engine 14. At step 242, the intelligent medical engine 14 is configured to compare the objective medical data contained in the patient template with the existing groups of objective medical data already stored in the central database 16. At step 244, the intelligent medical engine 14 is configured to determine which one of the existing groups of objective medical data in the central database 16 has the closest matching data with the patient template. The intelligent medical engine 14, at step 246, is configured to generate output data with the closest matching group, or several of the closest matching groups (collectively one or more of the closest matching groups).

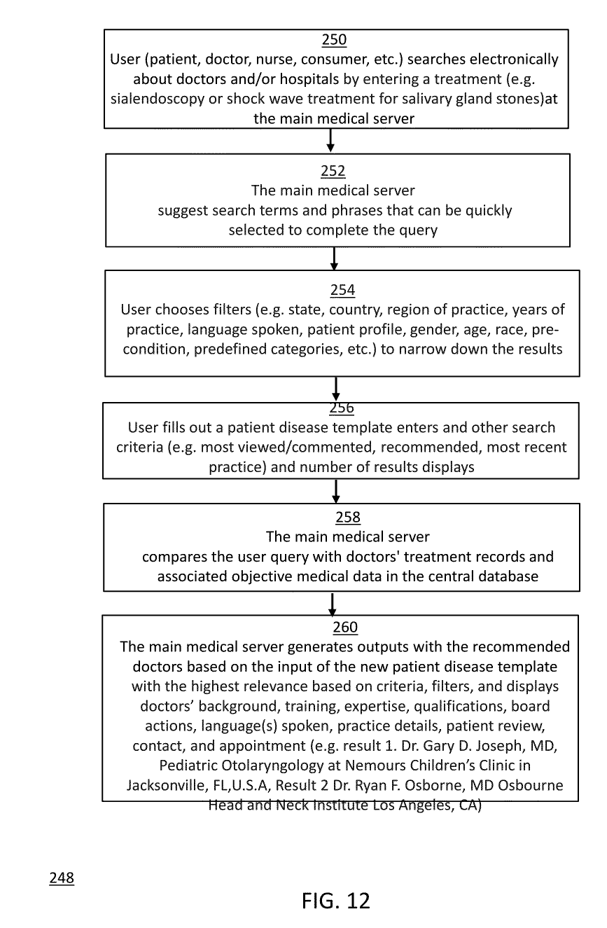

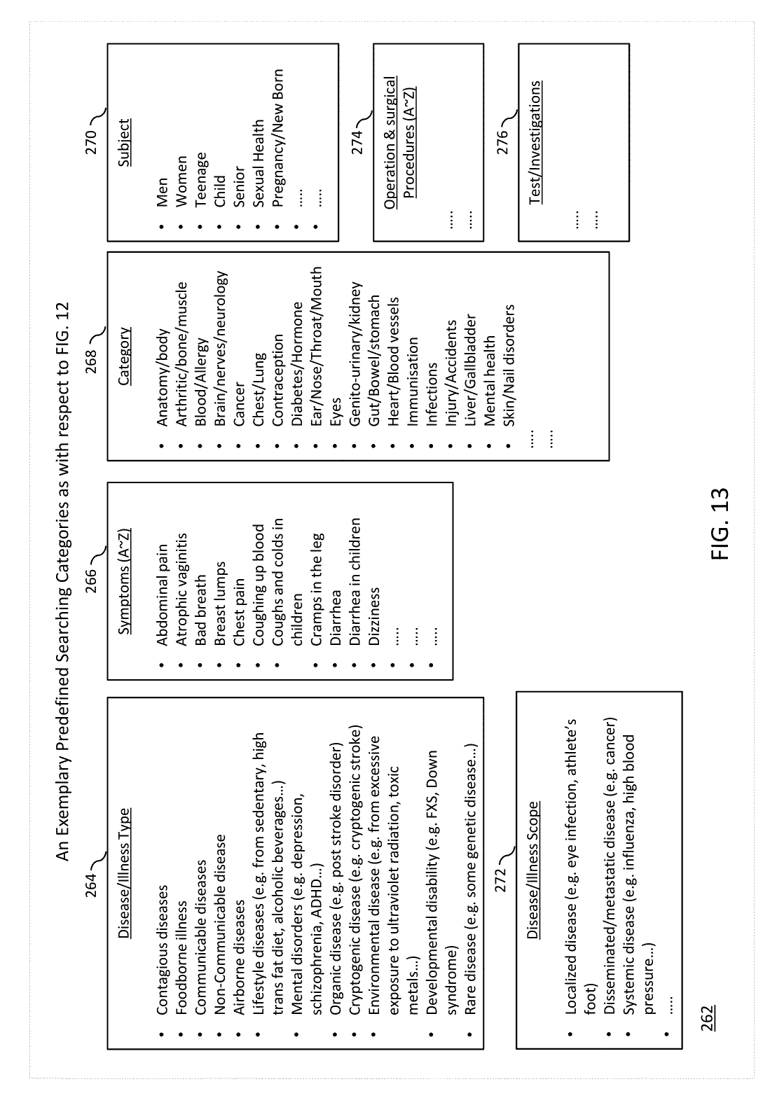

FIG. 12 is a block diagram illustrating the process 248 initiated by a consumer for selecting doctor objective data based on a query. At step 250, the consumer uses a computing device to conduct an electronic search (or to submit a query) about doctors and/or hospitals for a treatment (e.g. sialendoscopy or shock wave treatment for salivary gland stones) with suggestion terms/phrases at step 252, predefined filters at step 254, and storing criteria at step 256 in order to improve search accuracy and speed at the medical main server 12. At step 258, the intelligent medical engine 14 is configured to compare the query submitted with the doctor objective data (and/or hospital objective data) to the central database 16. Searching queries on objective data solve the problematic issue of searching by specialized medical terms or subjective description. At step 260, the intelligent medical engine 14 is configured to generate an output with highest relevancy based on sorting criteria and filters, which effectively narrow down the results to fit users' needs. Alternatively, at step 260, the intelligent medical engine 14 is configured to generate an output with one or more key criteria in the evaluation of a treatment selection by a doctor, which could include both success/positive cases and negative cases.

FIG. 13 illustrates exemplary predefined searching categories 262 with respect to FIG. 12 in accordance with the present disclosure. When a patient (or a consumer) selects doctor objective data based on a query at process 248 as shown in FIG. 12, there are predetermined parameters or filters at step 254 that a consumer may use to conduct a search for his or her illness. FIG. 13 illustrates some exemplary predefined searching categories 262, including, but not limited to, disease/illness type 264, symptoms 266, category 268, subject 270, disease/illness scope 272, operation and surgical procedures 274, and test/investigations 276, among others. The disease/illness type 264 is a searching category that identifies the type of disease of the patient, which may include contagious disease, foodborne illness, communicable disease, lifestyle disease (such as high trans fat diet), mental disorders, among others. When a patient generates a query, he or she may indicate the symptoms 266 felt, which might include abdominal pain, atrophic vaginitis, bad breath, breast lumps, chest pain, coughing, and dizziness, among others. In addition to the symptoms, a patient may identify the category 268, which highlights the part of the human body troubled by the disease or illness. For example, the category 268 may include anatomy/body, arthritic/bone/muscle, blood/allergy, and brain/nerves/neurology, etc. A patient may provide additional information in the subject 270 searching category to define their search by gender, age etc. The disease/illness scope 272 searching category offers a more general description of the disease or illness. In this category, a patient may identify his or her disease as a systemic disease (e.g. influenza, high blood pressure, etc.). As shown in FIG. 13, the searching parameters may also include operation and surgical procedures 274 and test/investigations 276 that the patient may opt to select from the predefined filters.

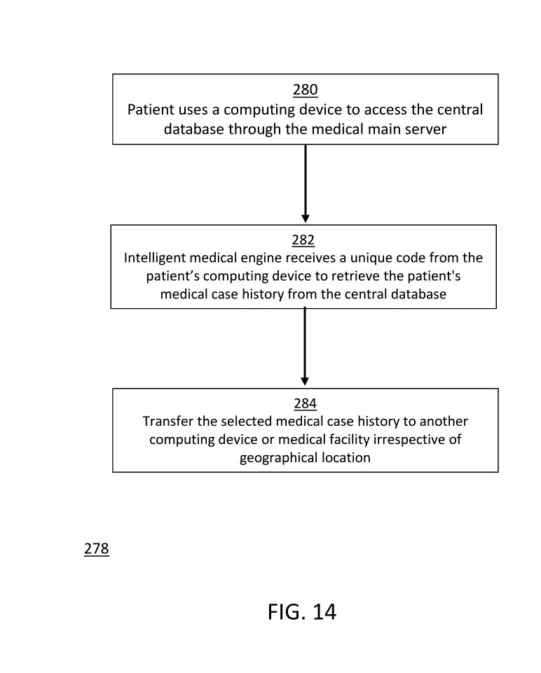

FIG. 14 is a block diagram illustrating the process 278 by a consumer to retrieve his or her own medical records from any location. At step 280, the patient uses a computing device to access the central database 16 through the medical main server 12. At step 282, the intelligent medical engine 14 is configured to receive a unique code from the patient's computing device to retrieve the patient's medical case history from the central database 16. At step 284, the intelligent medical engine 14 is configured to transfer the selected medical case history associated with the patient to another computing device or medical facility for use by the patient or another medical personnel. The ability to access the patient's medical case history from the central database 16 in another medical facility, which can be located in another country or region, provides great flexibility to the patient, particularly if the patient is traveling or has moved to another city, country, region, or continent.

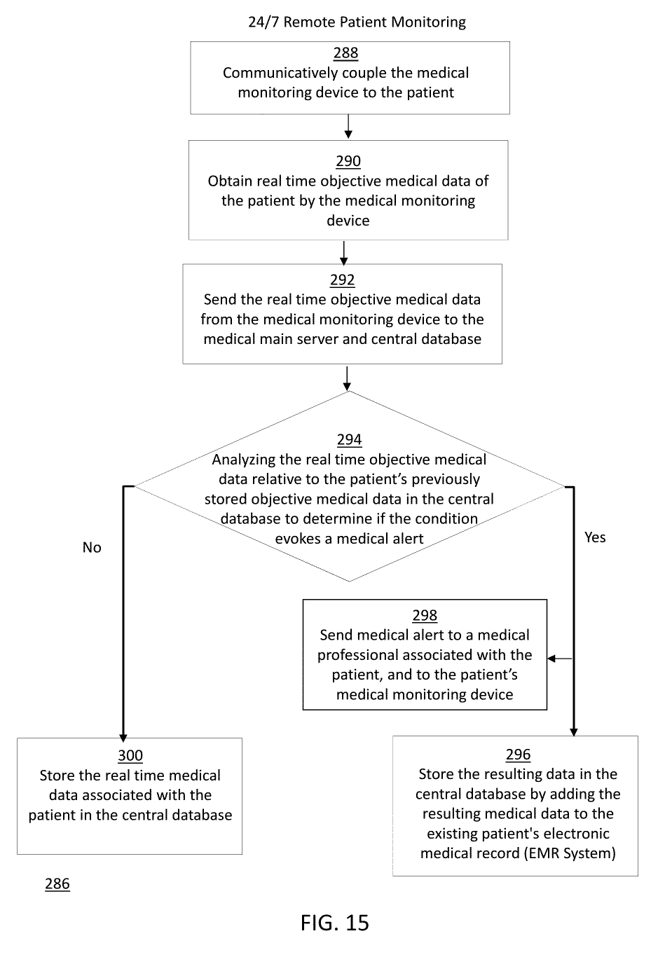

FIG. 15 is a flow diagram illustrating the process 286 of 24/7 monitoring patients relative to objective medical data with respect to FIG. 6. At step 288, the portable medical monitoring device module 65 is communicatively coupled with the portable medical monitoring device 150 to the patient 148. At step 290, the portable medical monitoring device module 65 is configured to obtain real time objective medical data from the patient 148 by the portable medical monitoring device 150. At step 292, the portable medical monitoring device module 65 is configured to send the real time objective medical data of the patient 148 from the portable medical monitoring device 150 to the medical main server 12 and the central database 16. At step 294, the intelligent medical engine 14 is configured to analyze the real time objective medical data of the patient 148 relative to the patient's 148 previously stored objective medical data in the central database 16 to determine if the comparison would invoke a medical alert to the patient's medical doctor and to the patient. If one of the parameters in the patient's 148 real time objective medical data exceeds a threshold of the patient's 148 previous stored objective medical data, then the intelligent medical engine 14 is configured to send a medical alert to a medical professional associated with the patient 148 and to the patient's 148 portable medical monitoring device 150 to inform the patient 148 at step 298. At the same time in step 296, the intelligent medical engine 14 is configured to store the resulting real time objective medical data from the patient 148 in the central database 16 by adding the resulting objective medical data to the existing patient's 148 EMR System. At step 300, if none of the parameters in the patient's 148 real time objective medical data exceeds a threshold of the patient's 148 previously stored objective medical data, then the intelligent medical engine 14 is configured to store the patient's 148 real time objective medical data in the central database 16. The patient 148 is used for illustrative purposes whereby a large volume of patients, including patients 154, 160, is communicatively coupled to the medical main server 12 through their respective portable medical monitoring device 150. A portable medical monitoring device 150 includes any type of portable devices, like smartphones, tablets, glasses/goggles, watches, wearable devices, etc.

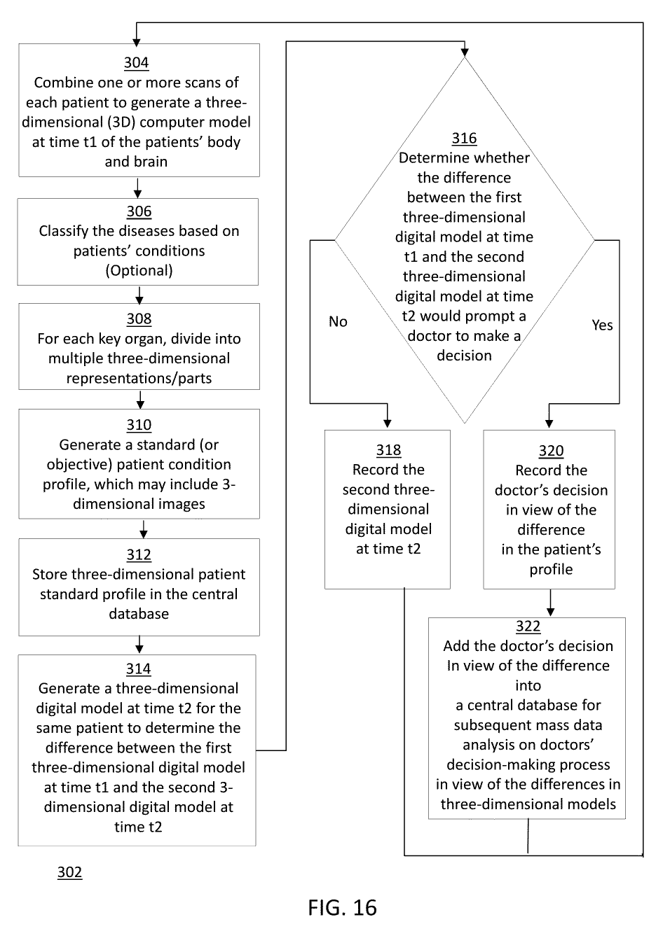

FIG. 16 is a flow diagram illustrating the process 302 for storing, compiling, and analyzing a patient's three-dimensional profile over time to assist a doctor in making a treatment decision based on multiple different data points in view of changing images. This embodiment can also include other doctors' decisions in similar situations as the patient's two data points. At step 304, the learning module 72 is configured to conduct an analysis of images from one or more diagnostic imaging devices, such as X-rays, a magnetic resonance imaging (MRI), a computed tomography (CT) scan, etc. to generate either two-dimensional images or three-dimensional images or digital models at time t₁ of the patient's body (such as key body organs) and brain (such as brain structure). A plurality of two-dimensional images can be constructed to form a three-dimensional representation of the patient's particular organ. At step 306, as an optional step, the intelligent medical engine 14 is configured to classify the diseases based on the patient's conditions from received patients' objective medical data. At step 308, the intelligent medical engine 14 is configured to construct three-dimensional representations for a selected or key organ, or multiple key organs. At step 310, the intelligent medical engine 14 is configured to generate a standard (or objective) patient condition profile for each patient, where the objective patient condition profile may include a set of three-dimensional images of the patient. At step 312, the intelligent medical engine 14 is configured to store the standard patient profile with three-dimensional images, and any applicable two-dimensional data or images, in the central database 16. At step 314, the intelligent medical engine 14 is configured to generate a three-dimensional digital model at time t₂ for the same patient to determine the difference between the first three-dimensional digital model at time t₁ and the second three-dimensional digital model at time t₂. At step 316, the intelligent medical engine 14 is configured to determine whether the difference between the first three-dimensional digital model at time t₁ and the second three-dimensional digital model at time t₂ would prompt a doctor to make a decision on the type of treatment process for the patient. If there is no change on the doctor's decision inputted into the intelligent medical engine 14 or the intelligent medical engine 14 determines that no change is necessary, at step 318, the intelligent medical engine 14 is configured to record the second three-dimensional digital model at time t₂. If the doctor makes a decision to change the type of treatment to input into the intelligent medical engine 14 or the intelligent medical engine 14 determines that a change to the treatment is necessary, at step 320, the intelligent medical engine 14 is configured to record the second three-dimensional digital model at time t₂. At step 322, the intelligent medical engine 14 is configured to add the doctor's decision or the decision made by the intelligent medical engine 14 in view of the difference between the first three-dimensional digital model at time t₁ and the second three-dimensional digital model at time t₂, and enter the data into a central database for subsequent mass data analysis on doctors' decision-making process in view of the differences in three-dimensional models. The process continues in a continuous loop by returning from step 318 or step 322 to step 314, with time t₂ now representing the next point in time, and time t₁ now representing the previous point in time.

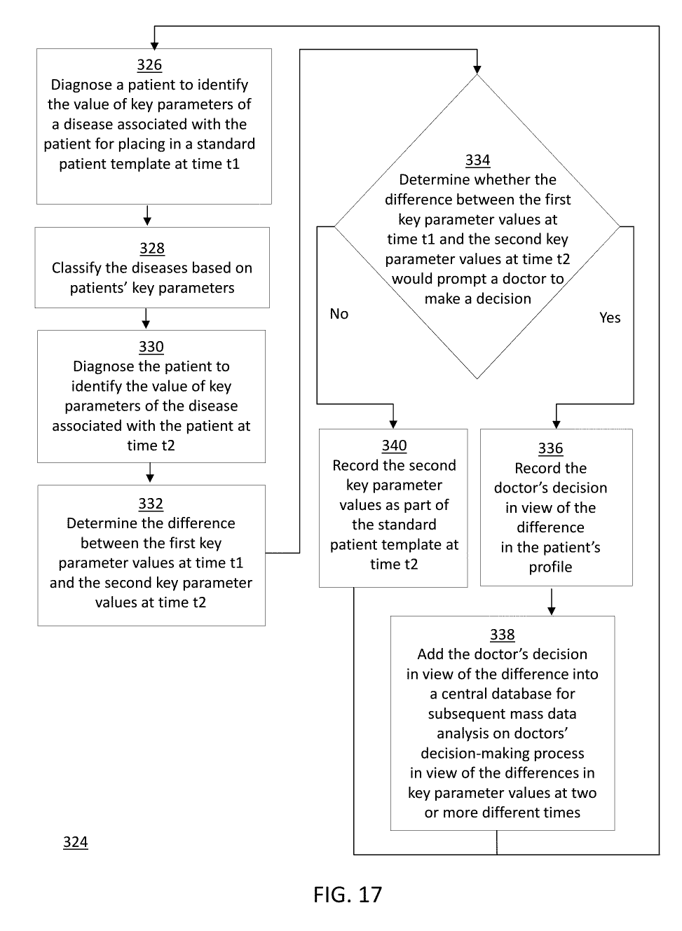

FIG. 17 is a flow diagram illustrating the process 324 for storing, compiling, and analyzing key parameters in a patient's template over time aiding a doctor in making decisions between multiple different data points in view of changes to key parameters in the template. At step 326, the intelligent medical engine 14 is configured to identify the value of key parameters of a disease associated with the patient for placing in a standard patient template at time t1. At step 328, the intelligent medical engine 14 is configured to classify the diseases of the patient based on patients' key parameters in the template. At step 330, the intelligent medical engine 14 is configured to diagnose the patient to identify the value of key parameters of the disease associated with the patient at time t2. At step 332, the intelligent medical engine 14 is configured to determine the difference between the first key parameter values at time t1 and the second key parameter values at time t2. At step 334, the intelligent medical engine 14 is configured to determine whether the difference between the first key parameter values at time t1 and the second key parameter values at time t2 would support altering the treatment protocol from the current treatment protocol. On the one hand, at step 336, if there is an entry into the intelligent medical engine 14 that the doctor has decided to use a different treatment method, the intelligent medical engine 14 is configured to record the doctor's decision in view of the difference in the patient's profile. At step 338, the intelligent medical engine 14 is configured to add the doctor's decision in view of the difference into a central database for subsequent mass data analysis on doctors' decision-making processes, in view of the differences in key parameter values at two or more different times. On the other hand, at step 340, if there is an entry into the intelligent medical engine 14 that the doctor has maintained the same treatment method, the intelligent medical engine 14 is configured to record the second key parameter values as part of the standard patient template at time t2. The process from step 338 and 340 returns to step 326.

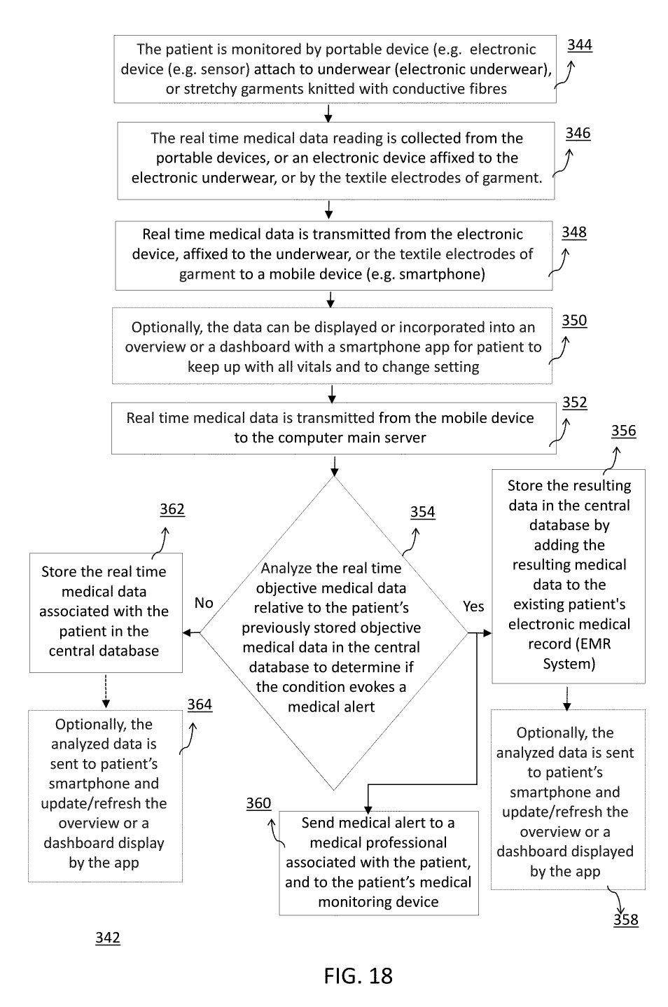

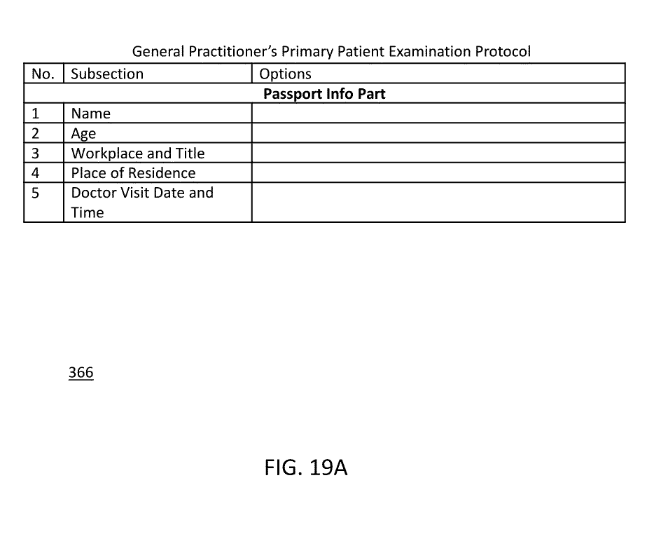

FIG. 18 is a flow diagram illustrating the process 342 sensing medical data with electronic underwear 170 or textile electrodes of a fabric garment 172 knitted with conductive fibers for monitoring patients relative to objective medical data. At step 344, an electronic device is attached to a man or woman's underwear (electronic underwear). As shown in FIG. 18, the electronic underwear 170 is typically manufactured as a unit, with the electronic device and the underwear to be sold at retail stores. Other embodiments may include the electronic device being sold separately and attachable to the underwear. On example of a woman's underwear is a pantyhose in which the electronic device is affixed to the top of the pantyhose around the waist with strong elastic.

At step 346, the electronic device on the electronic underwear, or the textile electrodes of garments, monitors a patient based on the real time medical data (e.g., temperature, blood pressure, pulse/heart rate, etc.) reading collected from the electronic device affixed to the electronic underwear, or the textile electrodes. At step 348, the electronic device on the electronic underwear, or the textile electrodes, transmits the real time medical data to a mobile device, such as a smartphone 150, via a wireless protocol, such as Bluetooth or a cellular data network. Optionally, at step 350, the data can be displayed or incorporated into an overview or a dashboard with a smartphone app for a patient to keep up with all the vitals and to change the settings.

At step 352, the smartphone 150 in turn transmits the real time medical data to the medical main server 12. At step 354, the intelligent medical engine 14 is configured to analyze the real time objective medical data of the patient 148 relative to the patient's 148 previously stored objective medical data in the central database 16 to determine if the comparison would invoke a medical alert to the patient's medical doctor and to the patient. If one of the parameters in the patient's 148 real time objective medical data exceeds a threshold of the patient's 148 previously stored objective medical data, then the intelligent medical engine 14 is configured to send a medical alert to a medical professional associated with patient 148 and to the patient's 148 portable medical monitoring device 150 to inform the patient 148 at step 360. At the same time in step 356, the intelligent medical engine 14 is configured to store the resulting real time objective medical data from the patient 148 in the central database 16 by adding the resulting objective medical data to the existing patient's 148 EMR System. Optionally, at step 358, the resulting data is sent to a patient's smartphone and is updated/refreshed to overview or a dashboard displayed by the app. At step 362, if none of the parameters in the patient's 148 real time objective medical data exceeds a threshold of the patient's 148 previously stored objective medical data, then the intelligent medical engine 14 is configured to store the patient's 148 real time objective medical data in the central database 16. Optionally at step 364, the resulting data is sent to a patient's smartphone and is updated/refreshed to overview or a dashboard displayed by the app. The patient 148 is used for illustrative purposes whereby a large volume of patients, including patients 154, 160, is communicatively coupled to the medical main server 12 through their respective portable medical monitoring device 150. A portable medical monitoring device 150 includes any type of portable devices, like smartphones, tablets, glasses/goggles, watches, wearable devices, etc.

In some embodiments, an electronic container, such as part of a wearable device, like a watch, provides medication to a patient at suitable times. For example, the drugs can be stored in the electronic container for daily use. When it is time to take medication, the electronic container would beep to alert the patient to take the drug retrieved from the electronic container.

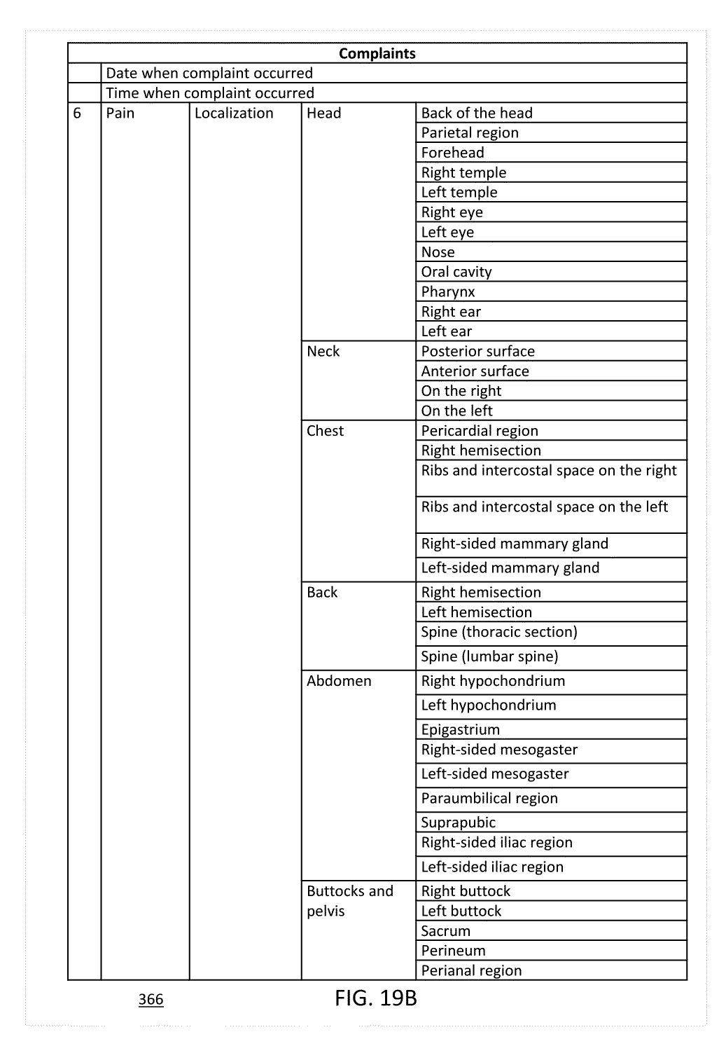

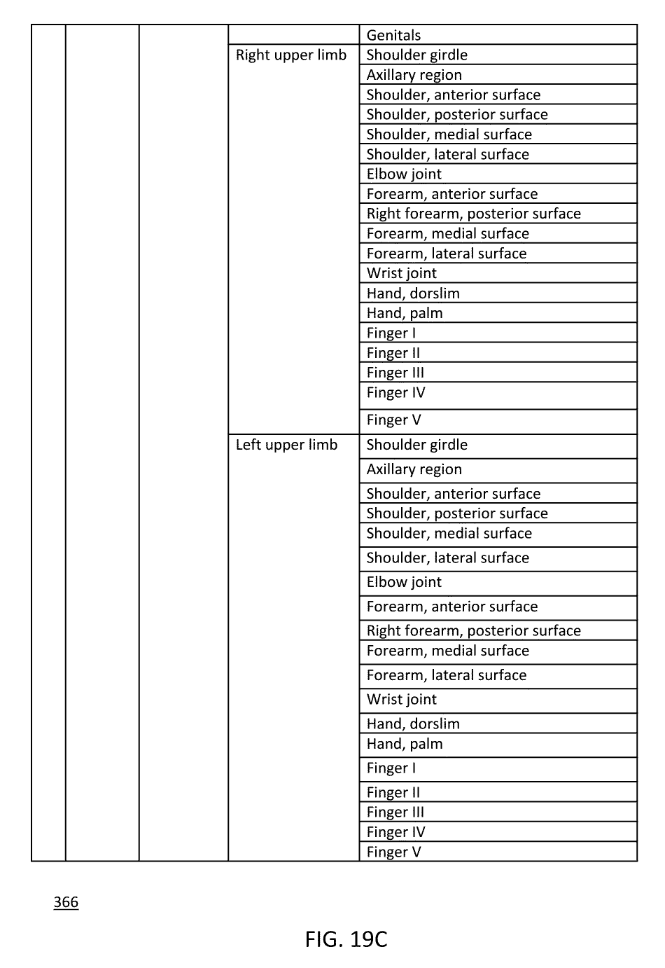

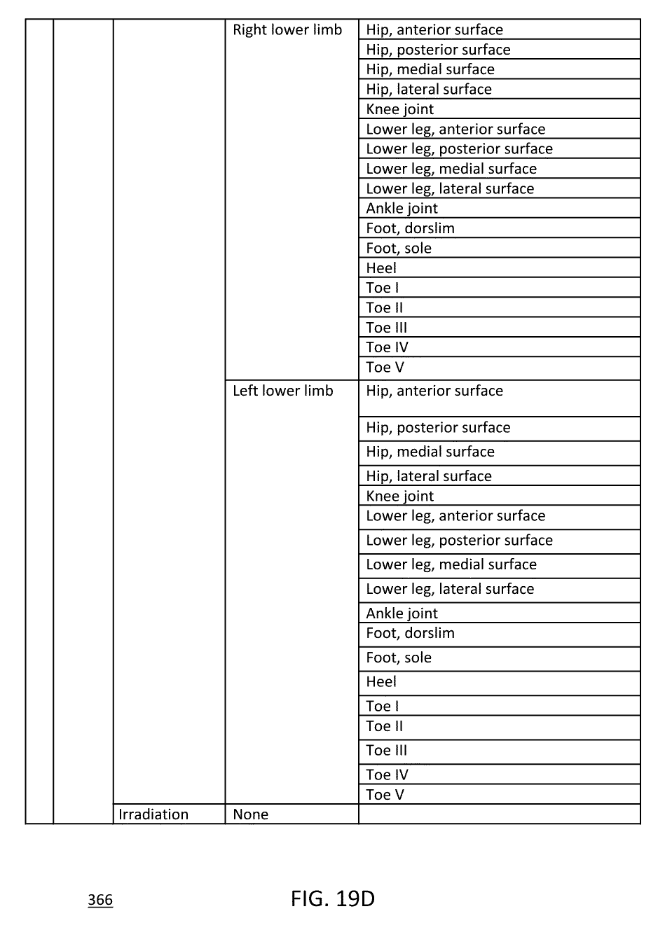

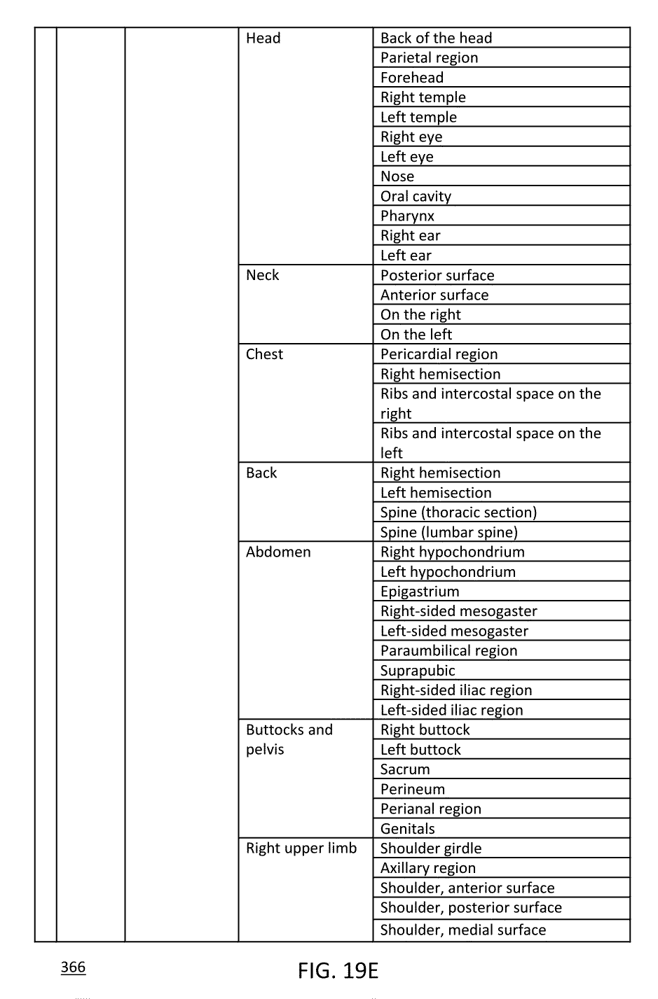

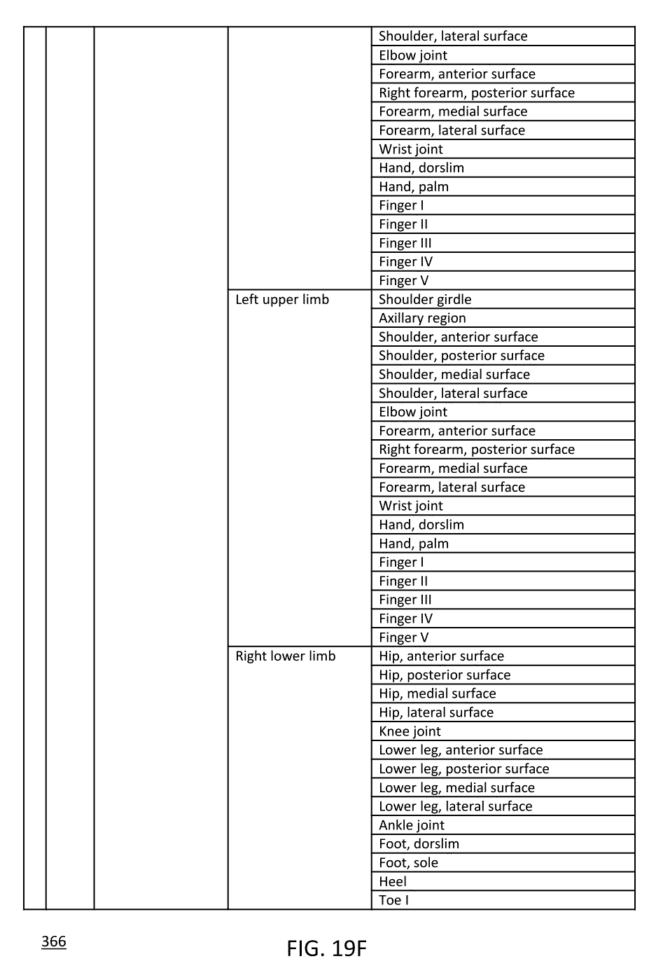

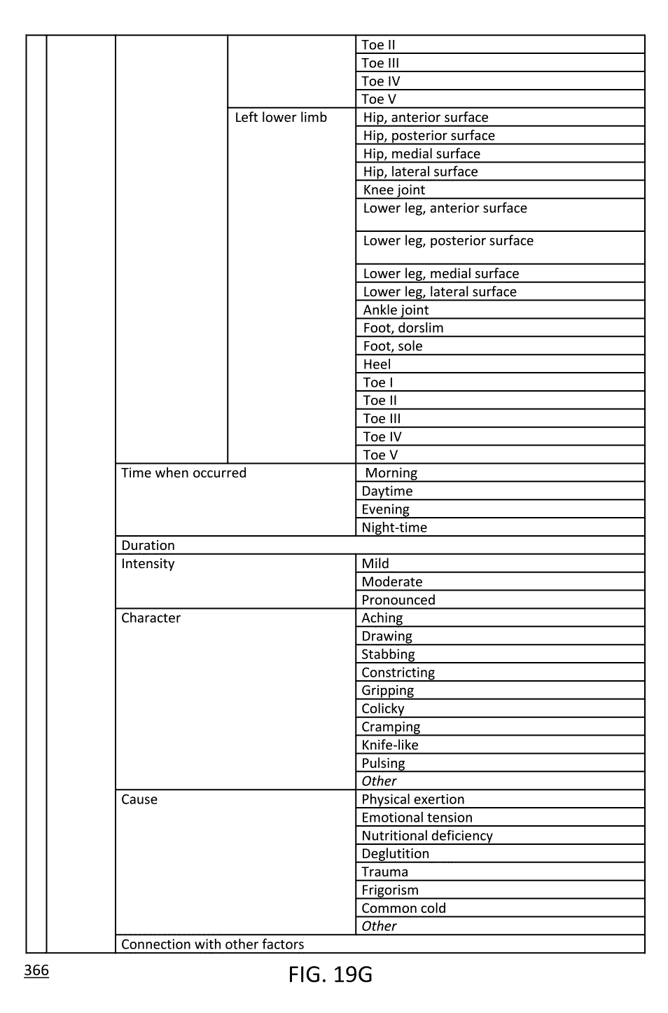

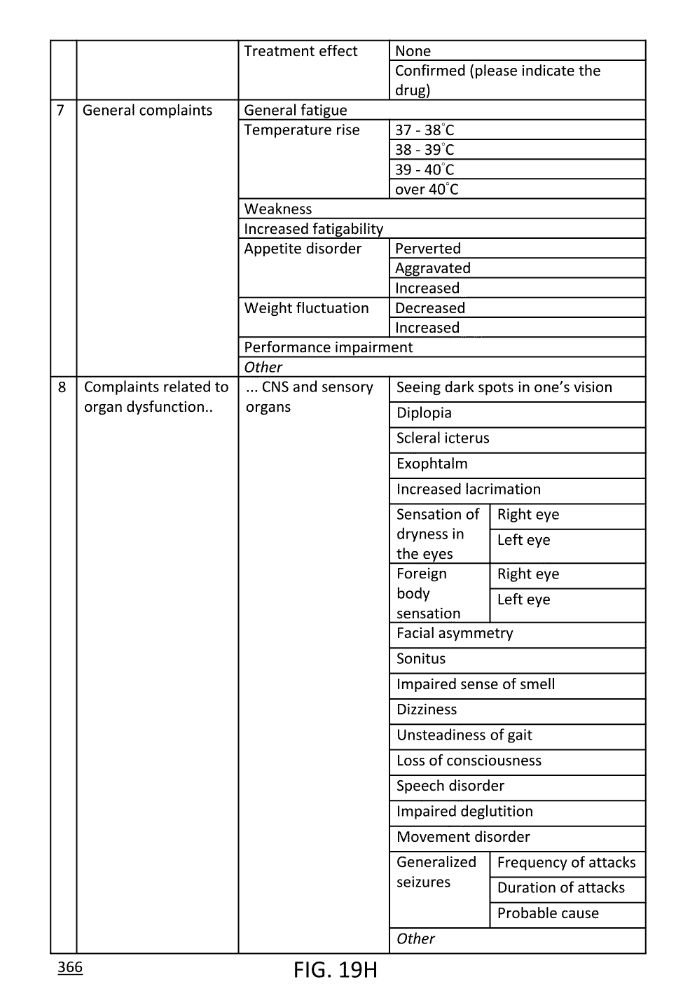

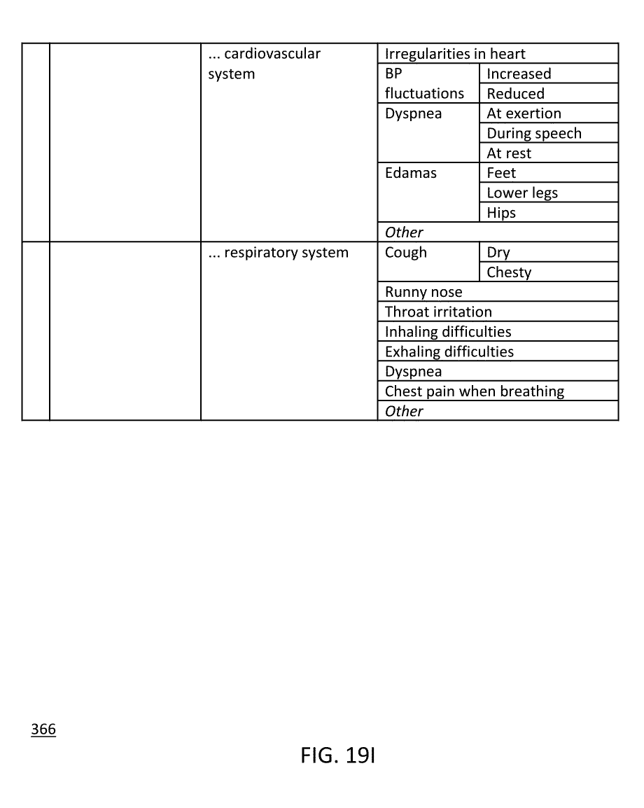

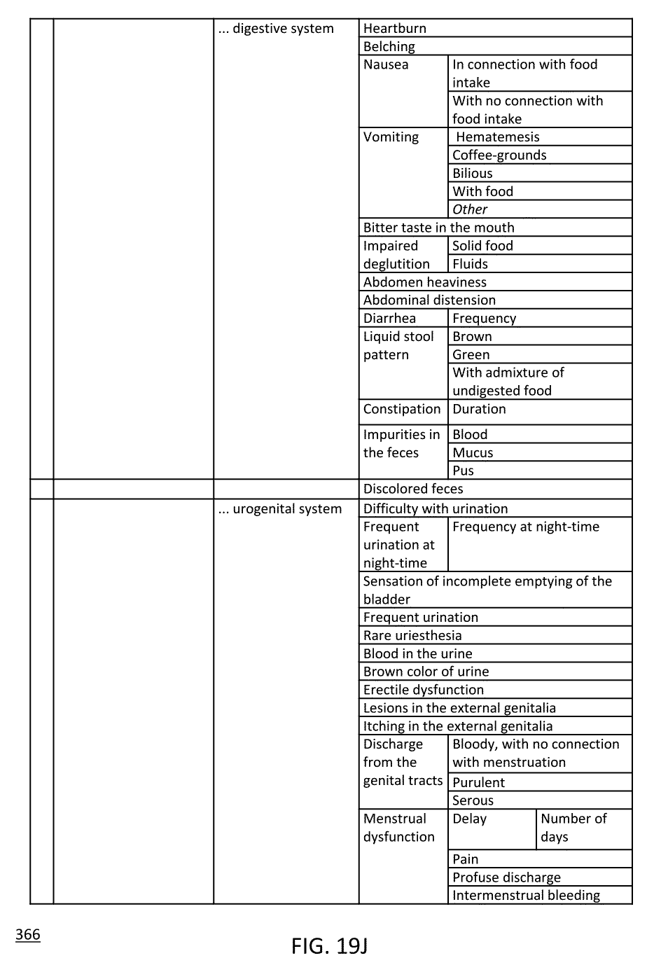

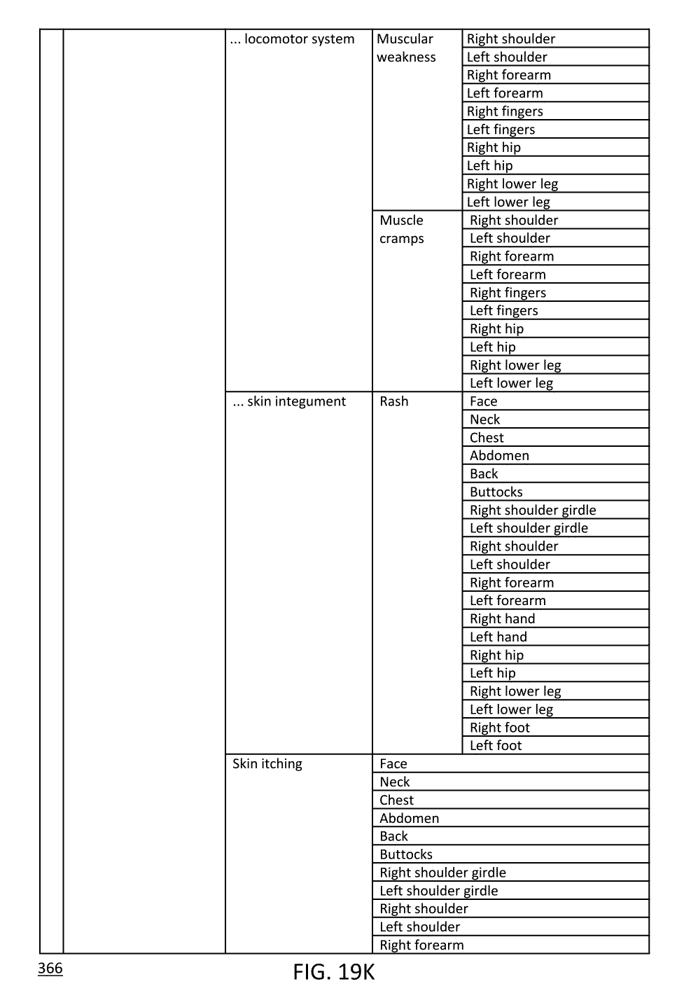

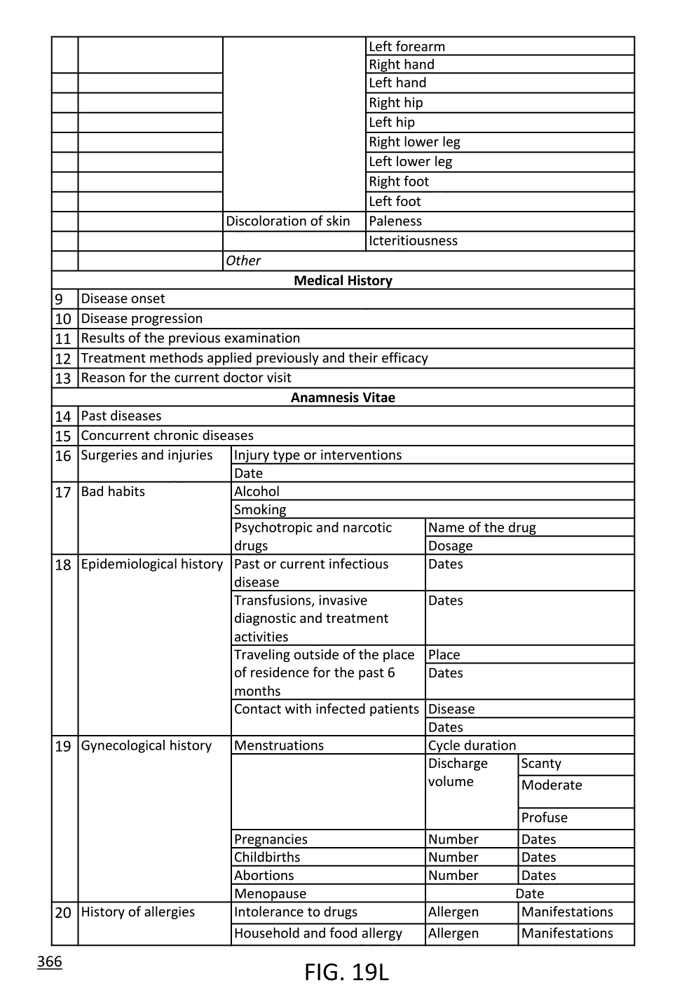

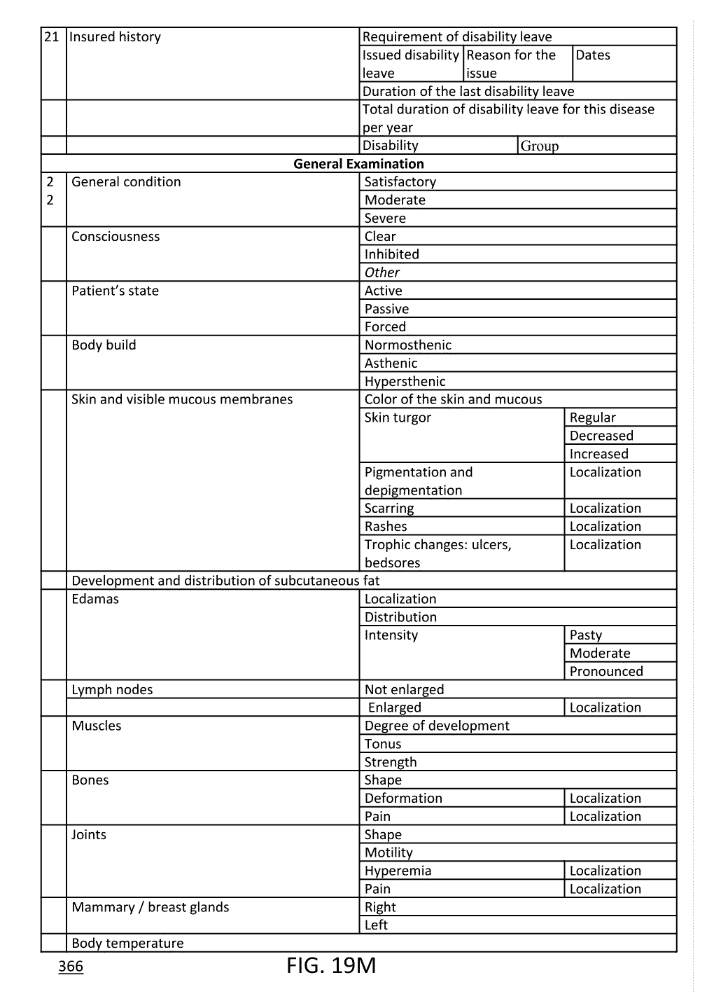

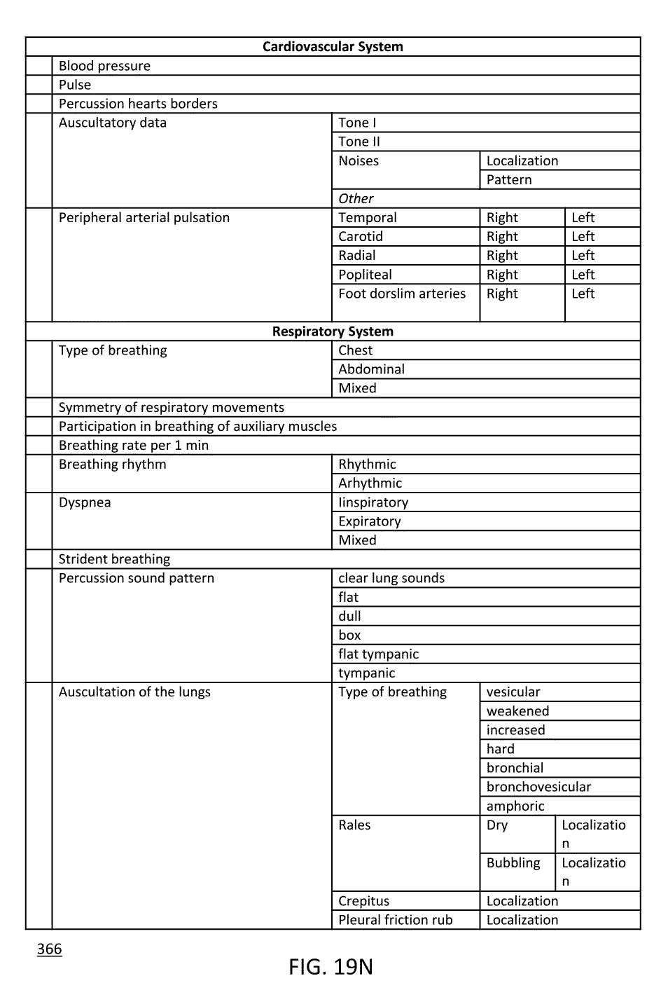

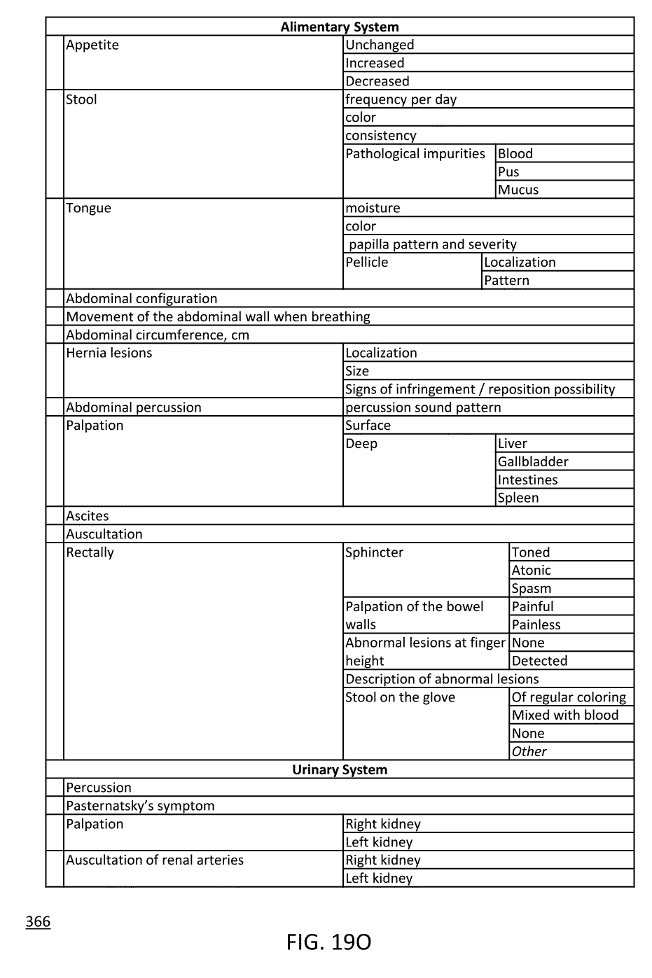

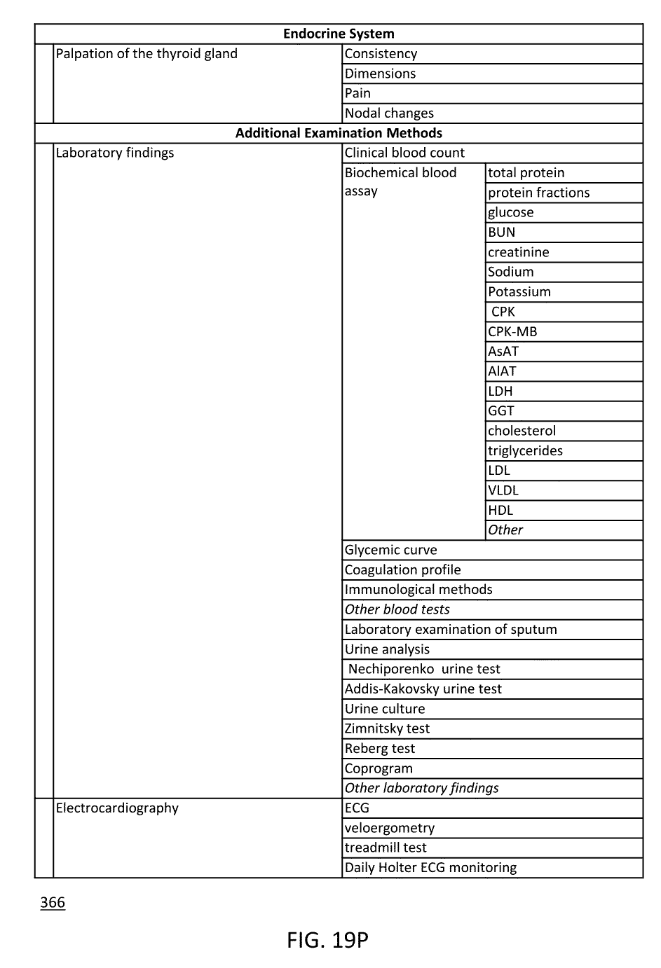

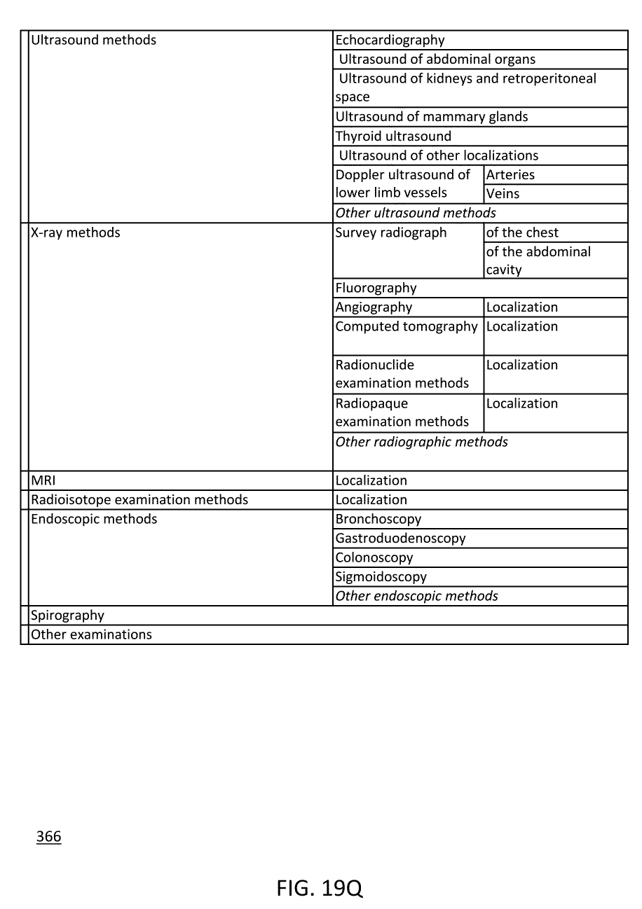

FIGS. 19A-Q illustrate an exemplary list of fields for general practitioners' primary patient examination protocol 366. As an example, during a physical exam, a health care provider will measure the weight, height, and blood pressure of the patient, obtain urine and blood samples for analysis, and perform various exams such as a heart exam including obtaining an electrocardiogram (ECG or EKG), respiratory system exam, breast exam, pelvic exam including a pap smear, testicular exam, penis exam, and prostate exam including measuring the level of Prostate Specific Antigen (PSA). The blood analysis includes, but is not limited to, obtaining the level of white blood cell count, red blood cell count, platelet count, hemoglobin, hematocrit, cholesterol (LDL, HDL, triglycerides), glucose, minerals (such as potassium, calcium, sodium, and chloride), total protein, creatinine, bilirubin, albumin, vitamin D, uric acid, thyroxine, and thyroid stimulating hormone (TSH). The urine analysis includes, but is not limited to, obtaining the color and appearance of the urine and obtaining the level of glucose, bilirubin, ketone, blood, and protein. A mammogram, colorectal cancer screening, and osteoporosis screening are also performed as preventive means. The tests and exams are examples of the list of fields on a patient's physical examination form.

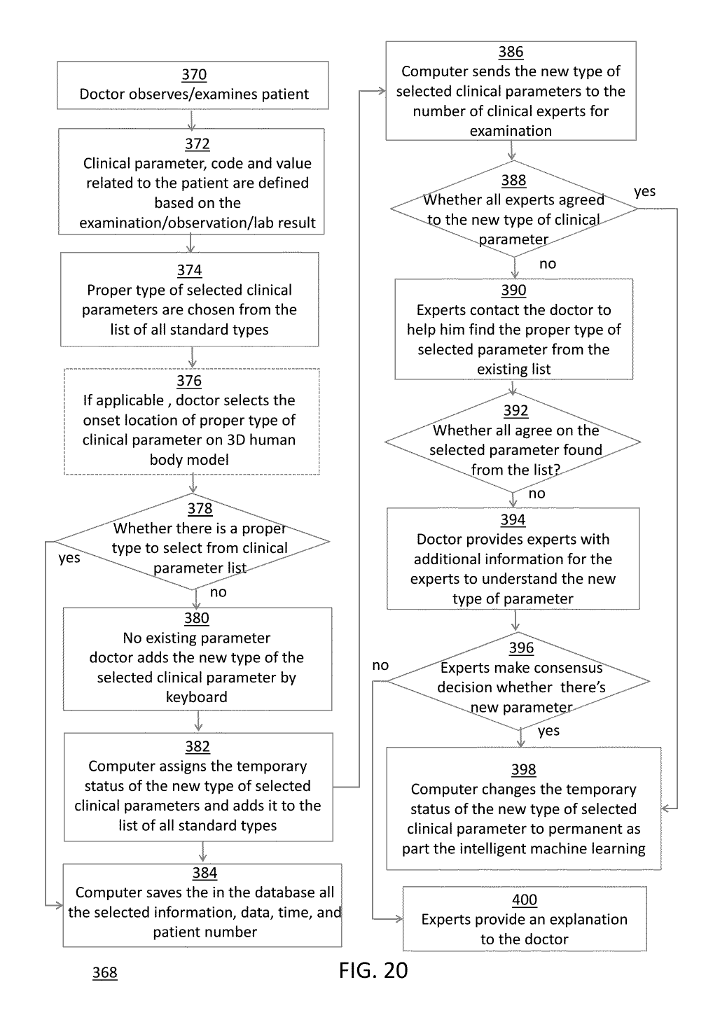

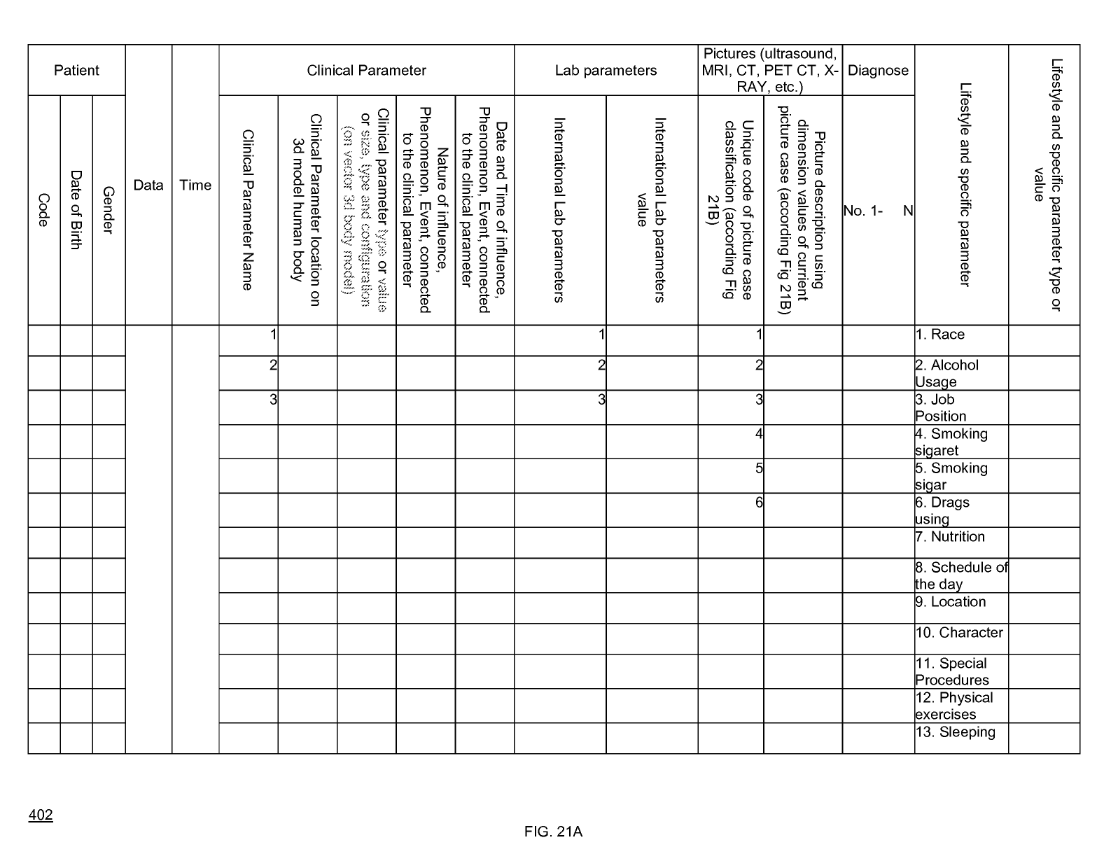

FIG. 20 is an exemplary flow chart illustrating the process 368 in clinical record standardization. At step 370, a doctor/physician conducts clinical activities, and translates results of these activities, particularly unstructured clinical data to standard type which is universal by selecting/adding proper parameters and codes from the list under an expert decision control procedure to feed and interact with the system, to fulfill the type and parameter as an algorithm of the self-learning system. At step 374, the physician/doctor conducts the clinical activities (e.g., general examination/observation of patient's symptoms or complaints) by following guidelines and procedures of patient examination protocol, such as complaints (local pain in head, right eye, etc.), general examination (body temperature, pulse) lab findings (blood count), image test (CT, MRI), medical history. Each of the check items has predefined corresponding clinical parameters and codes from a list of clinical parameters, codes and values related to the patient are defined based on the examination/observation/lab result. The proper types of selected clinical parameters are chosen from the list of all standard types, such as name of influence, phenomenon, event connected to the clinical parameters, international lab parameters, and values (including standardized scale to measure a patient's symptoms/complaint intensity of pain), lifestyle and specific parameters and values at different times/dates of a specific patient code, age and gender as standardized data to feed the self-learning system. At step 376, if applicable, physician/doctor selects the onset location of the proper type of clinical parameter on a three-dimensional human body model, including the precise location of onset with picture transferred on vector three-dimensional human body model. If there is no proper type of clinical parameter in existing parameter list, the physician/doctor manually adds the new type o selected clinical parameter. A computer assigns the temporary status of the new type of selected clinical parameter(s) and adds it to the list of all standard types. If the computer sends the new type of selected clinical parameters to the number of clinical experts for examination. If the selected experts agree to the new type of clinical parameter, the computer changes the temporary status of the new type of selected clinical parameter to permanent, as part of the intelligent machine learning process. In instances where the consensus cannot be reached by the experts on the new type of parameter, the experts would contact the physician/doctor to assist the doctor to find the proper type of selected parameter from the existing list. If the outcome is not agreed upon by the selected experts in relation to the selected parameter found from the list, the physician/doctor provides experts with additional information for the expert to understand the new type of parameter. The selected experts make unanimous decision as to whether there is new parameter, and if there is a newly found parameter, the computer changes the temporary status of the new type of selected clinical parameter to permanent; as part of intelligent machine learning process. Otherwise, the selected experts provide an explanation to the physician/doctor that there is no new parameter.

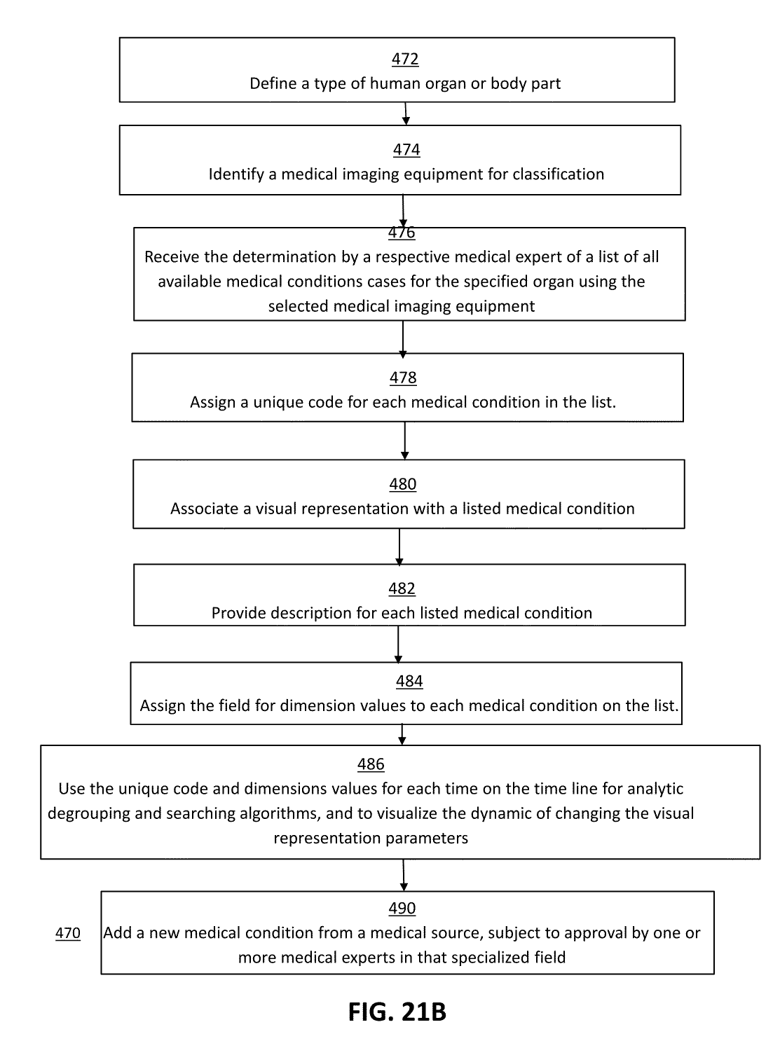

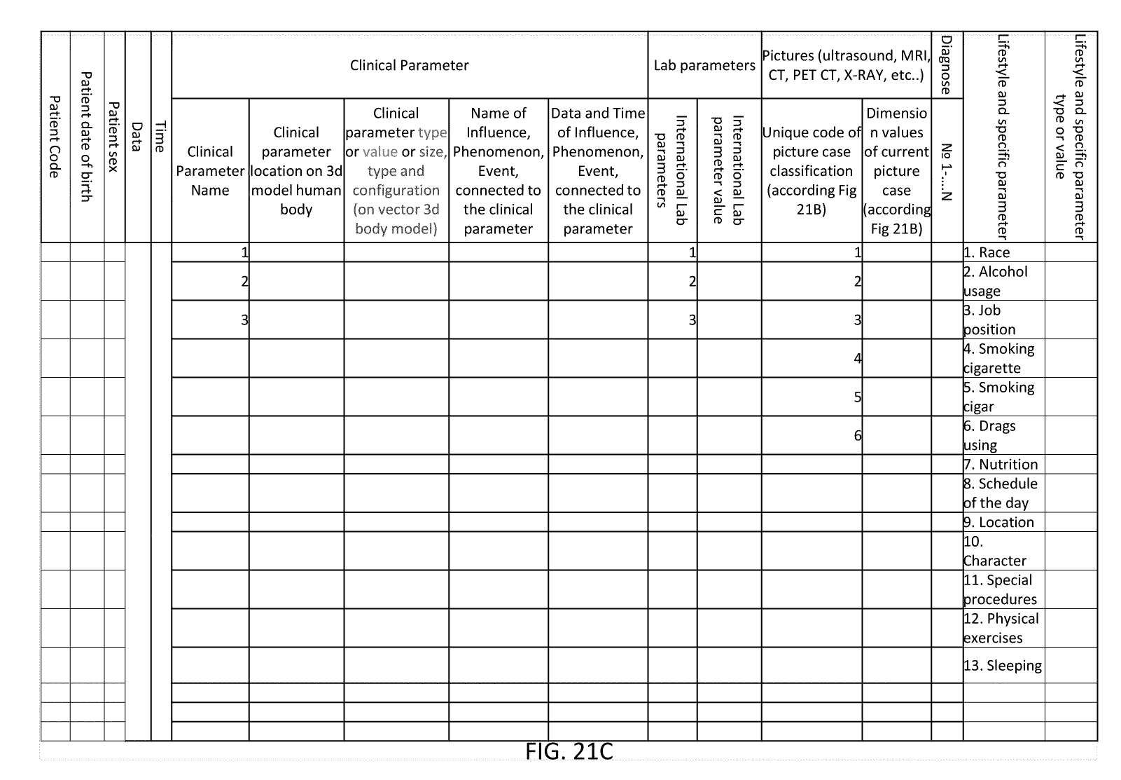

FIG. 21A is an exemplary clinical parameter and code list 402 for standardization of clinical records. Clinical parameter and code list may include data and parameter code such as patient's name, age, clinic visit date, patient's symptoms and complaints (pain, organ dysfunctions, etc.), patient's medical history, anamnesis vitae, general examination (of general condition, lymph nodes, bones, body temperature, cardiovascular system, respiratory system, alimentary system, urinary system, and additional examinations), clinical parameter, lab parameter, disease and lifestyle, etc. The standardization of clinical records is to standardize clinical language in one computer information size, such as one byte of data. In other words, one byte of computer information data would hold the standardized clinical language as entered into the clinical parameter and code list 402. With the standardized clinical language in one byte, a patient's clinical parameter and code list 402 can be easily translated from one language to another language, such as translating from English to French, or from English to Chinese, as well providing a standardized information for database searching and computer analysis.

FIG. 21B is a flow diagram illustrating the process 470 of standardization for visual representations (including medical images) from a medical imaging equipment, while FIG. 21C is a block diagram illustrating an exemplary clinical parameter and code list for standardization of clinical visual representation records in accordance with the present disclosure. The standardization of clinical language includes categorizing medical images for creating visual representations of the interior of a body for clinical analysis and medical intervention. Medical imaging provides two-dimensional and three-dimensional representations of internal structures hidden by tissues such as the skin and bones, as well as to diagnose and treat disease. The medical imaging equipment is part of biological imaging and incorporates radiology which uses the imaging technologies of ultrasound, computed tomography (CT), magnetic resonance imaging (MRI), positron emission tomography (PET/CT), X-ray radiography, medical ultrasonography, endoscopy, elastography, tactile imaging, thermography, medical photography and nuclear medicine functional imaging techniques as positron emission tomography. At step 472, the intelligent medical engine 14 is configured to define a type of human organ or body part, such as kidney, the person's head, right hand, etc.). At step 474, the intelligent medical engine 14 is configured to identify a medical imaging equipment used for classification of visual representations. At step 476, the intelligent medical engine 14 is configured to determine, by a respective medical expert, of a list of all available medical conditions cases for the specified organ using the selected medical imaging equipment. The intelligent medical engine 14 is configured, at step 478, to assign a unique code for each medical condition associated with the specified organ. At step 480, each visual representation is associated with a listed medical condition. At step 482, a corresponding description is provided for each listed medical condition. At step 484, one or more dimensional values are assigned for each listed medical condition. At step 486, the intelligent medical engine 14 is configured to use the unique code and dimensions (values or sizes) for each time on the time line for analytic degrouping and searching algorithms, and to visualize the dynamic of changing the visual representation parameters. At step 490, the intelligent medical engine 14 is configured to add a new medical condition from a medical source, subject to approval by one or more medical experts in that specialized field.

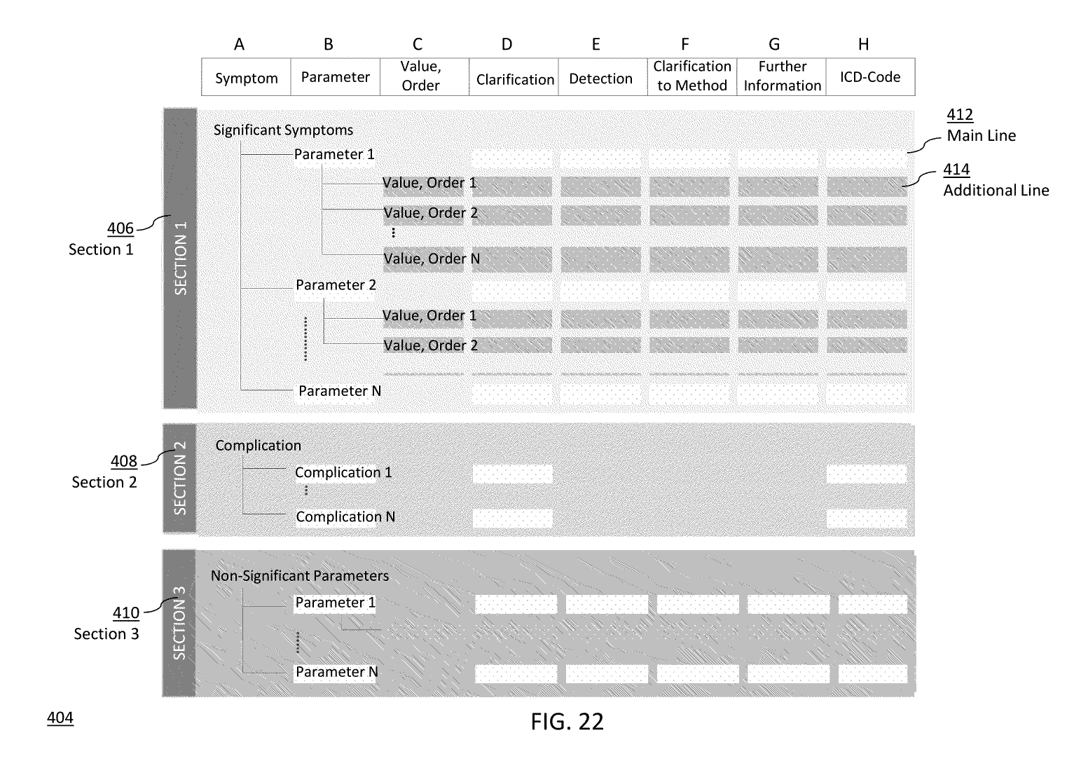

FIG. 22 is a block diagram illustrating an exemplary structure of clinical parameter form 404. In this illustration and embodiment, the clinical parameter form has three sections: Section 1 (406) comprises of significant (or main) parameters data; Section 2 (408) comprises complication data; and Section 3 (410) comprises indirect parameter data. Main (also referred to as “significant”) parameters define the stage, severity and the form of the disease. The significant parameters can include complaints, examination data, laboratory results, the data from instrumental tests, indications of other diseases. In one embodiment, indirect parameters do not directly impact and change with the course of the disease. In Sections 1 and 3, each parameter can take a fixed number of columns in the table, but an arbitrary number of rows, depending on the number of values, orders or forms. This structural unit is called a “parameter module”. Each parameter module has a “main line” 412 and “additional line” 414. The “main line” 412 contains: (1) the name of the parameter, under column “B”; (2) specification and general information about the parameter in the context of this disease, which has to be inscribed (use keyword) under column “D”; (3) the general methods for the determination of the parameter under column “E”; (4) an explanation of the general methods under column “F”; and (5) further information concerning the parameter under column “G”. Each “main line” 412 explores an “additional line” 414 where the values, order or form subjective to the main line parameter have to be specified. Each value order or form includes: (1) description of the value under column “C”; (2) values, order or form of the parameter such as laboratory ranges, size, localization of the pathological focus, type of lesions, the severity of a symptom, its duration, which have to be specified in the field under column “E”; (3) the parameter value specification in the context of the described diseases and explanations for each of the values under column “D”; (4) the value specific methods for the determination of the parameter under column “F”; and (5) further information concerning the value under column “G”.

In Section 2, the complications are described with the following: (1) the name of the parameter is specified under column “B”; (2) the description of the parameter is specified under column “D”; (3) the ICD code is specified under column “G”. The main (significant) parameters may define the stage, severity and the form of the disease. Parameters can include complaints, examination data, laboratory results, the data of instrumental tests, indications of other diseases.

In Section 3, indirect parameters 410 typically do not change with the course of the disease. The “main line” 412 contains: (1) the name of the parameter, under column “B”; (2) specification and general information about the parameter in the context of this disease, which has to be inscribed (use keyword) under column “D”; (3) the general methods for the determination of the parameter under column “E”; (4) an explanation of the general methods under column “F”; (5) further information concerning the parameter under column “G”. Each “main line” 412 explores an “additional line” 414 where the values, order or form subjective to the main line parameter have to be specified. Each value order or form includes: (1) description of the value under column “C”; (2) values, order or form of the parameter such as laboratory ranges, size, localization of the pathological focus, type of lesions, the severity of a symptom, its duration, which have to be specified in the field under column “E”; (3) the parameter value specification in the context of the described diseases and explanations for each of the values under column “D”; (4) the value specific methods for the determination of the parameter under column “F”; and (5) further information concerning the value under column “G”. In Section 2, the name of the parameter is specified under column “B”, the description of the parameter is specified under column “D” 3 and the ICD code is specified under column “H”.

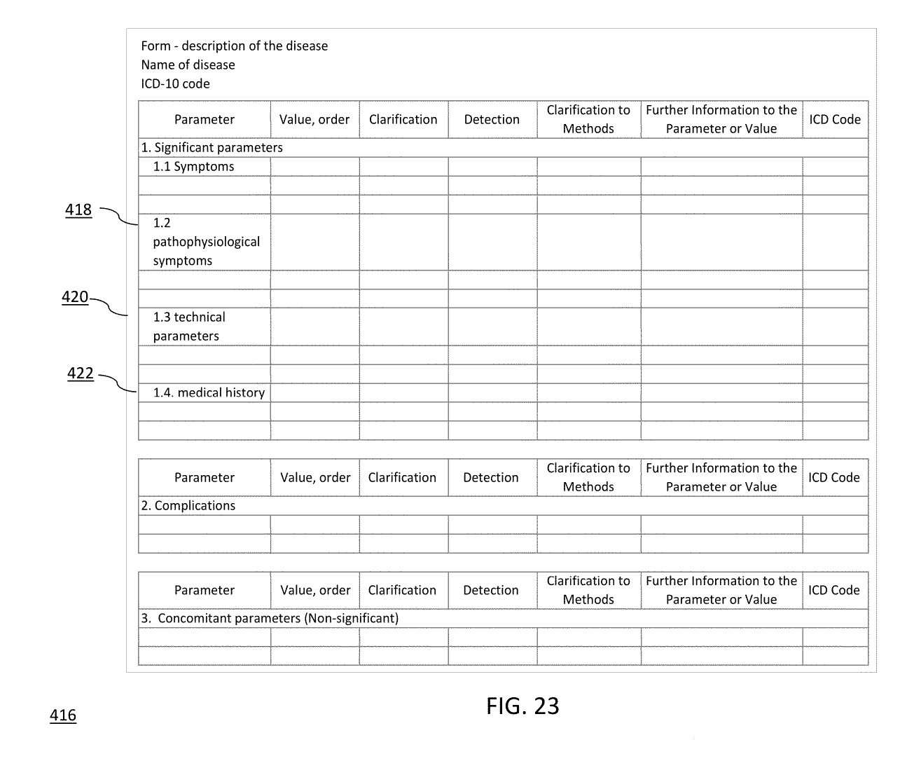

FIG. 23 is an exemplary blank clinical parameter form 416. Item “1.2 pathophysiological symptoms” 418 under column 1. “Significant parameters” includes parameters of changing functions of the body that lead to a pathophysiological condition and that have major influence on medical condition, diagnostic screening and therapy. Item “1.3 technical parameters” 420 includes parameters for using and operating medical equipment. Item 1.4 medical history” 422 includes parameters of the patient and/or close family members with relation to the actual disease (background diseases, genes). The field under column “ICD-code” includes further information of associated item (1.4).

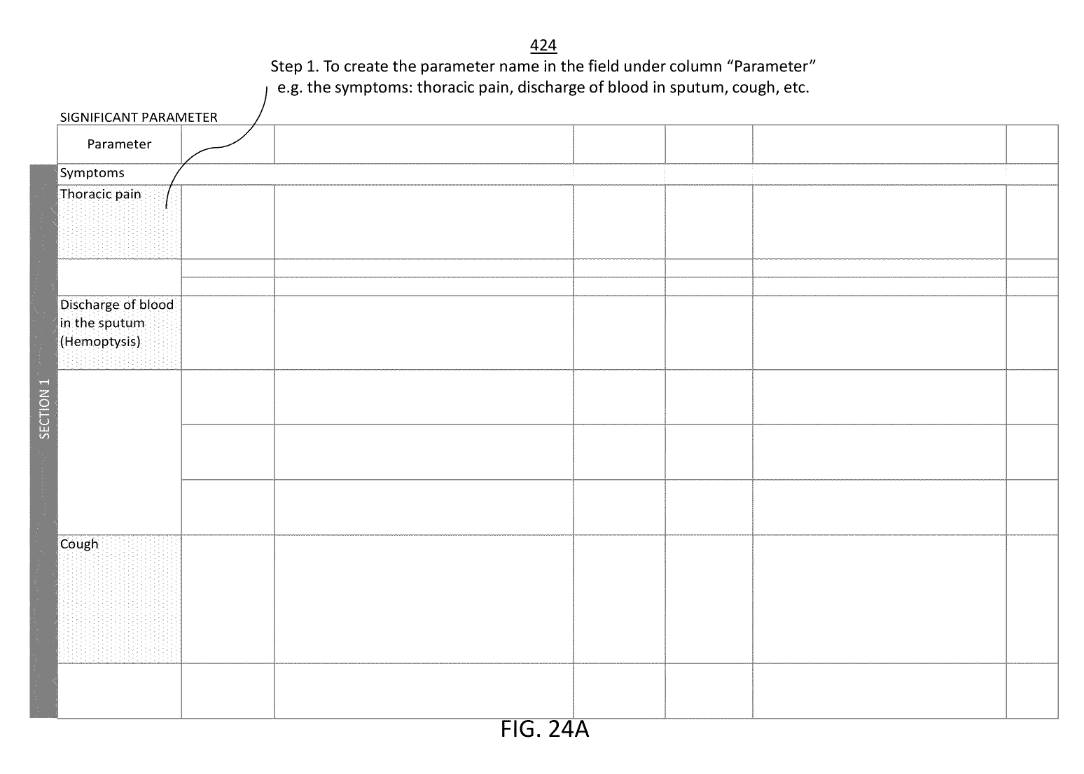

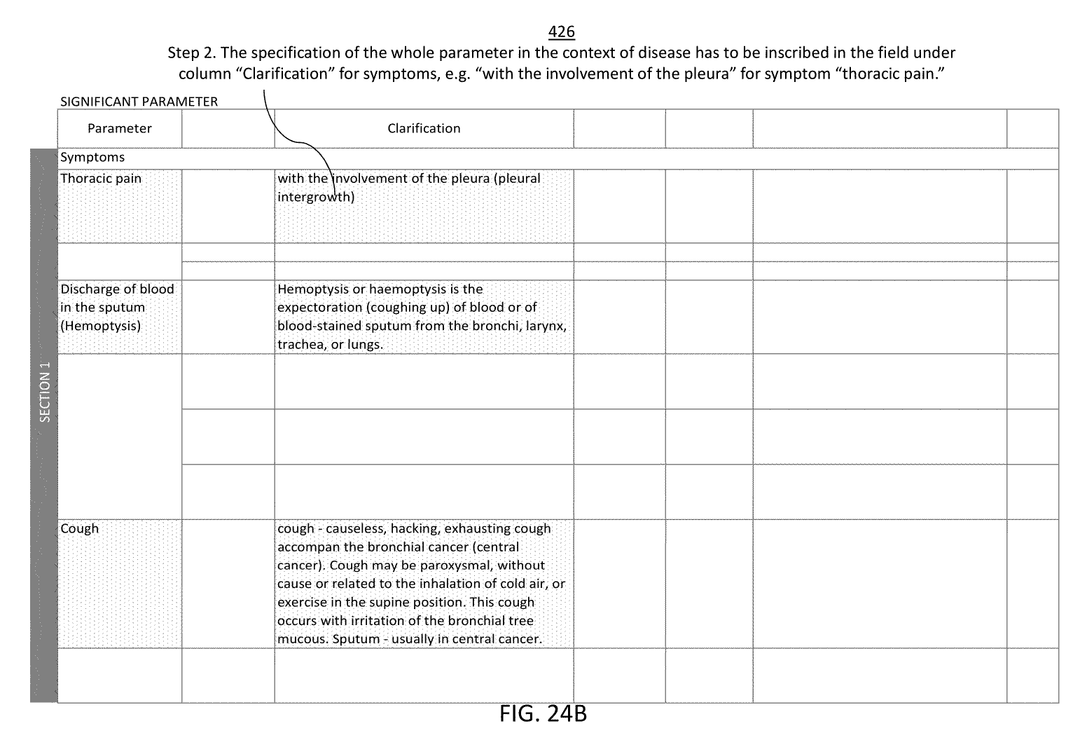

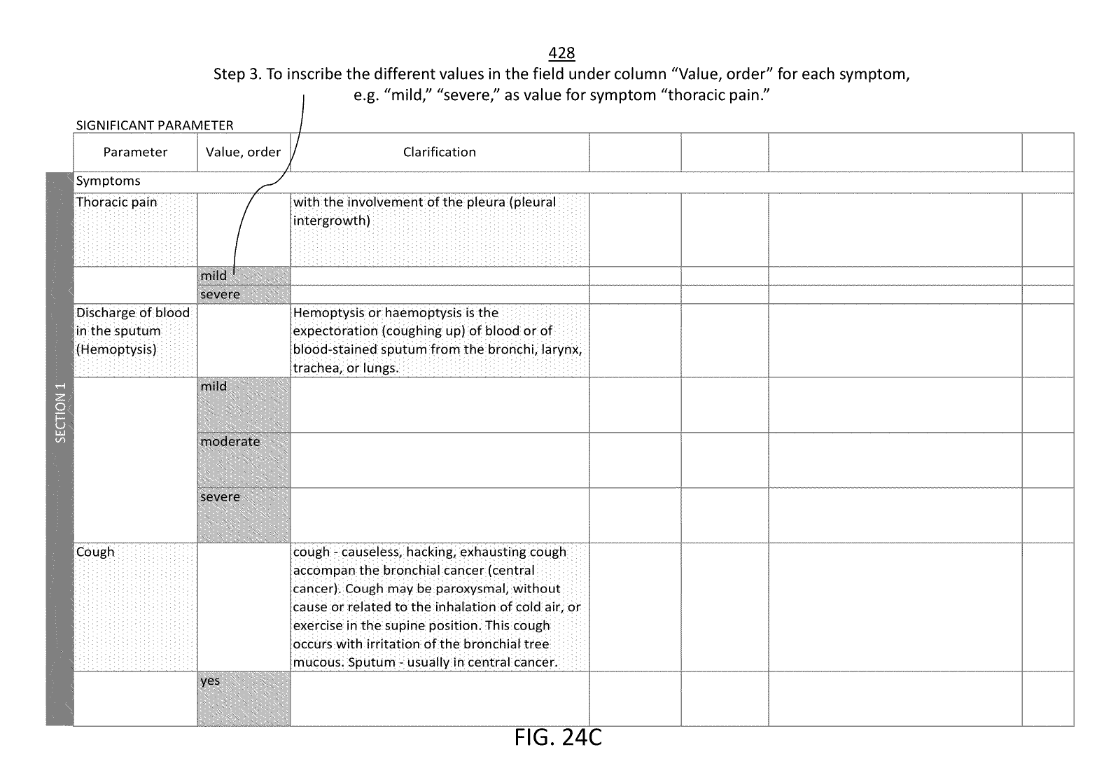

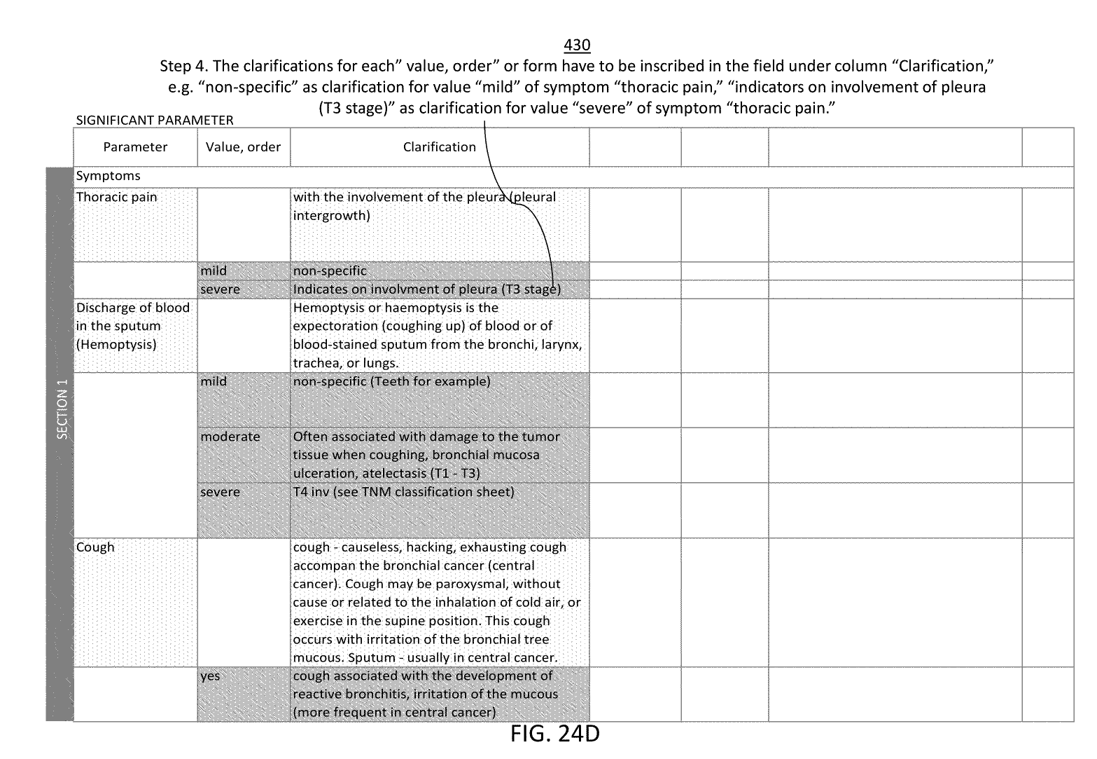

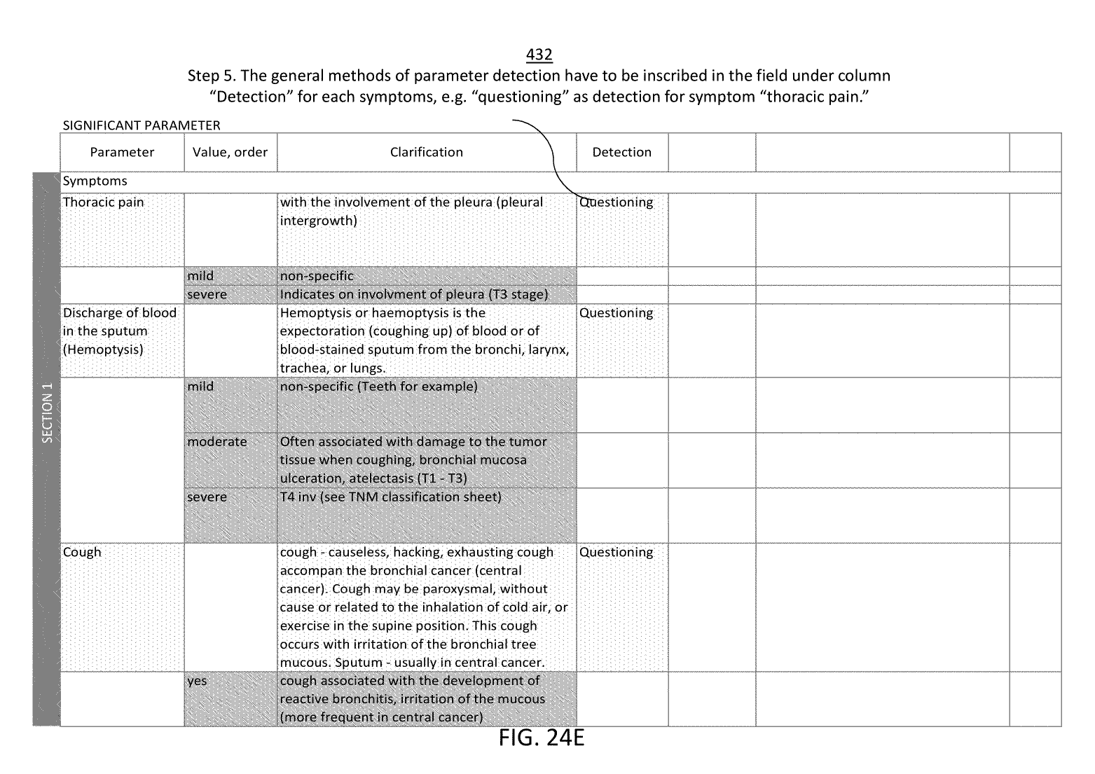

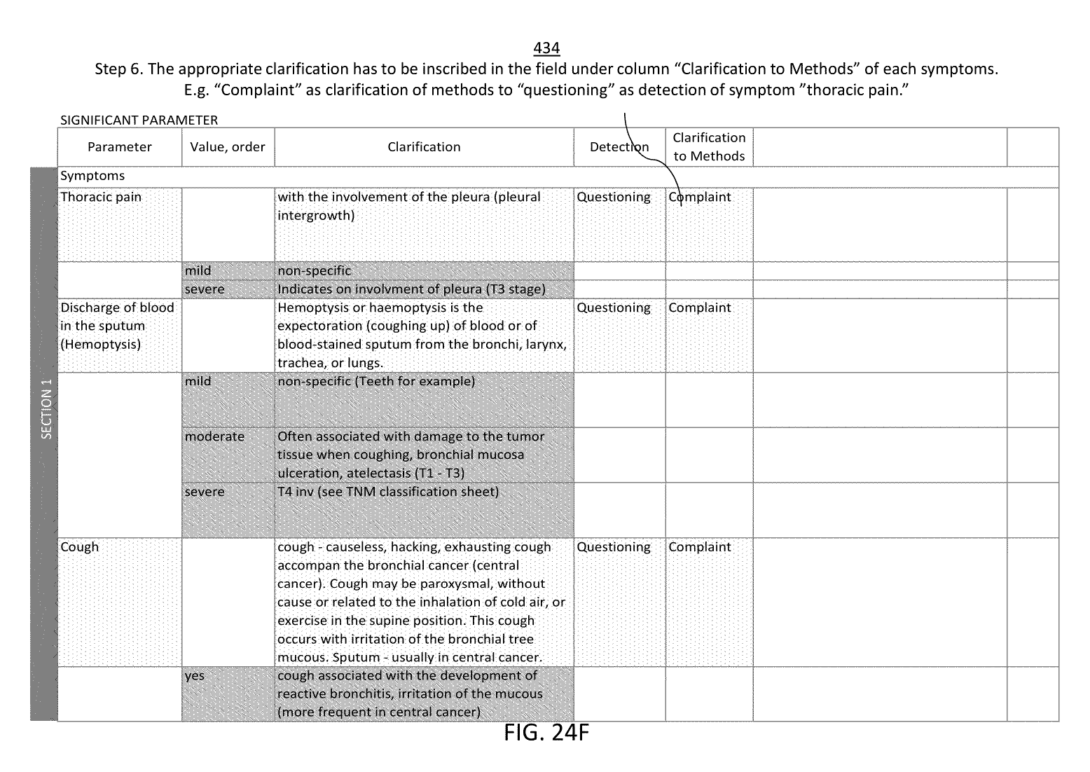

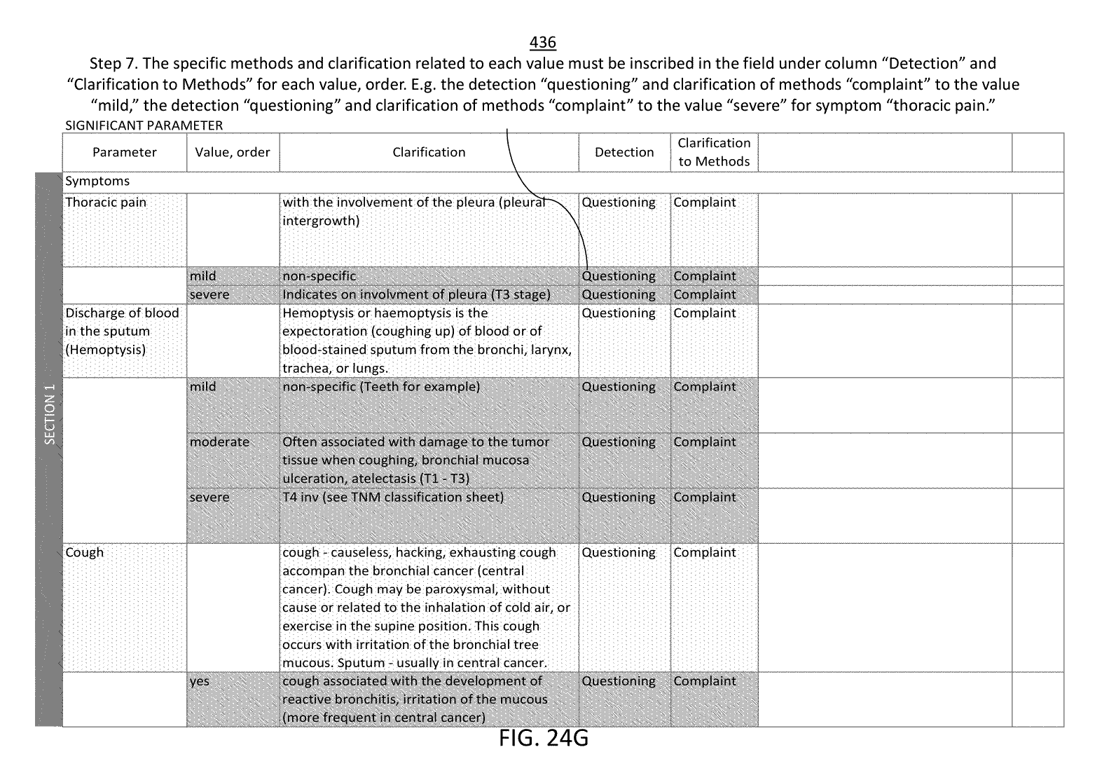

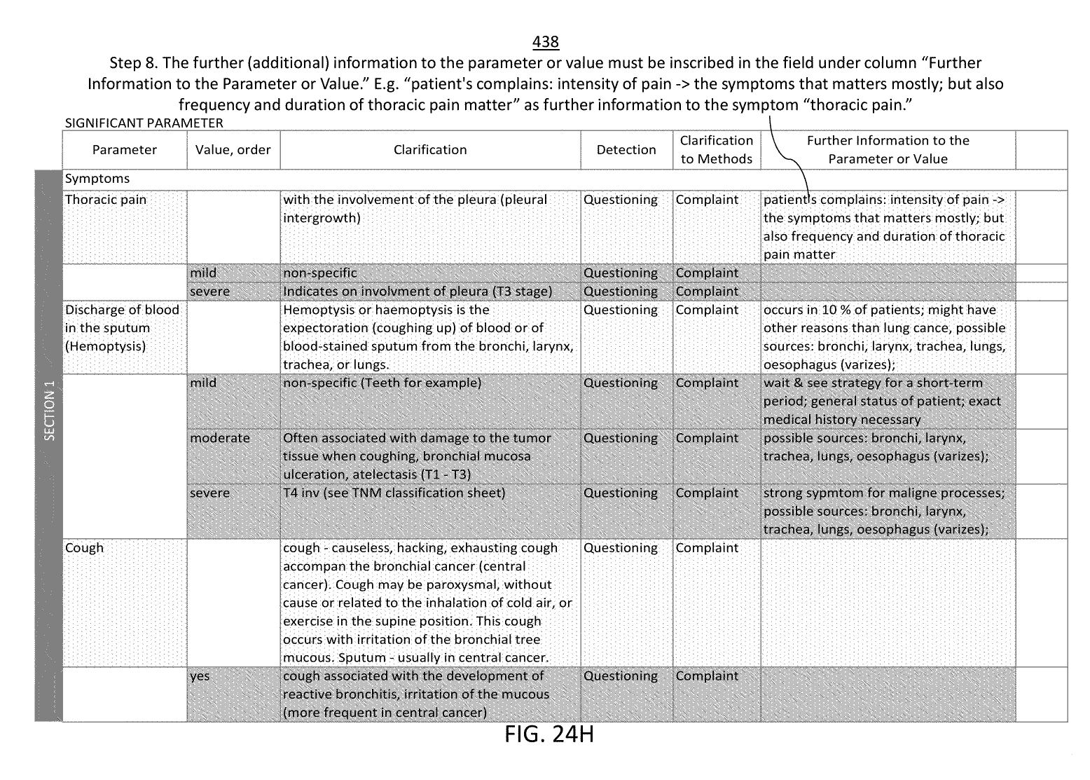

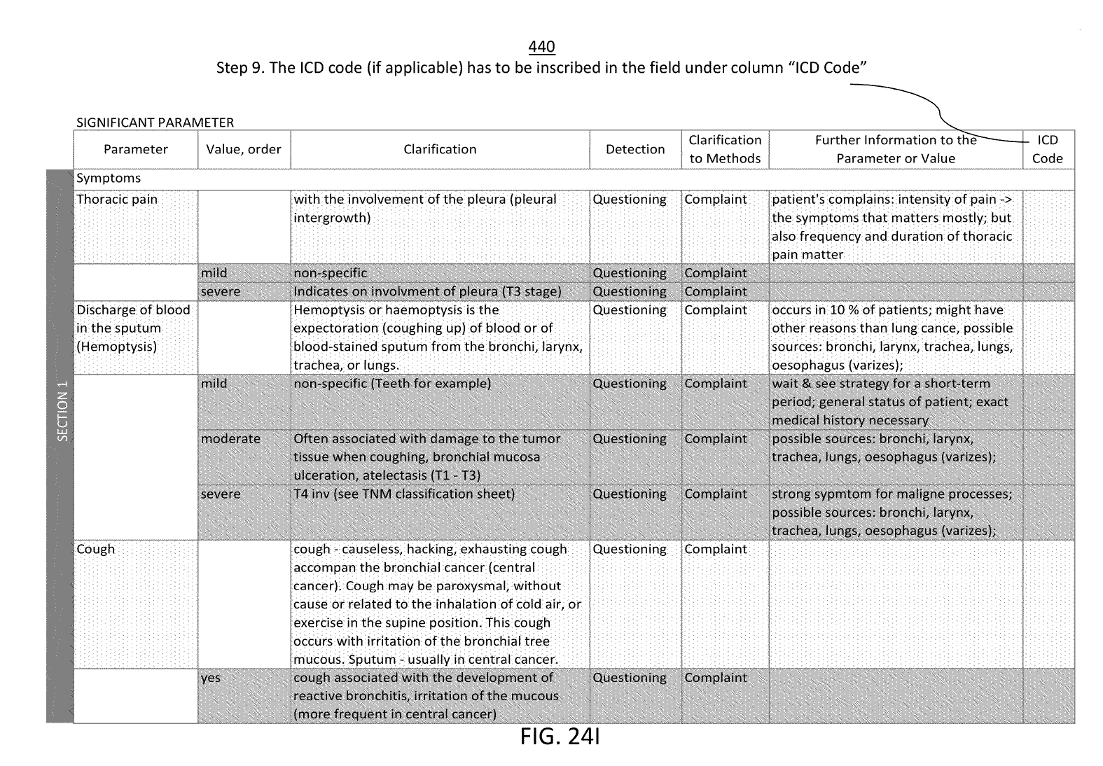

FIG. 24A is an exemplary instruction 424 to create a clinical parameter form for lung cancer—Step 1. Taking Section 1 of the form as example, the first step is to create the parameter name in the field under column “Parameter”, e.g. the (significant) symptoms include thoracic pain, discharge of blood in sputum, and cough.

FIG. 24B is an exemplary instruction 426 to create a clinical parameter form for lung cancer—Step 2. The specification of the whole parameter in the context of disease has to be inscribed in the field under column “Clarification” for symptoms, e.g. “with the involvement of the pleura” for symptom “thoracic pain”.

FIG. 24C is an exemplary instruction 428 to create a clinical parameter form for lung cancer—Step 3. To inscribe the different values in the field under column “Value, order” for each symptoms, e.g. “mild”, “severe” as value for symptom “thoracic pain”.

FIG. 24D is an exemplary instruction 430 to create a clinical parameter form for lung cancer—Step 4. The clarifications for each “value, order” or form have to be inscribed in the field under column “Clarification”, e.g. “non-specific” as clarification for value “mild” of symptom “thoracic pain”, “indicators on involvement of pleura (T3 stage)” as clarification for value “severe” of symptom “thoracic pain”.

FIG. 24E is an exemplary instruction 432 to create a clinical parameter form for lung cancer—Step 5. The general methods of parameter detection have to be inscribed in the field under column “Detection” for each symptom, e.g. “questioning” as detection for symptom “thoracic pain”.

FIG. 24F is an exemplary instruction 434 to create an clinical parameter form for lung cancer—Step 6. The appropriate clarification has to be inscribed in the field under column

“Clarification to Methods” of each symptoms, e.g. “Complaint” as clarification to methods to “questioning” as detection of symptom “thoracic pain”.

FIG. 24G is an exemplary instruction 436 to create a clinical parameter form for lung cancer—Step 7. The appropriate clarification has to be inscribed in the field under column “Clarification to Methods” of each symptoms, e.g. “Complaint” as clarification to methods to “questioning” as detection of symptom “thoracic pain”.

FIG. 24H is an exemplary instruction 438 to create a clinical parameter form for lung cancer—Step 8. The further (additional) information to the parameter or value must be inscribed in the field under column “Further Information to the Parameter or Value”, e.g. “patient's complains: intensity of pain->the symptoms that matters most; but also frequency and duration of thoracic pain matter” as further information to the symptom “thoracic pain”.

FIG. 24I is an exemplary instruction 440 to create an clinical parameter form for lung cancer—Step 9. The ICD code (if applicable) has to be inscribed in the field under column “ICD Code”.

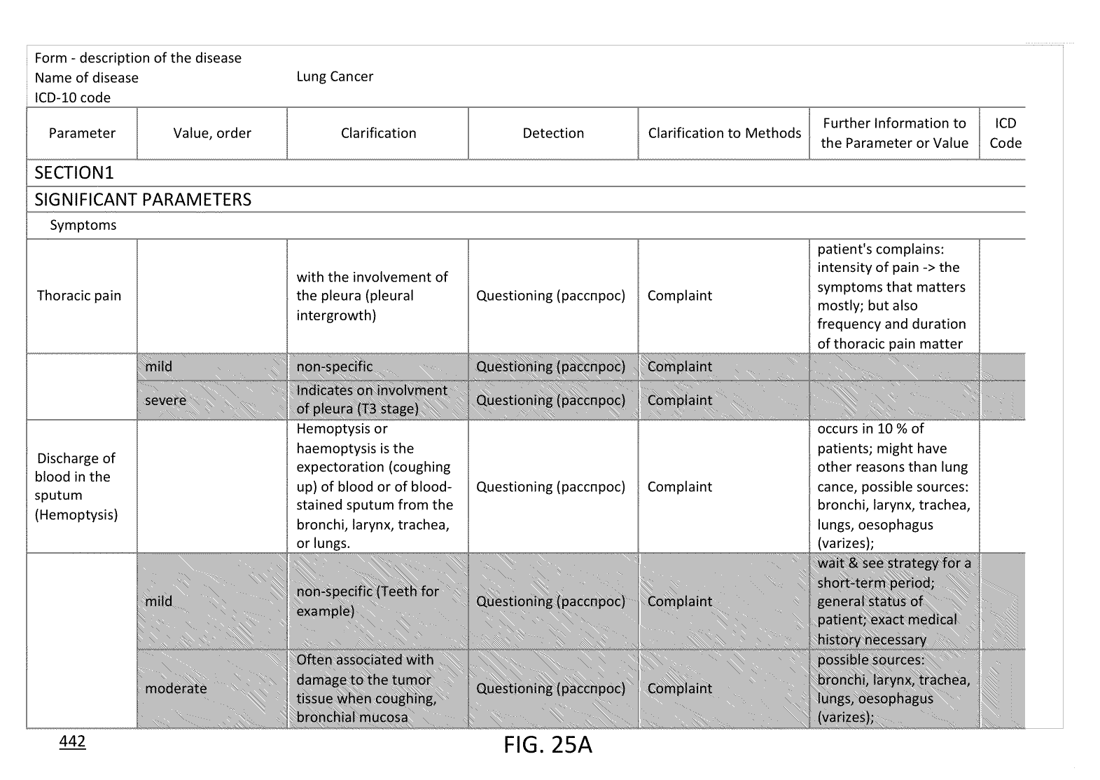

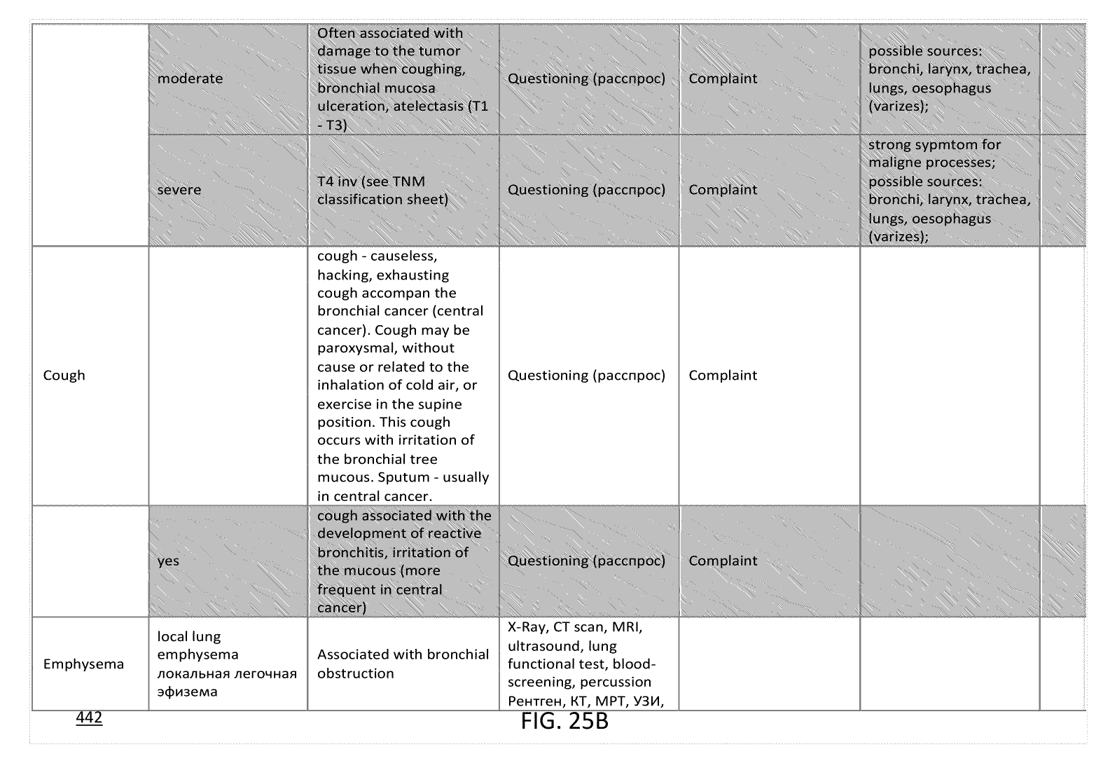

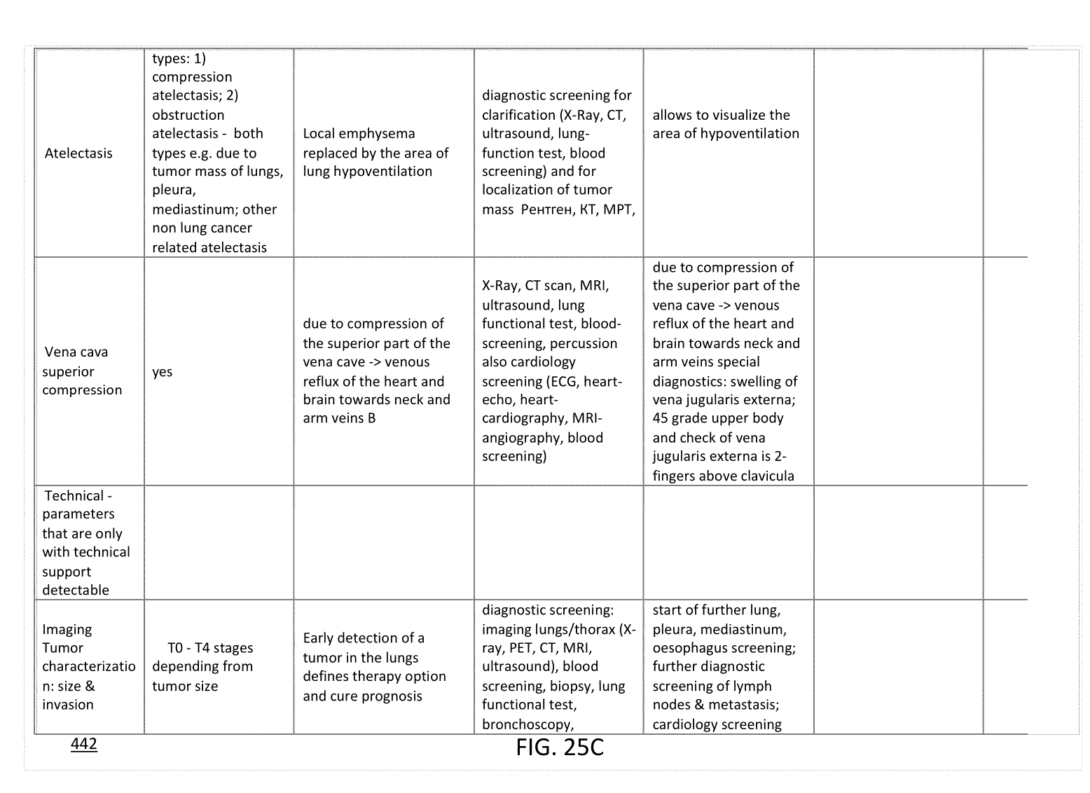

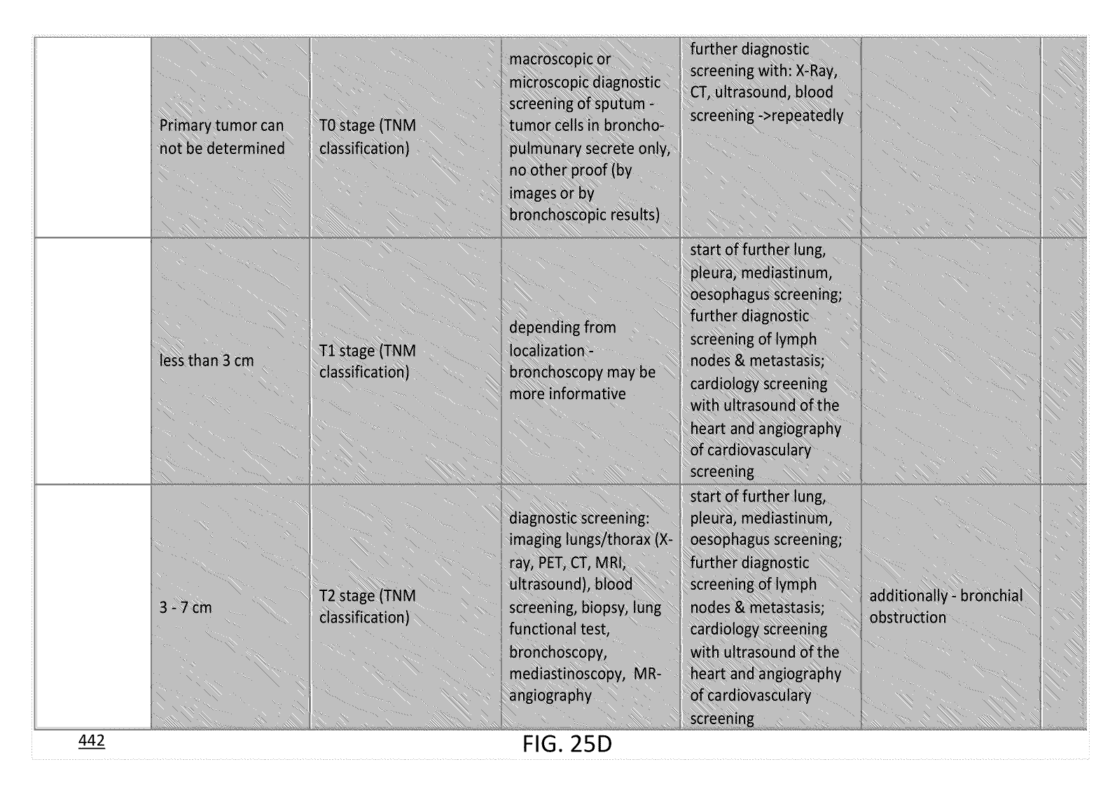

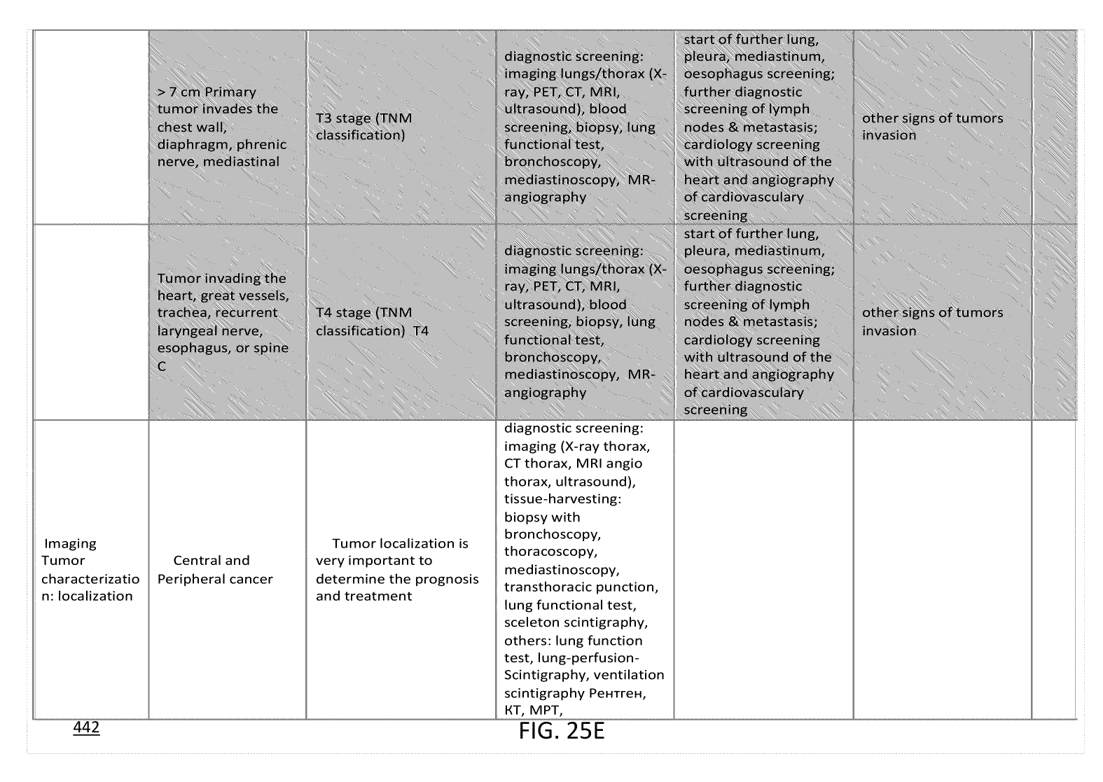

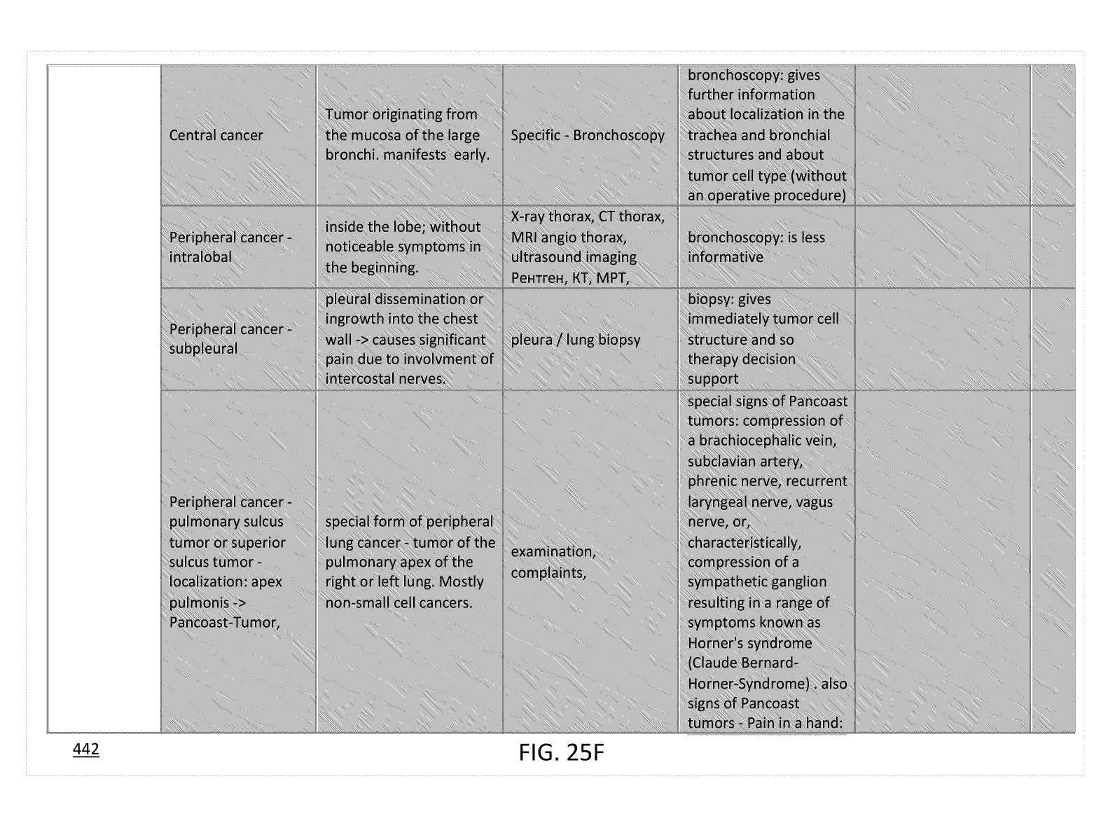

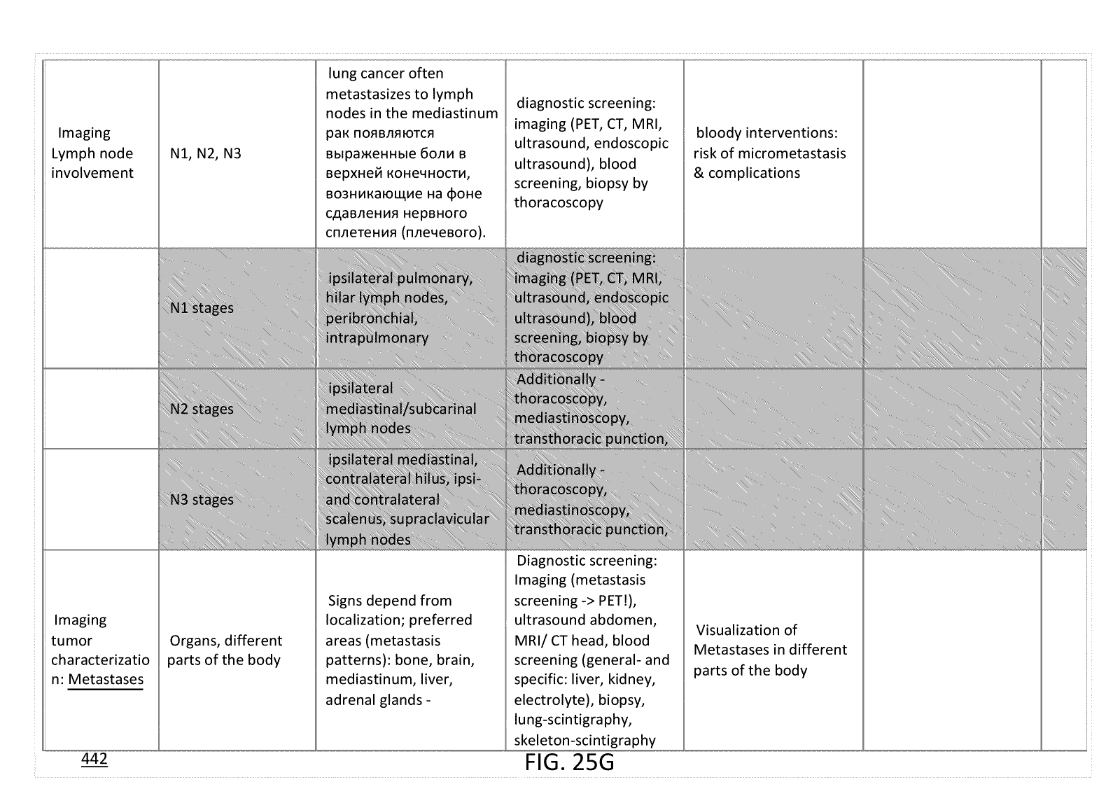

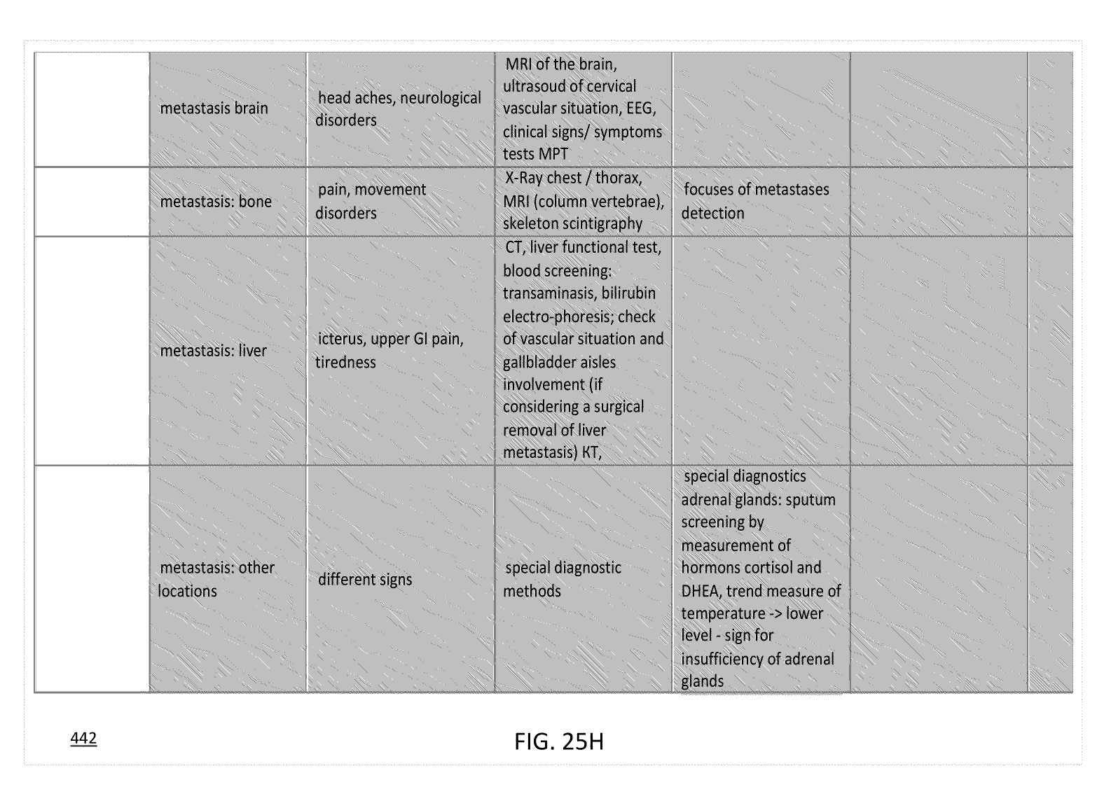

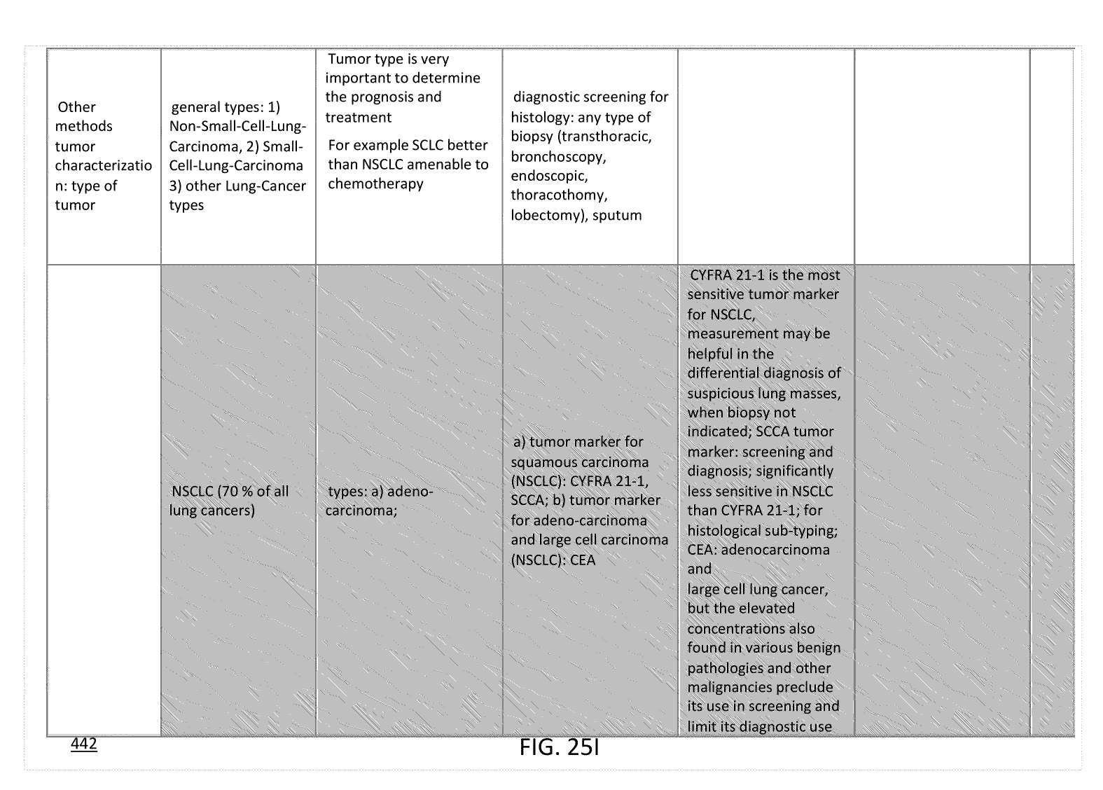

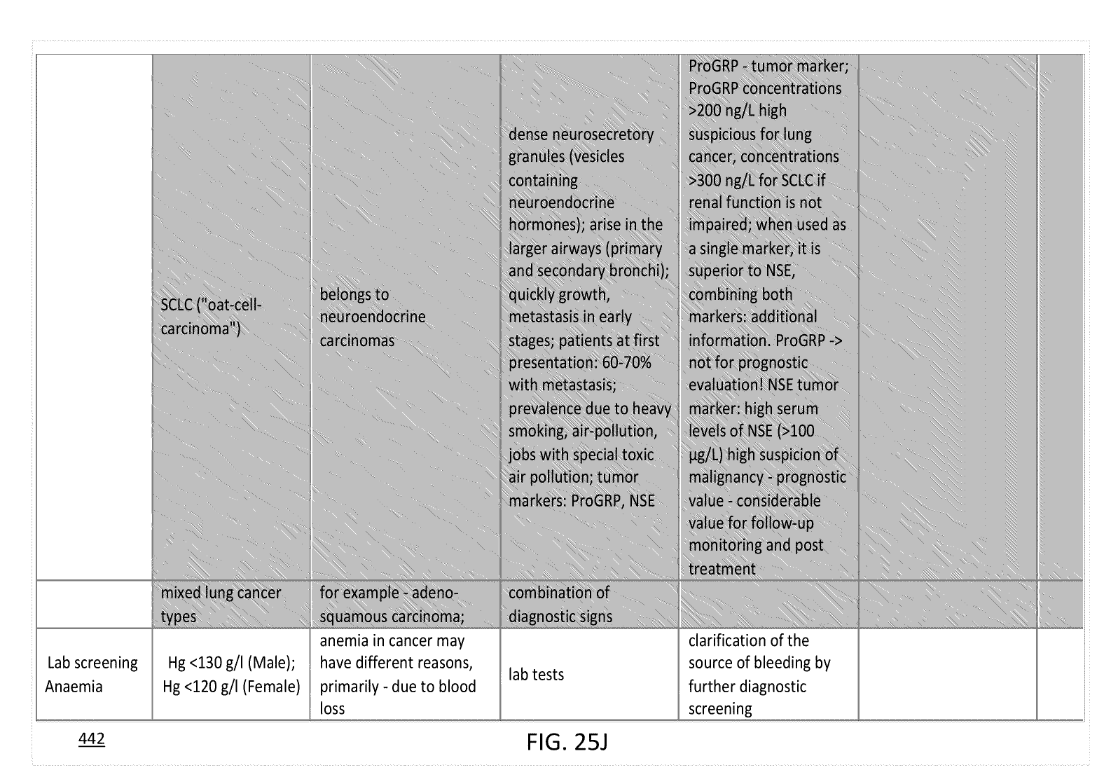

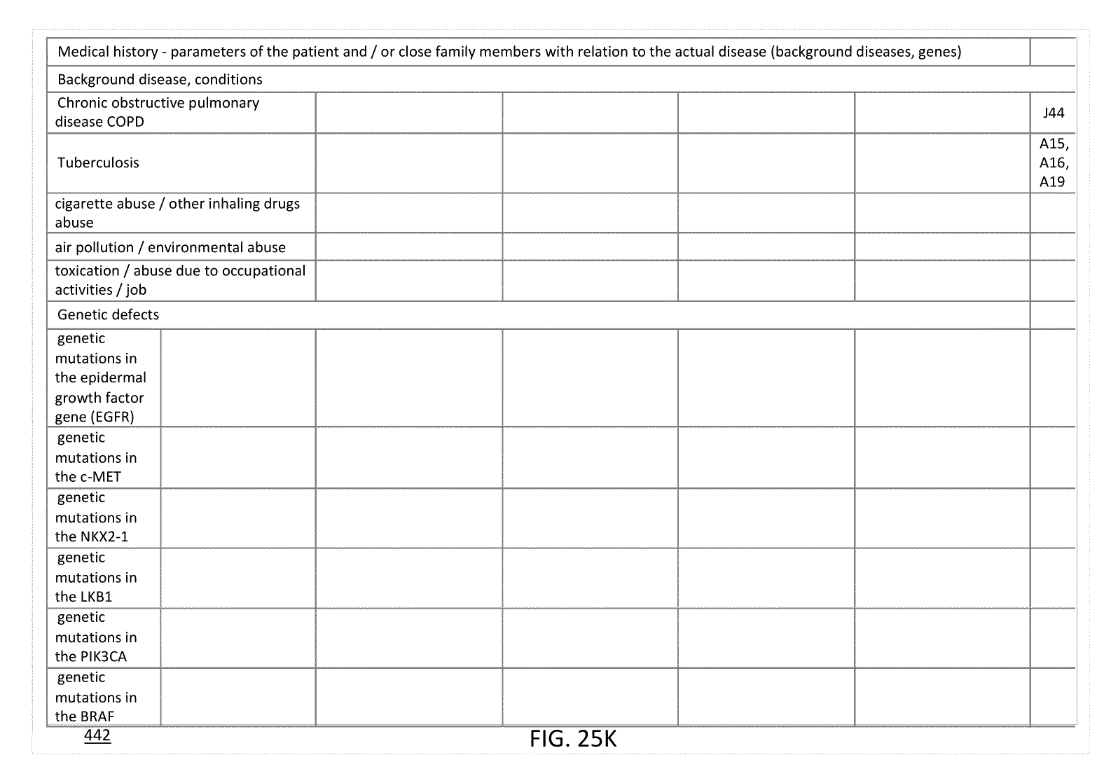

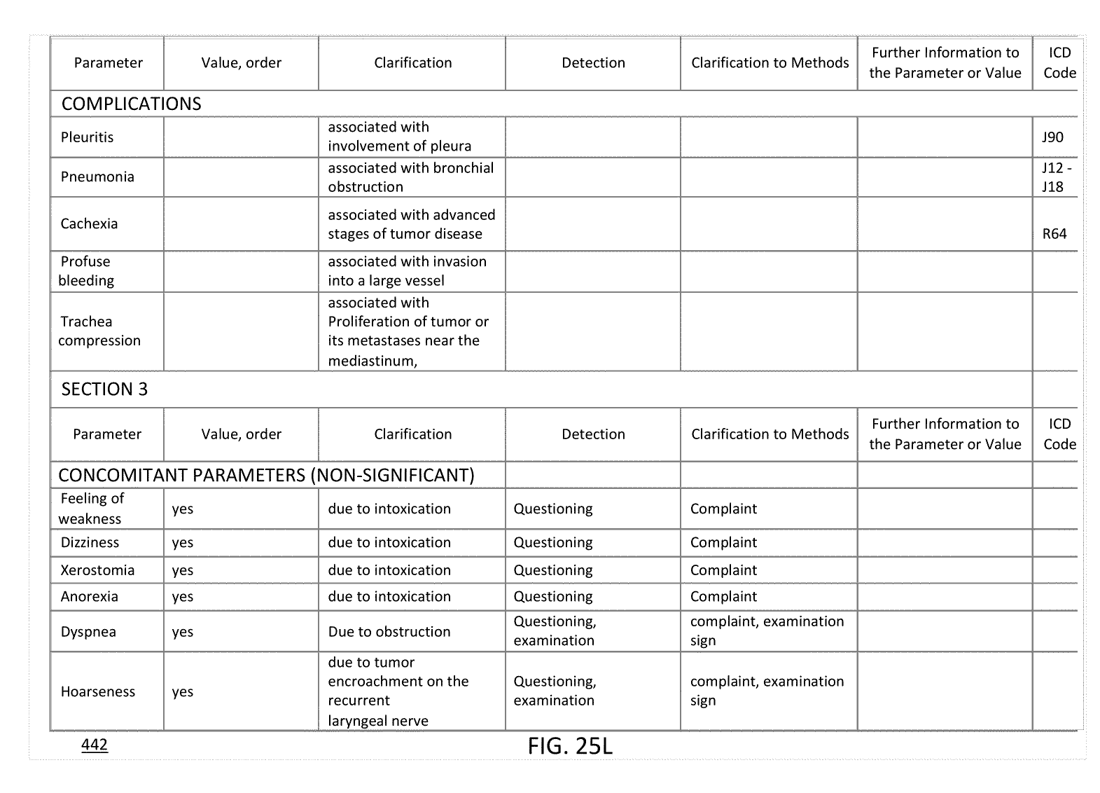

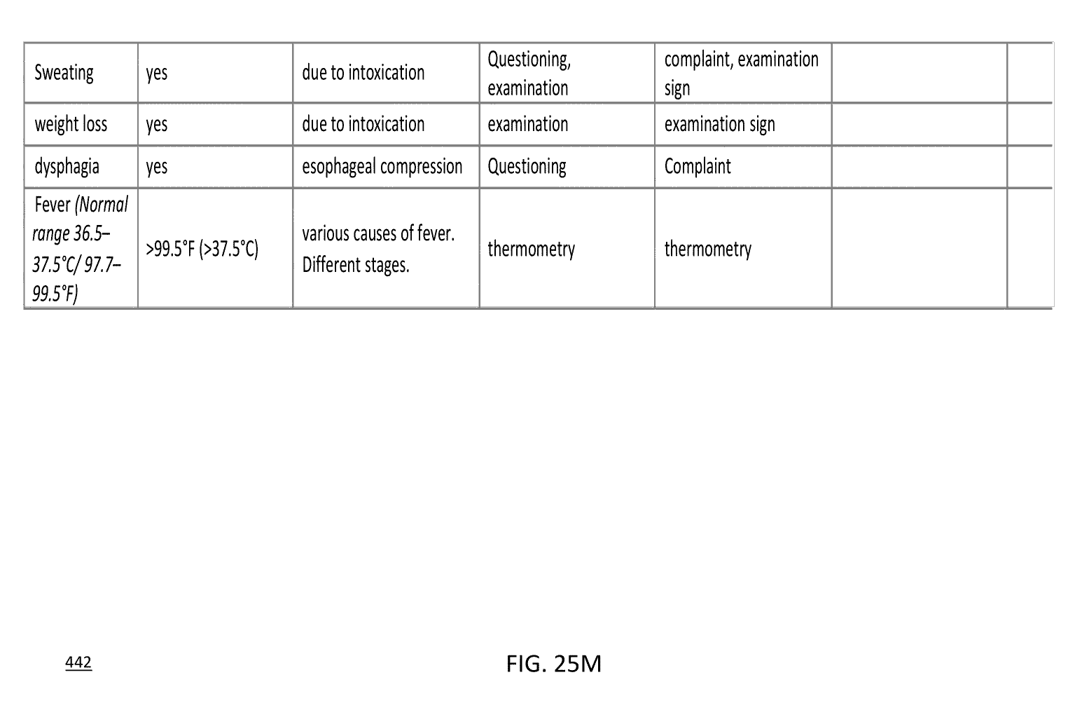

FIGS. 25A-M are block diagrams illustrating an exemplary clinical parameter form for lung cancer 442. The form is completed following the structure and instructions on the clinical parameter form.

As an example, for lung cancer, the first level parameters, the direct parameters, may include, but are not limited to: (1) type (small cell vs. non-small cell); (2) stage (size of the tumor and whether it has spread); and (3) grade (appearance and behavior).

The exemplary second level parameters for lung cancer may include presence of mutations of oncogenes: (1) epidermal growth factor receptor (EGFR); (2) Kirsten rat sarcoma onocogene homolog (KRAS); and (3) anaplastic lymphoma kinase (ALK). The presence of these mutations is used to determine whether a patient would benefit from non-small cell lung cancer (NSCLC) targeted therapies. The second level parameters may also include markers of neuroendocrine differentiation, such as (1) creatine kinase-BB, (2) chromogranin, and (3) neuron specific enolase; and of small peptide hormones, such as (1) gastrin-releasing peptide, (2) calcitonin, and (3) serotonin. These markers demonstrate the neuroendocrine differentiation of small cell lung cancer. The second level parameters may also include complications associated with lung cancer.

The exemplary third level parameters for lung cancer may include the patient's general conditions such as age, personal history of lung cancer, family history of lung cancer, race and ethnicity.

The exemplary fourth level parameters may include the lifestyle and habits of the patient such as weight, level of physical activity, alcohol consumption, smoking habits, exposure to second-hand smoke, and food consumption (fruits and vegetables vs. animal fats).

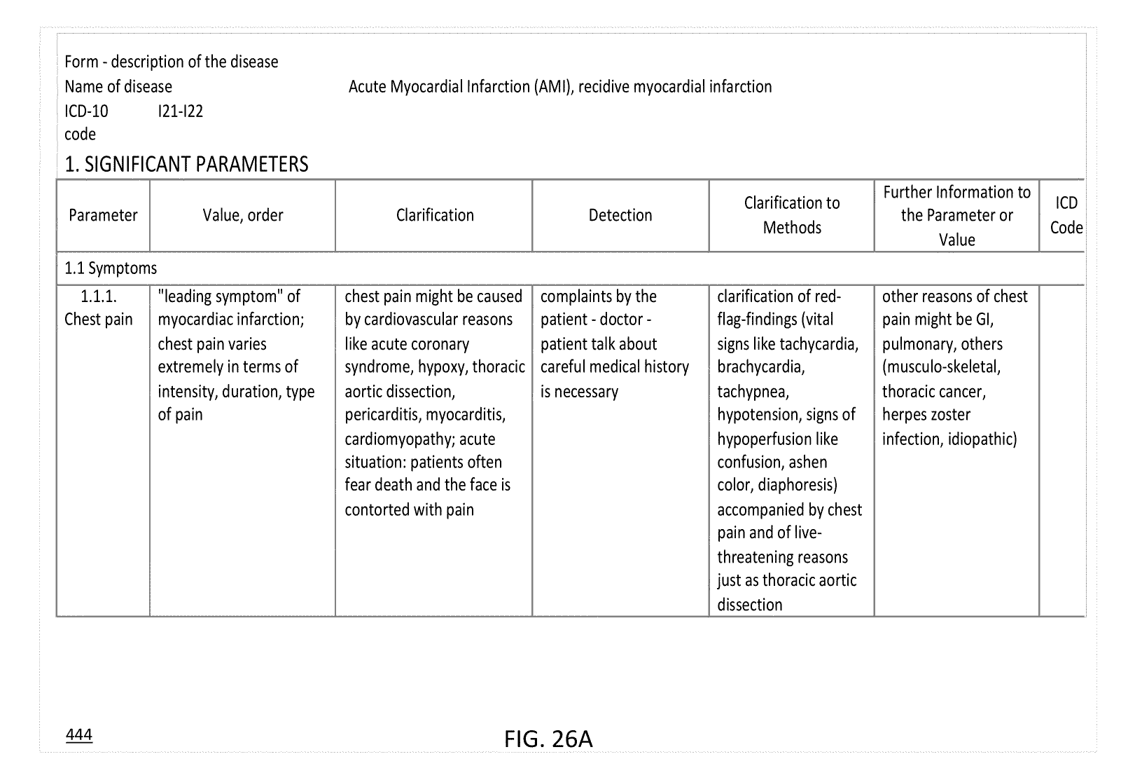

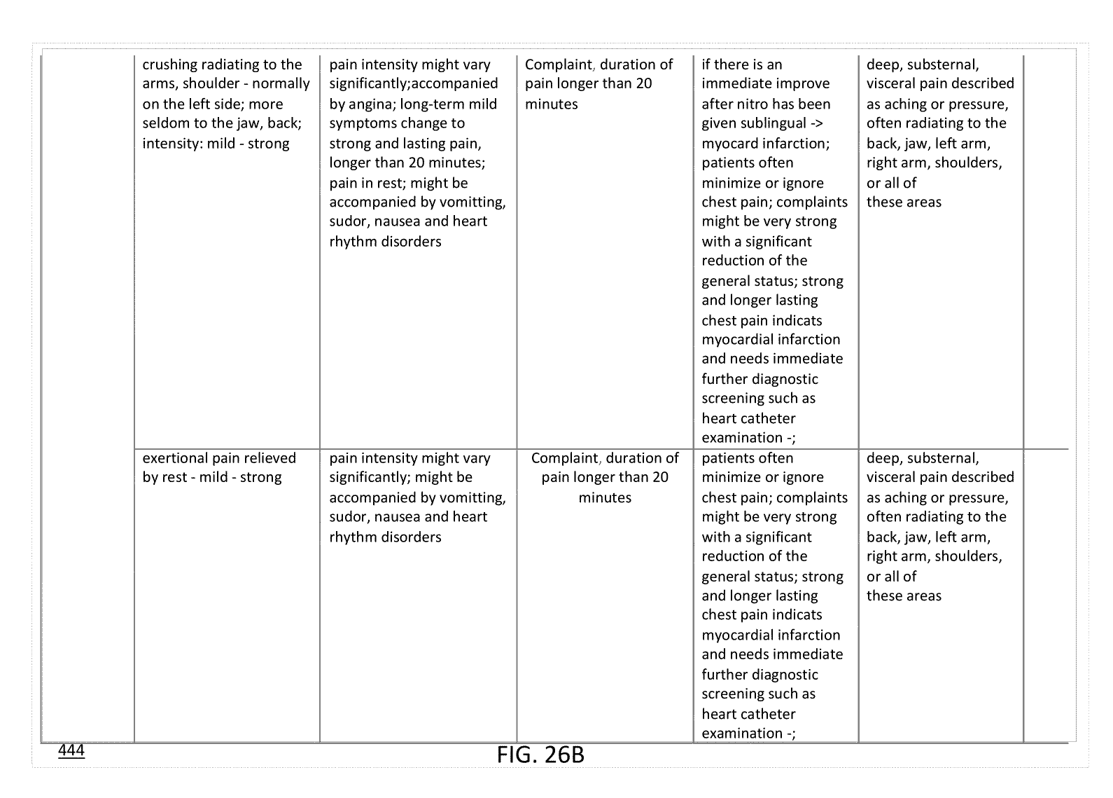

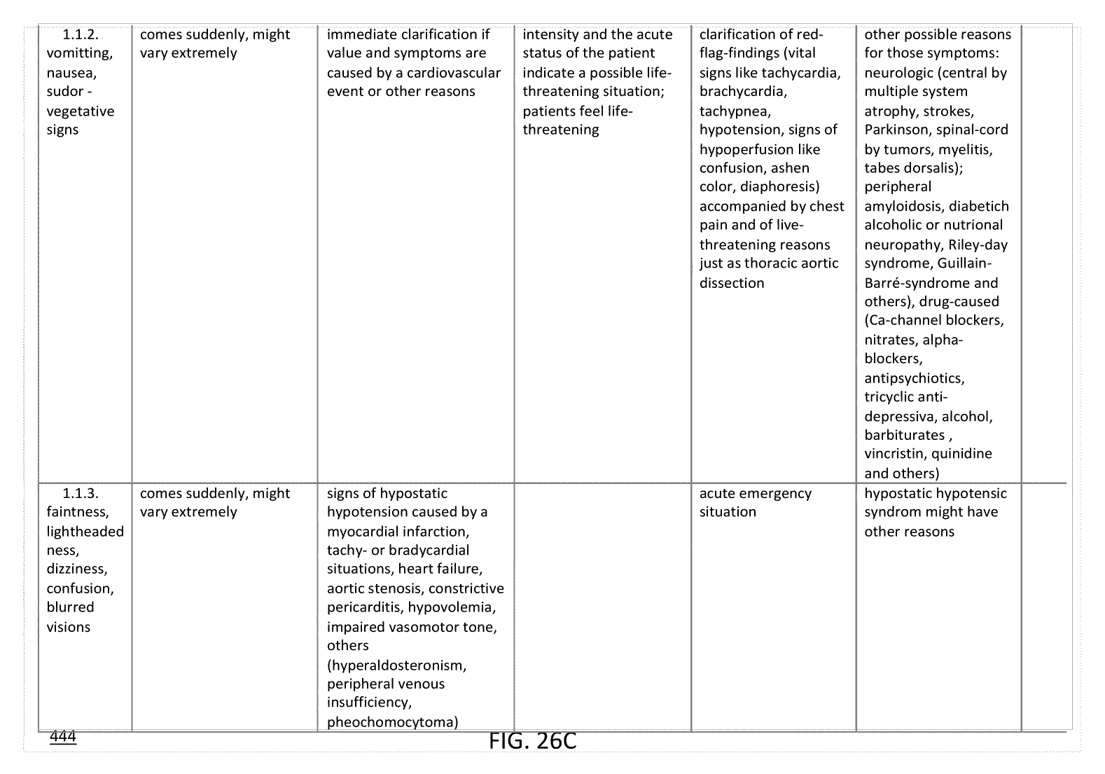

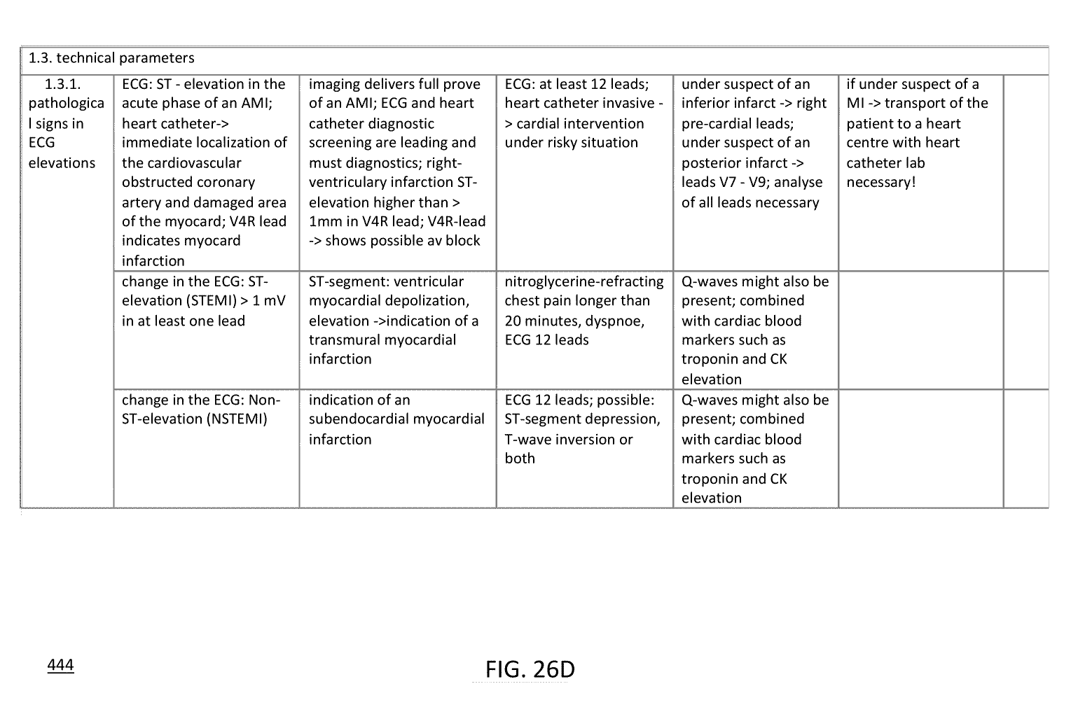

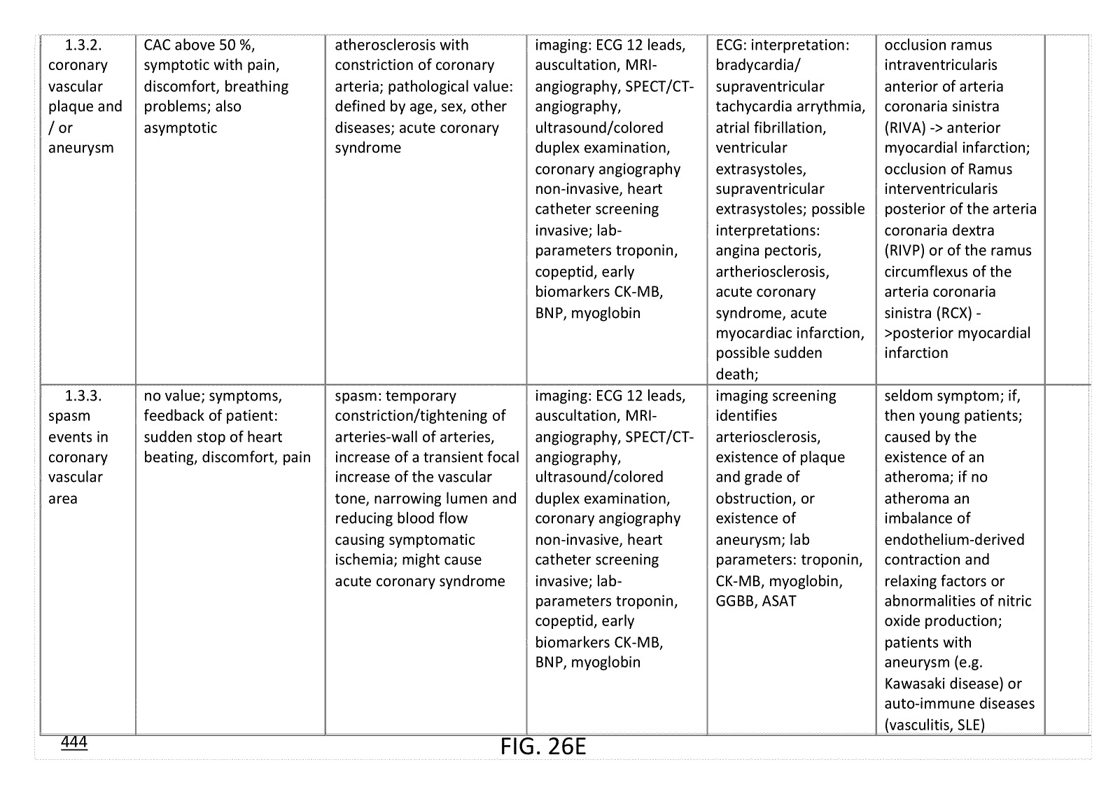

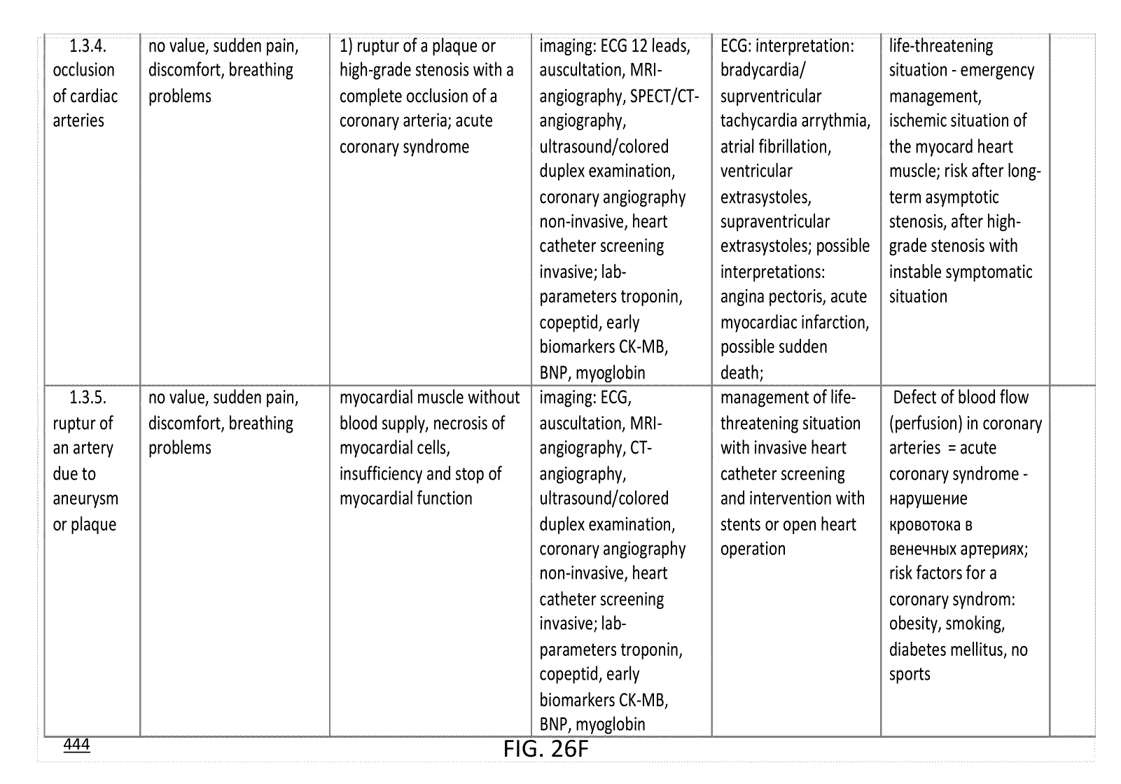

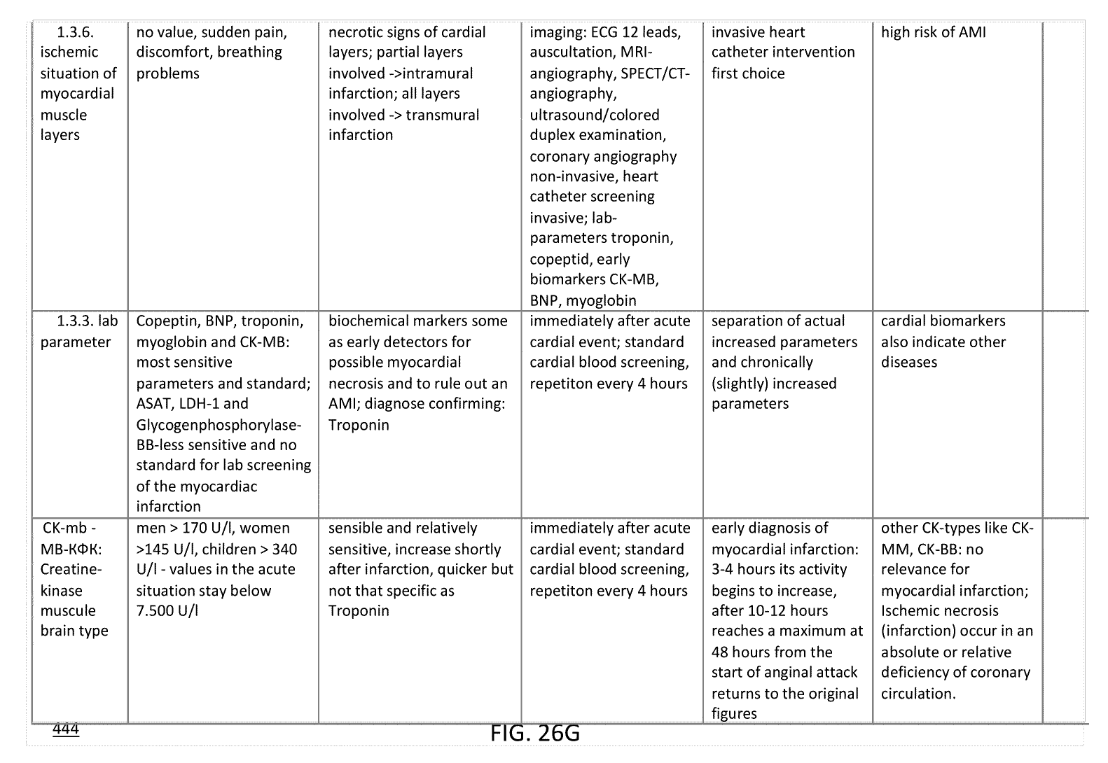

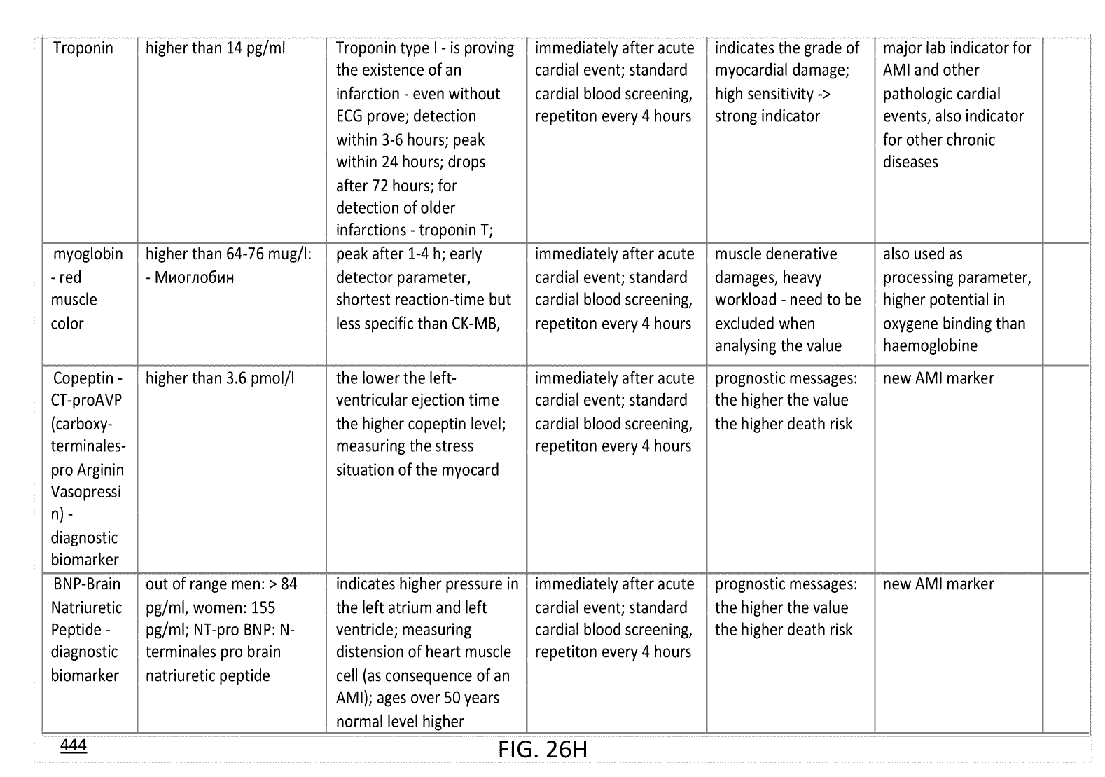

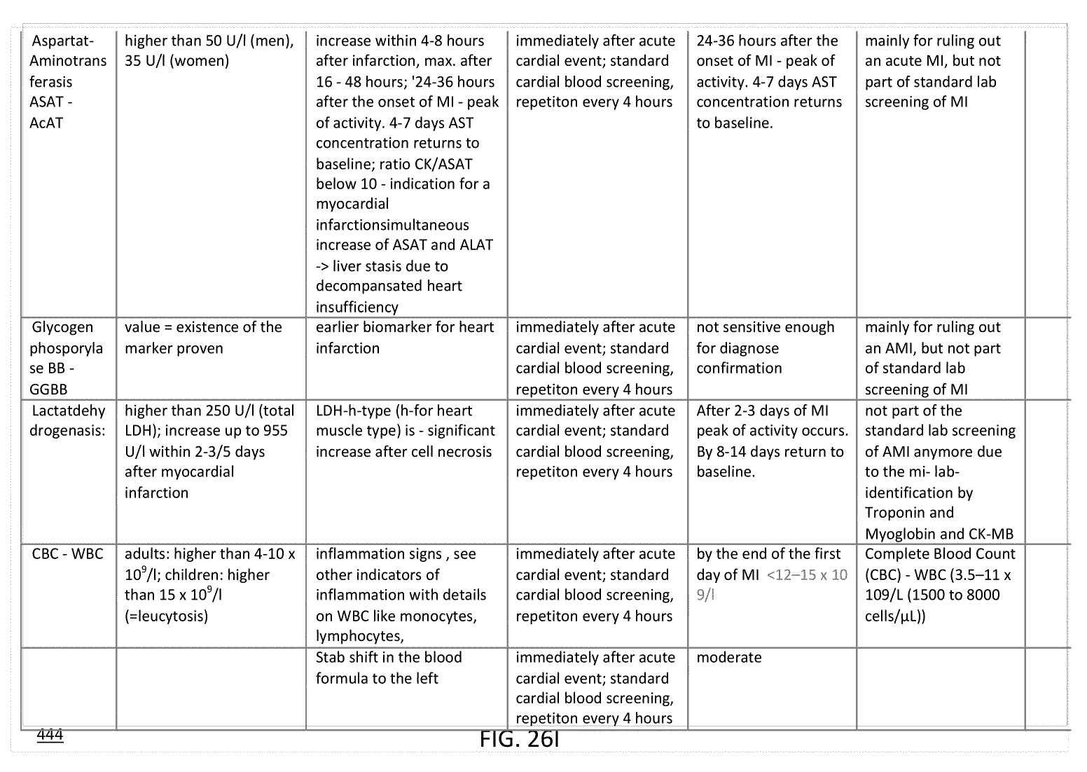

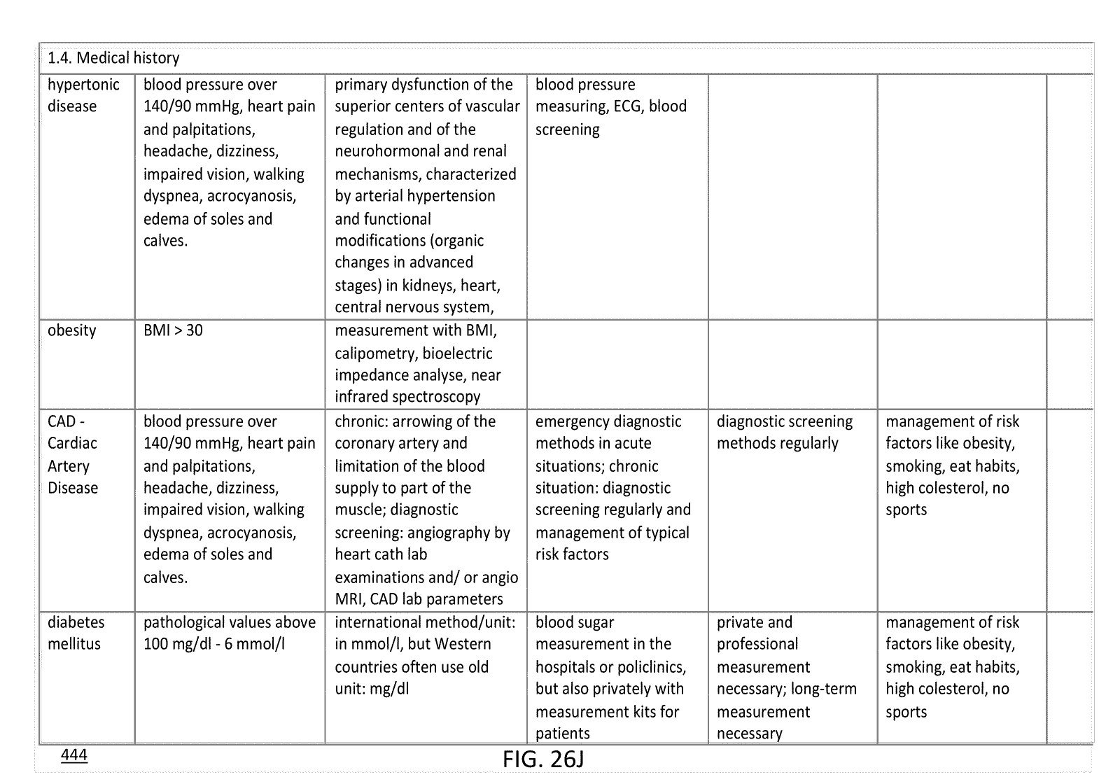

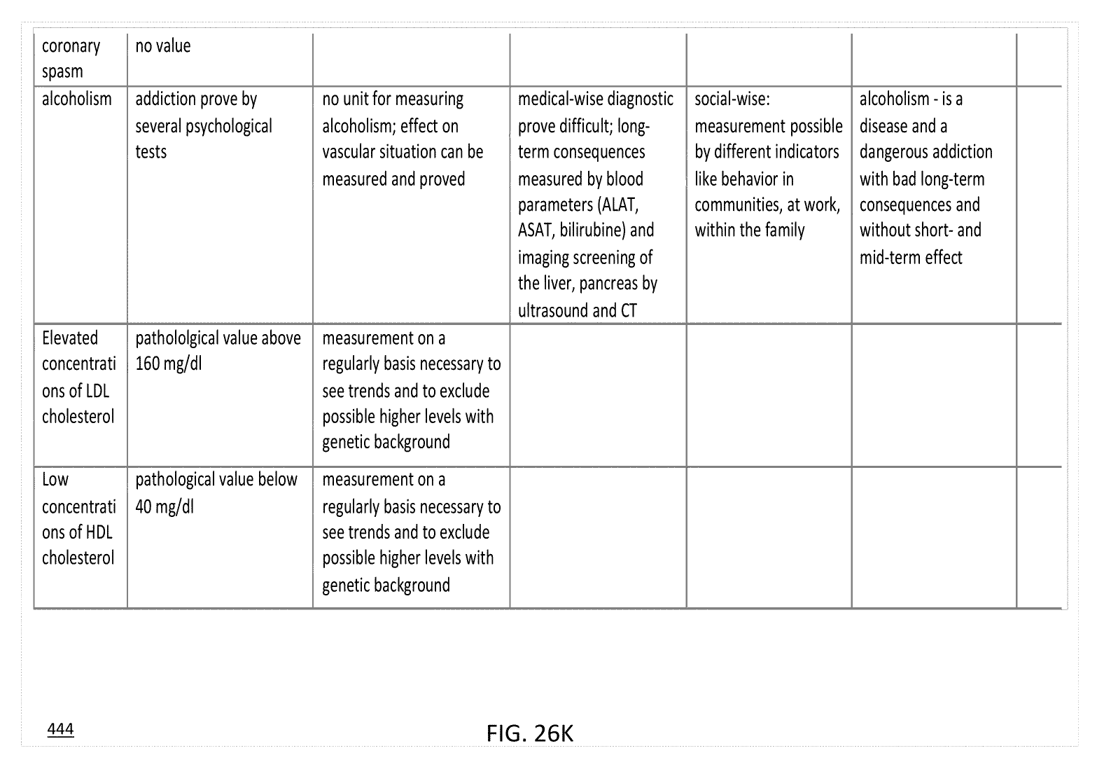

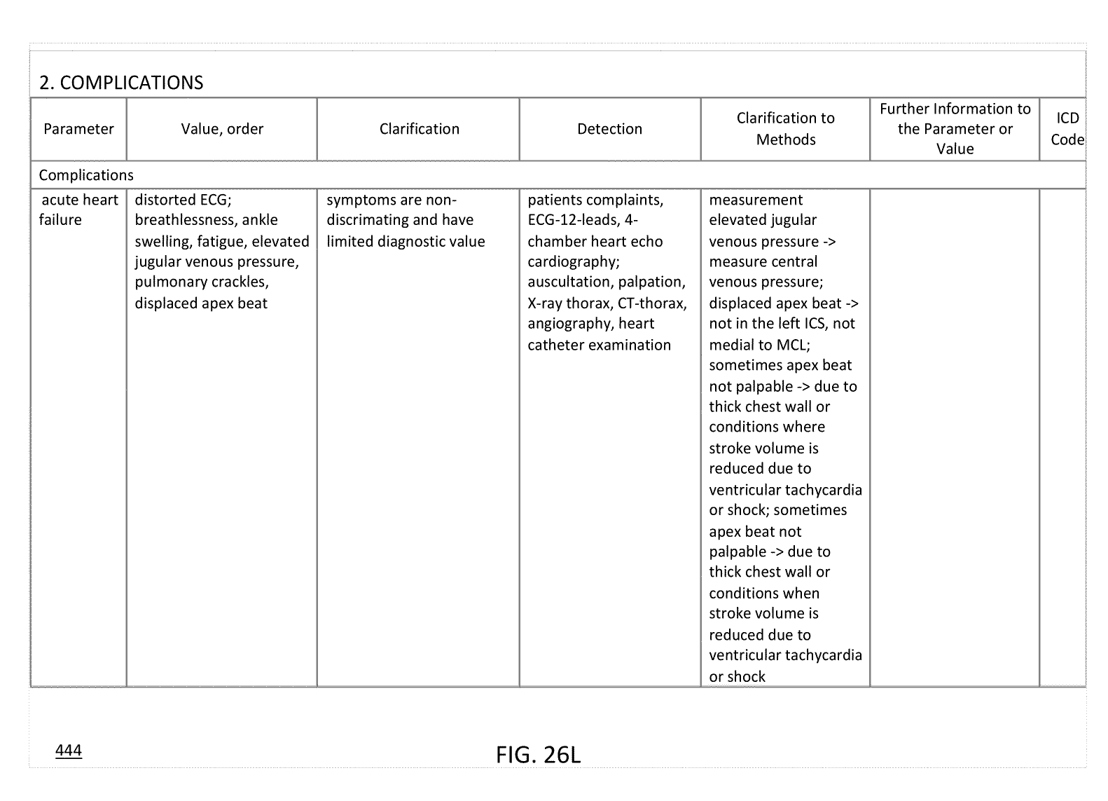

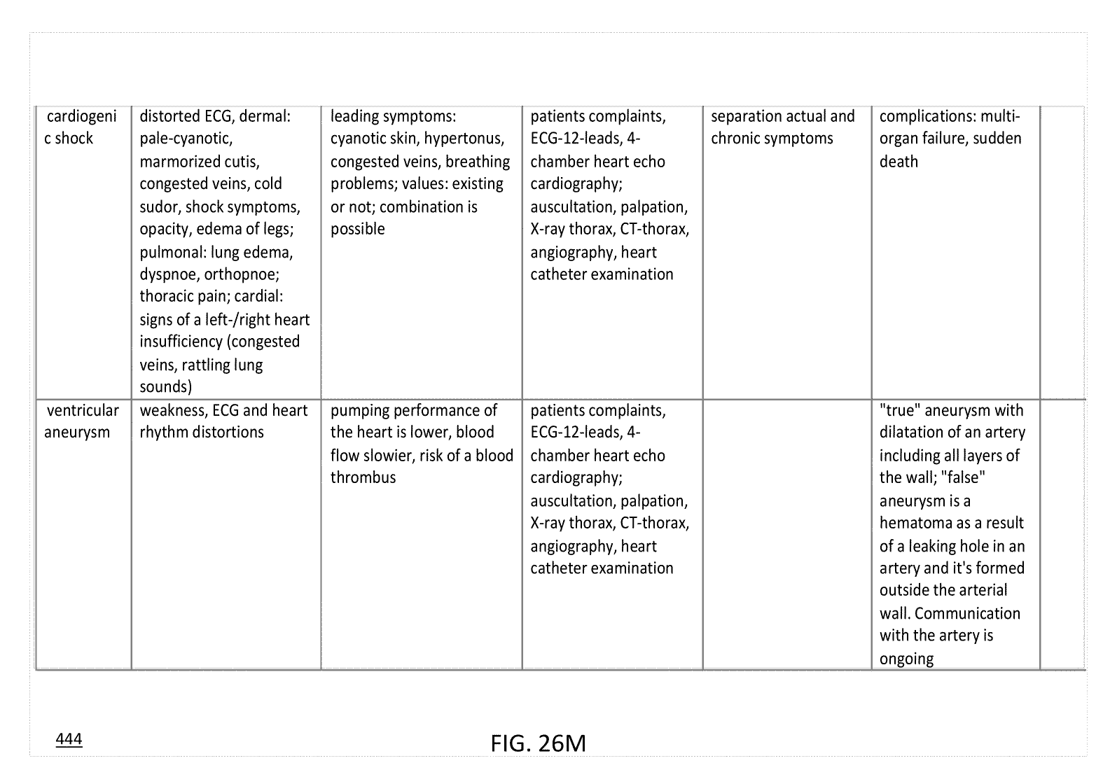

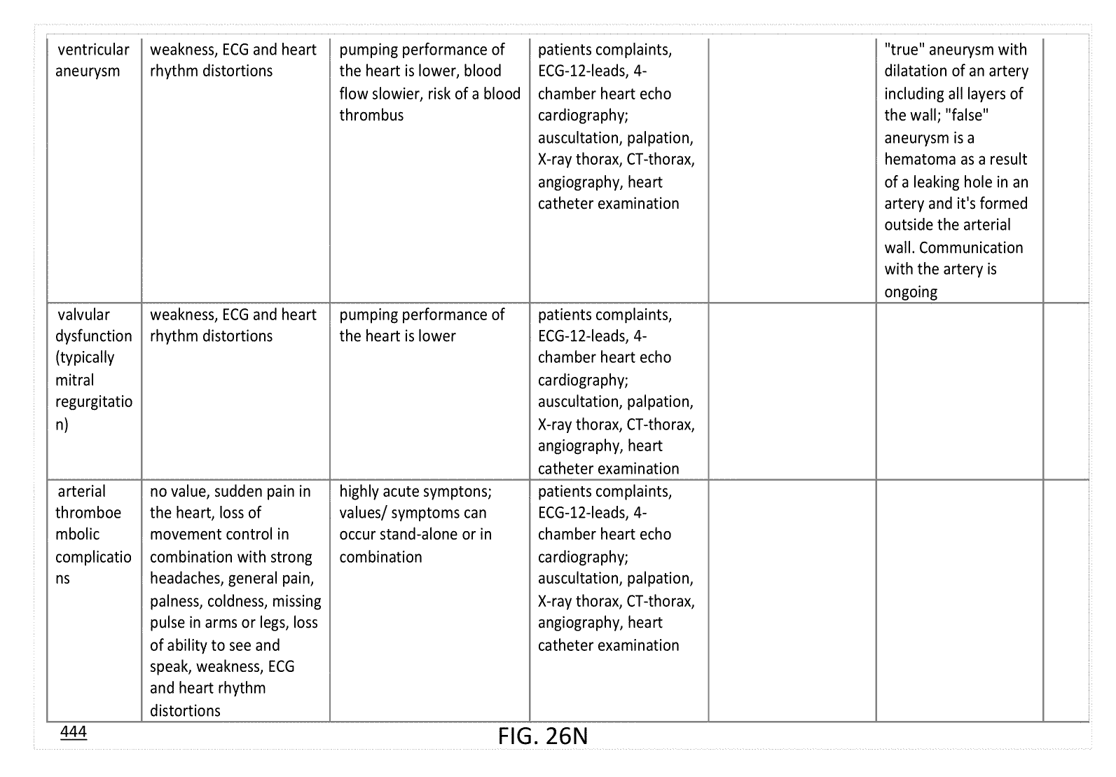

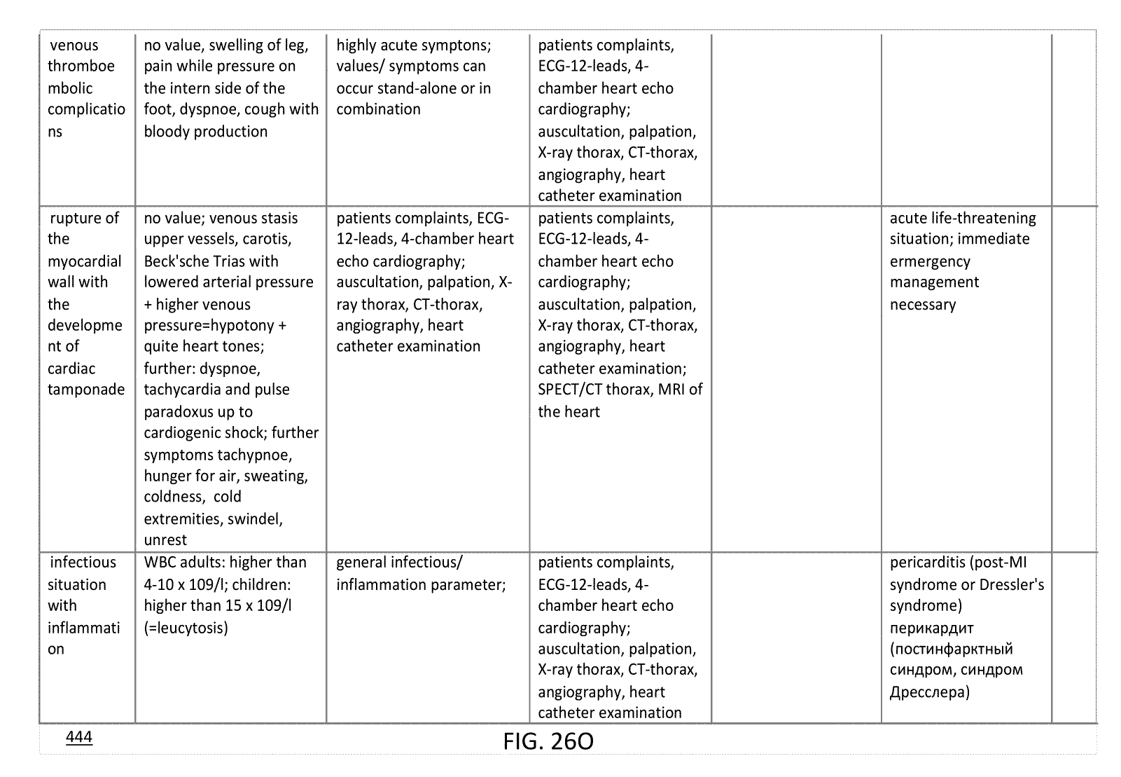

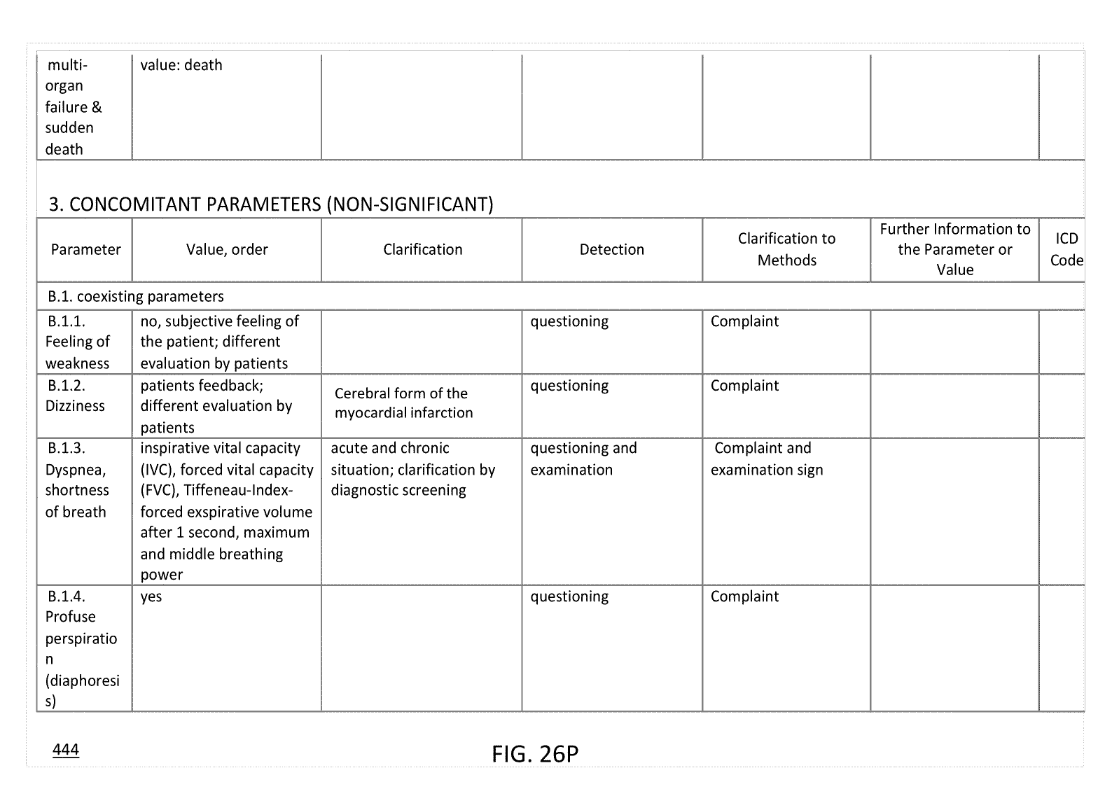

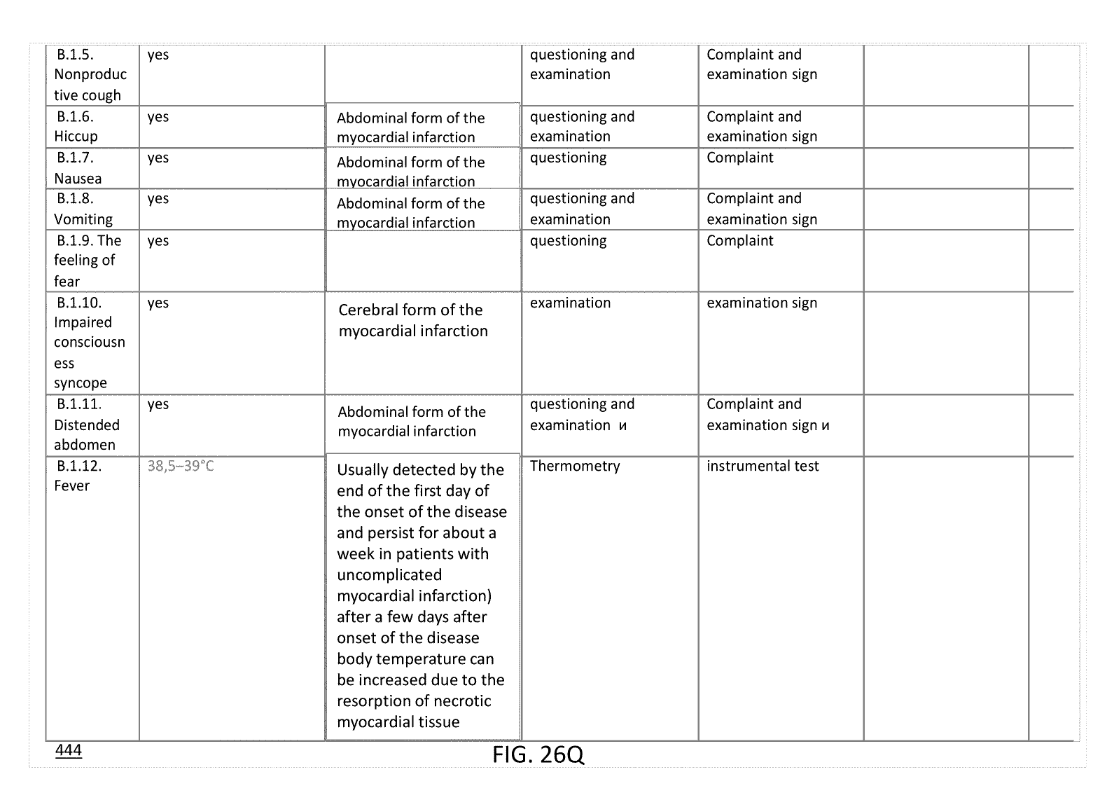

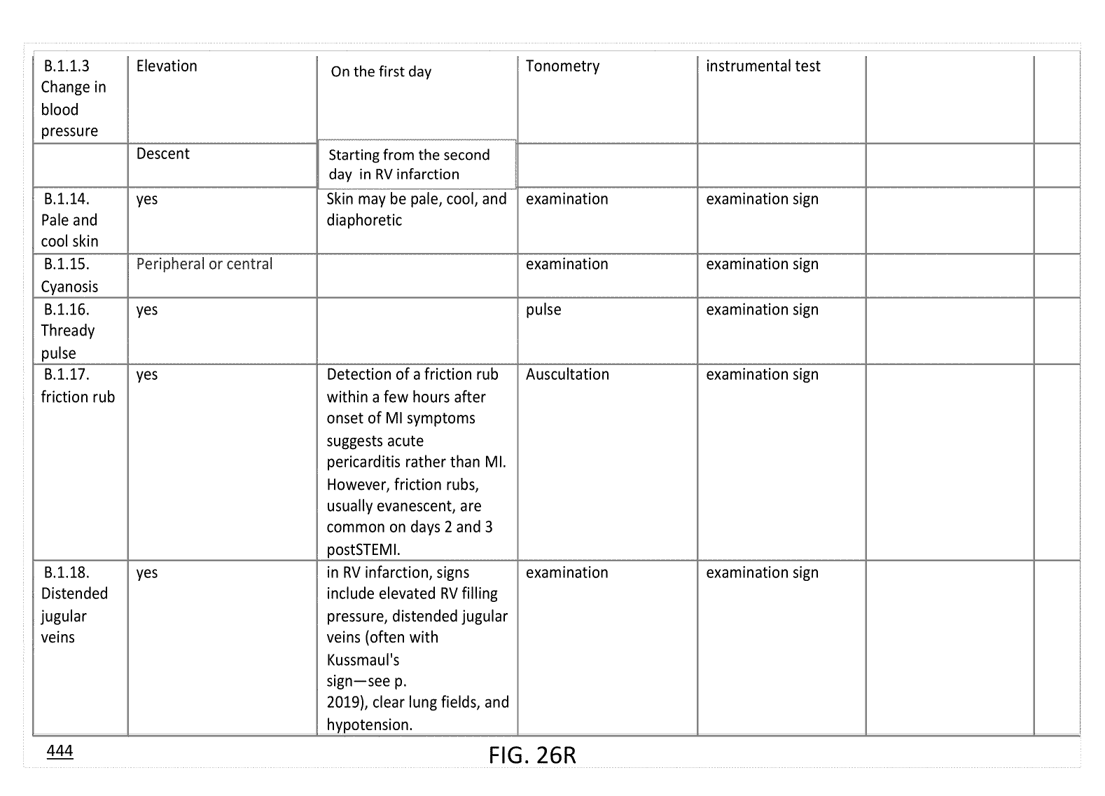

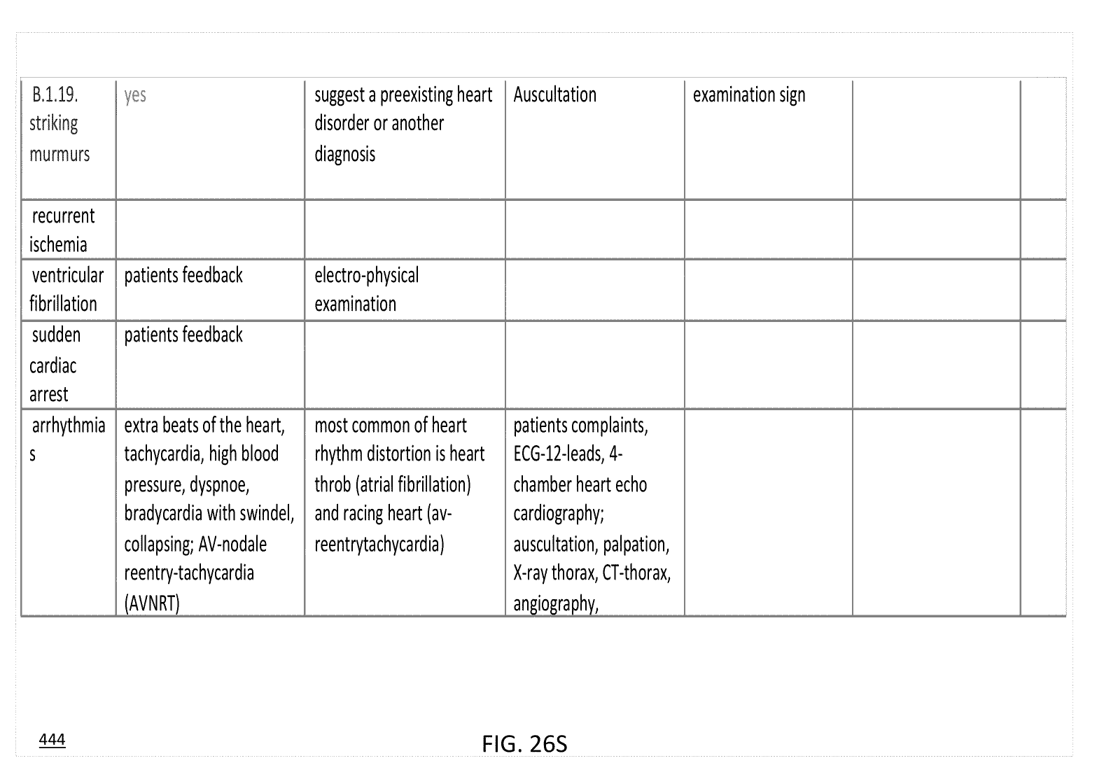

FIGS. 26A-S are block diagrams illustrating an exemplary clinical parameter form with myocardial infarction (MI) 444.

As an example, the first level parameters, the direct parameters, for a heart disease may include, but are not limited to, (1) type of heart failure (systolic dysfunction or diastolic dysfunction); (2) stage of the heart disease based on classification of the symptoms; and (3) grade of the heart disease based on severity of the heart symptoms.

The exemplary second level parameters for a heart disease may include, but are not limited to, markers associated with heart diseases. Example of genes found to be associated with myocardial infarction, include PCSK9, SORT1, MIA3, WDR12, MRAS, PHACTR1, LPA, TCF21, MTHFDSL, ZC3HC1, CDKN2A, 2B, ABO, PDGF0, APOA5, MNF1ASM283, COL4A1, HHIPC1, SMAD3, ADAMTS7, RAS1, SMG6, SNF8, LDLR, SLC5A3, MRPS6, and KCNE2. These markers can be used for disease, prognosis, and treatment of heart disease, such as myocardial infarction. The second level parameters may also include complications associated with heart disease.

The exemplary third parameters for heart disease may include the patient's general conditions such as age, personal history of heart disease, family history of heart disease, diabetes, high blood pressure, dyslipidemia/hypercholesterolemia (abnormal levels of lipoproteins in the blood), and race and ethnicity.

The exemplary fourth level parameters may include the lifestyle and habits of the patient such as obesity, level of physical activity, smoking habits, alcohol consumption, food intake (trans fat), and stress level of job.

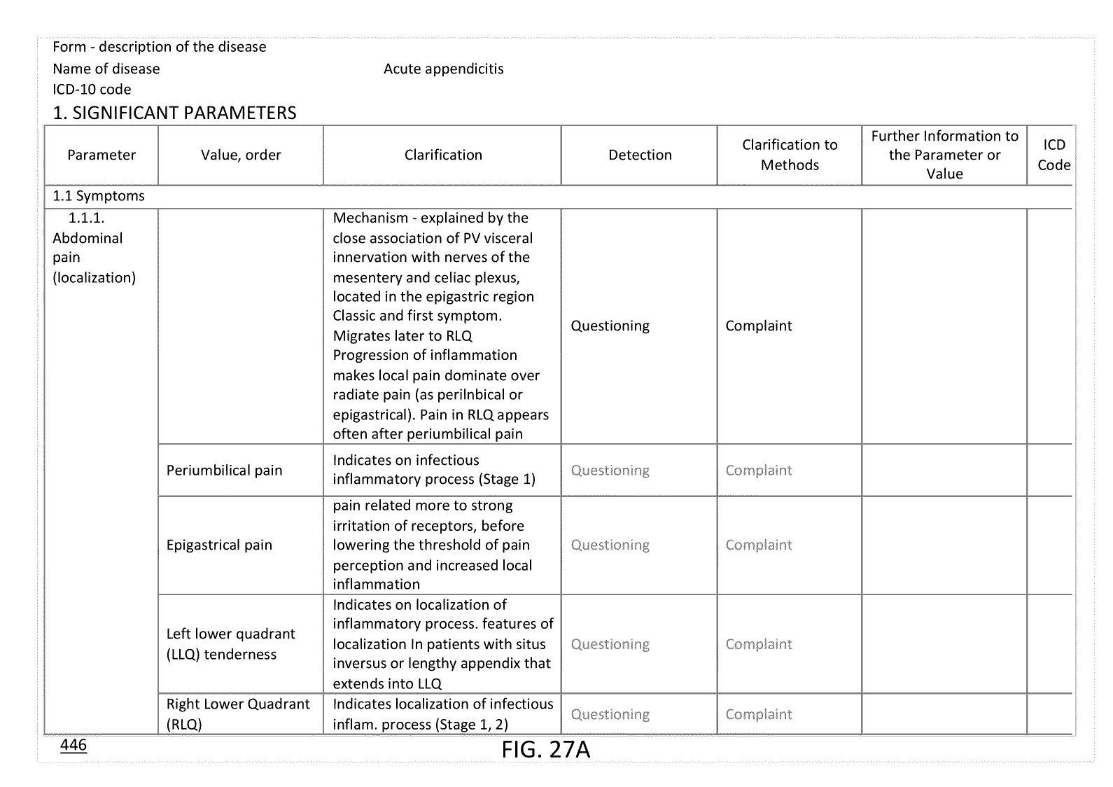

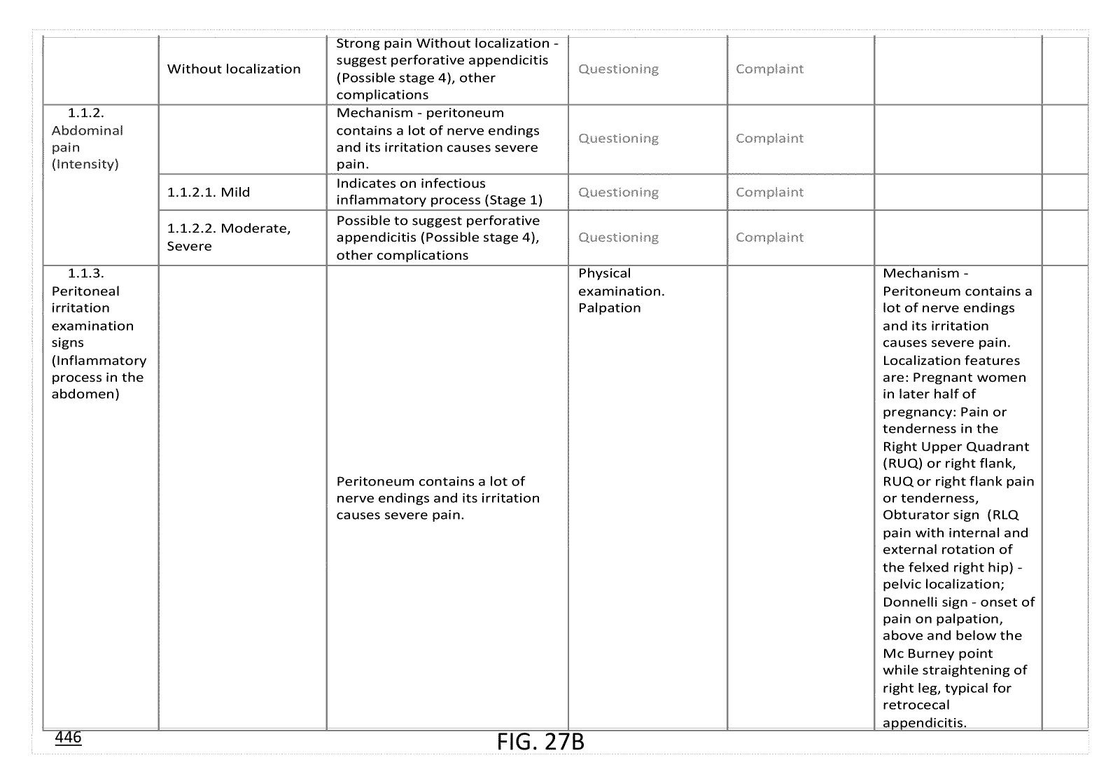

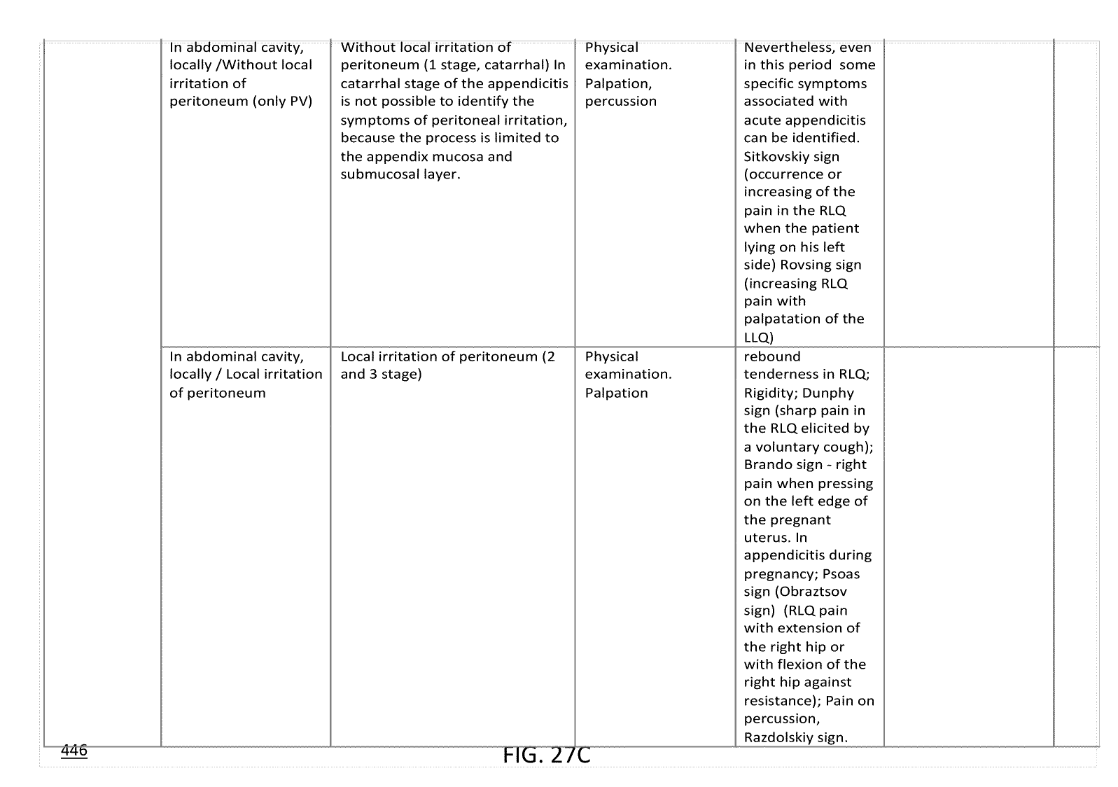

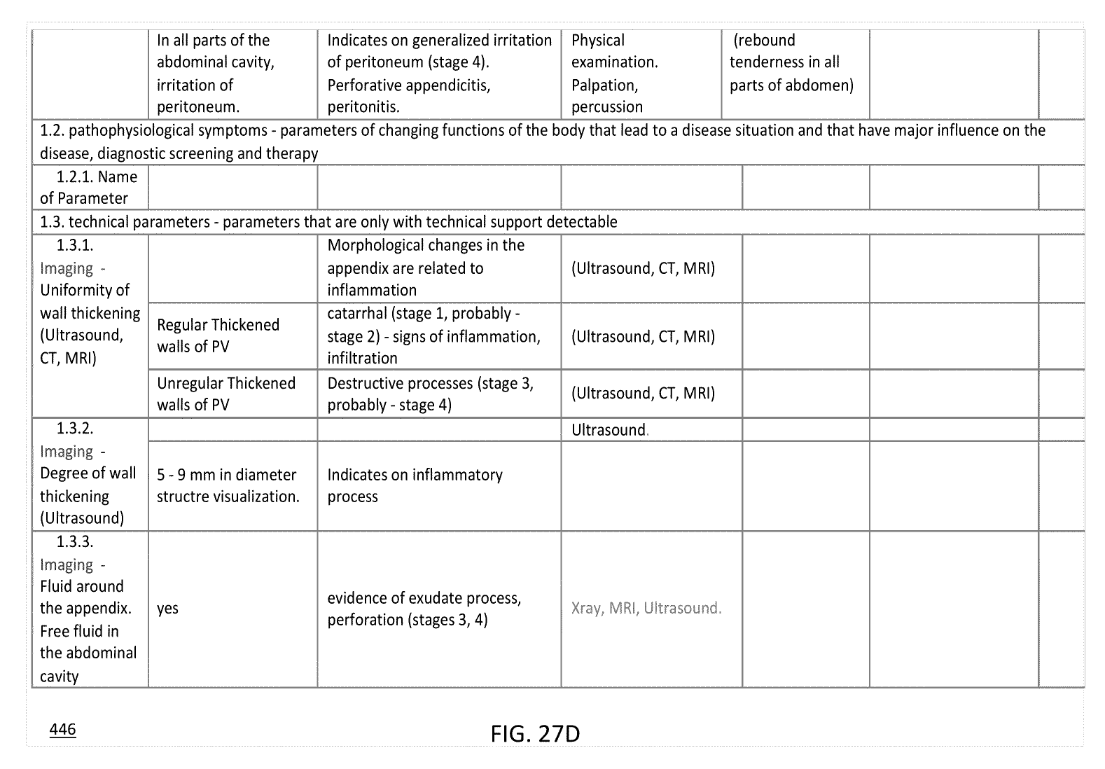

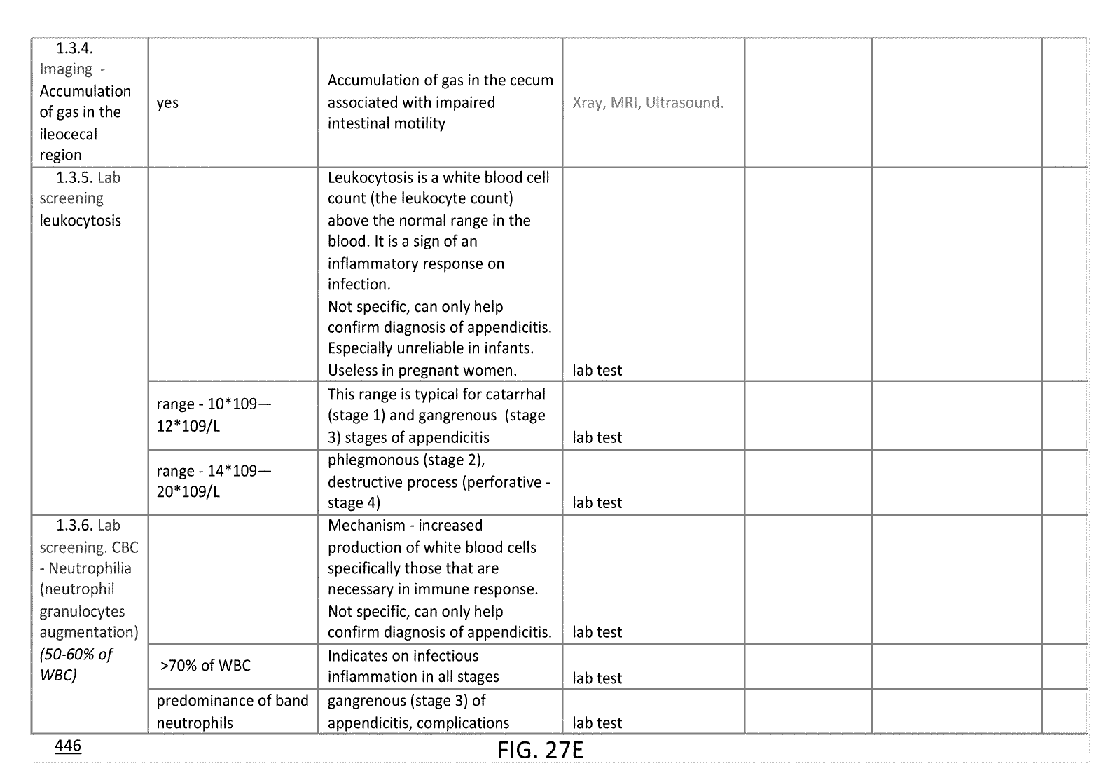

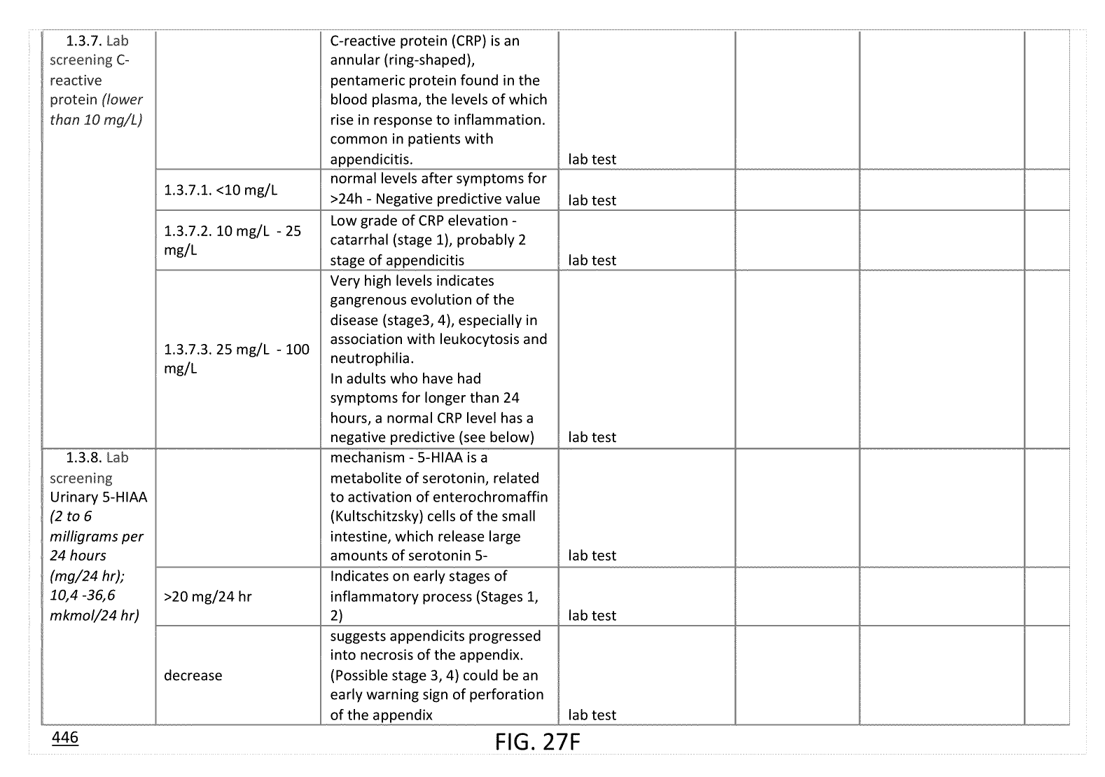

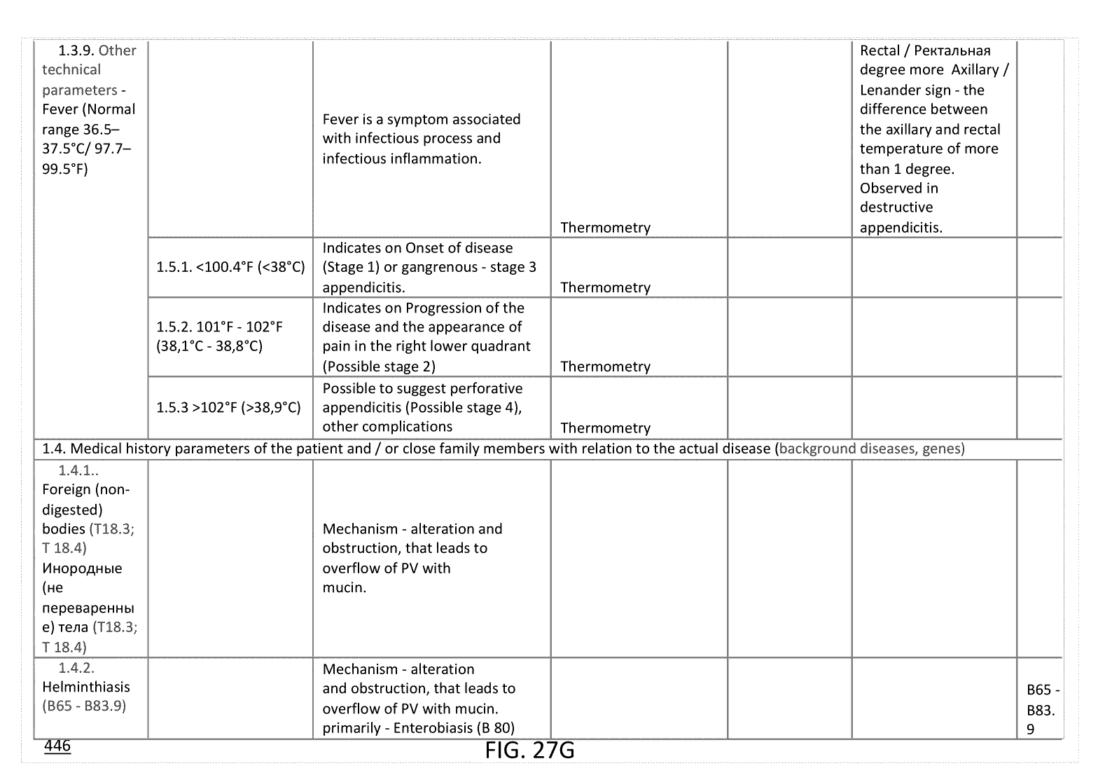

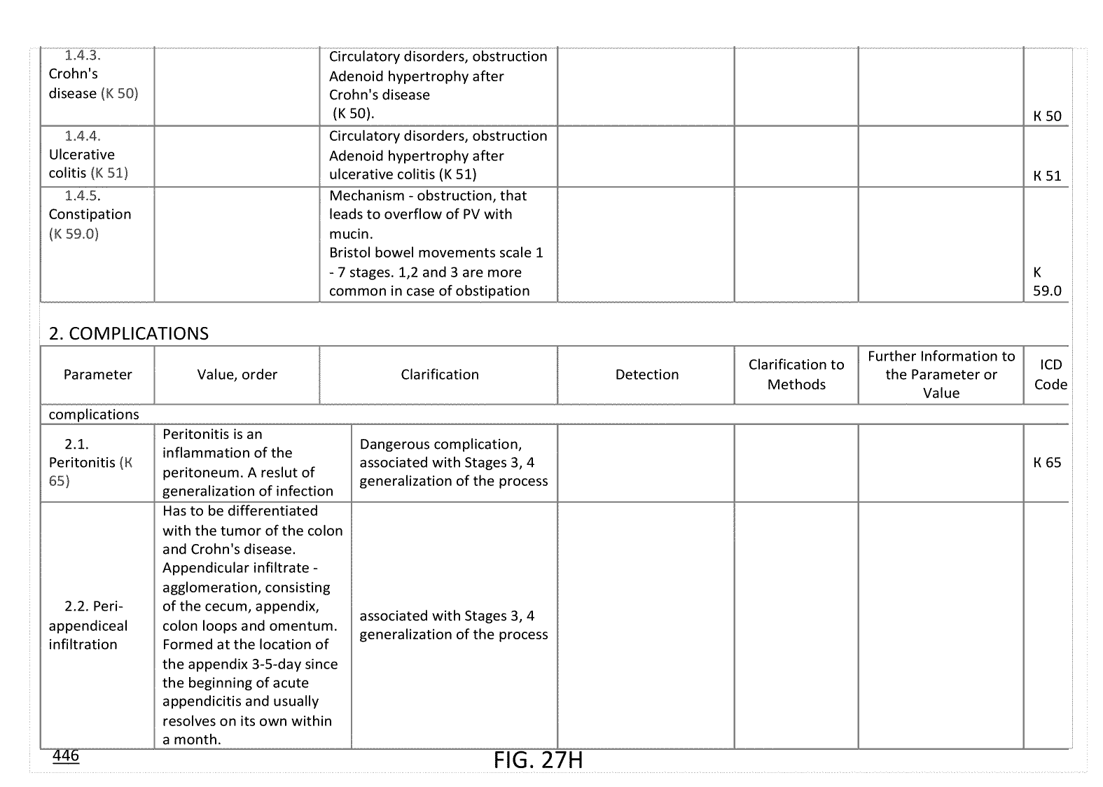

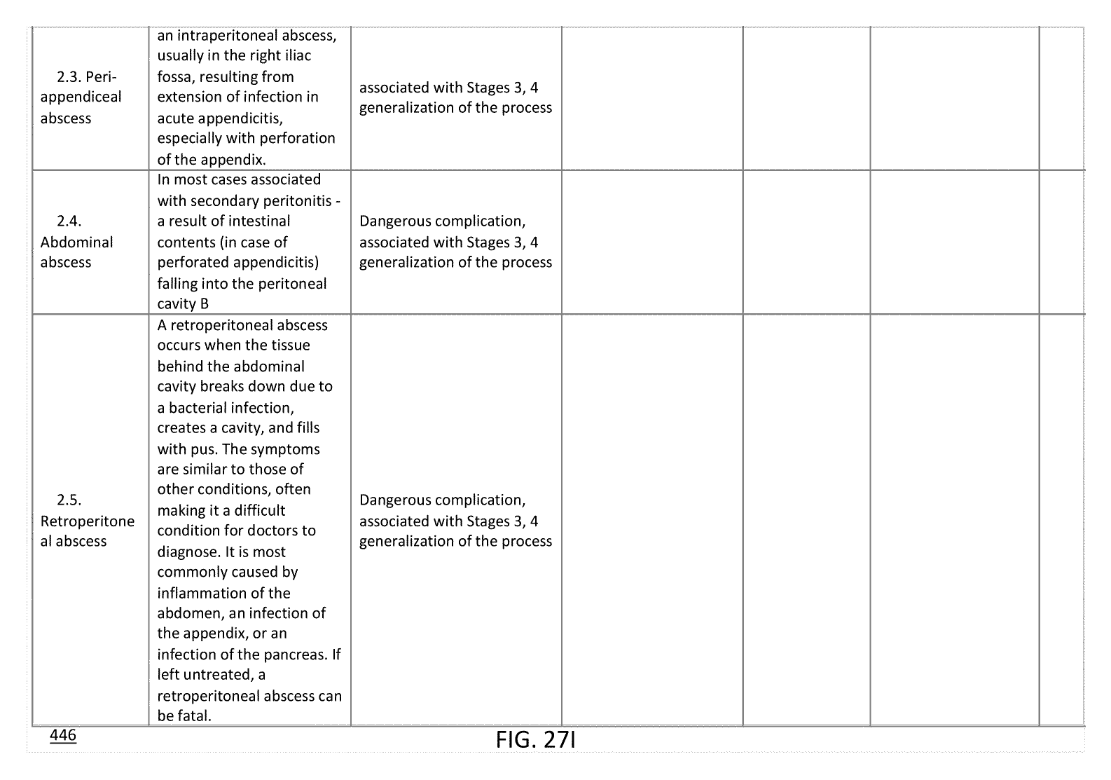

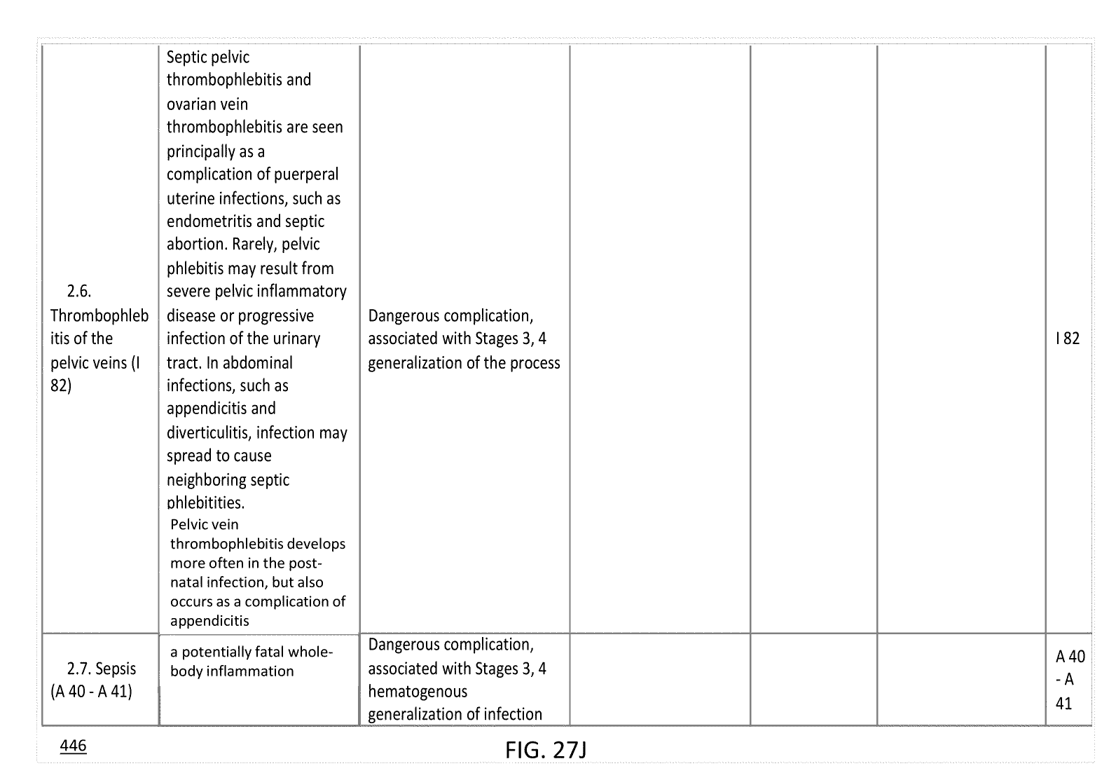

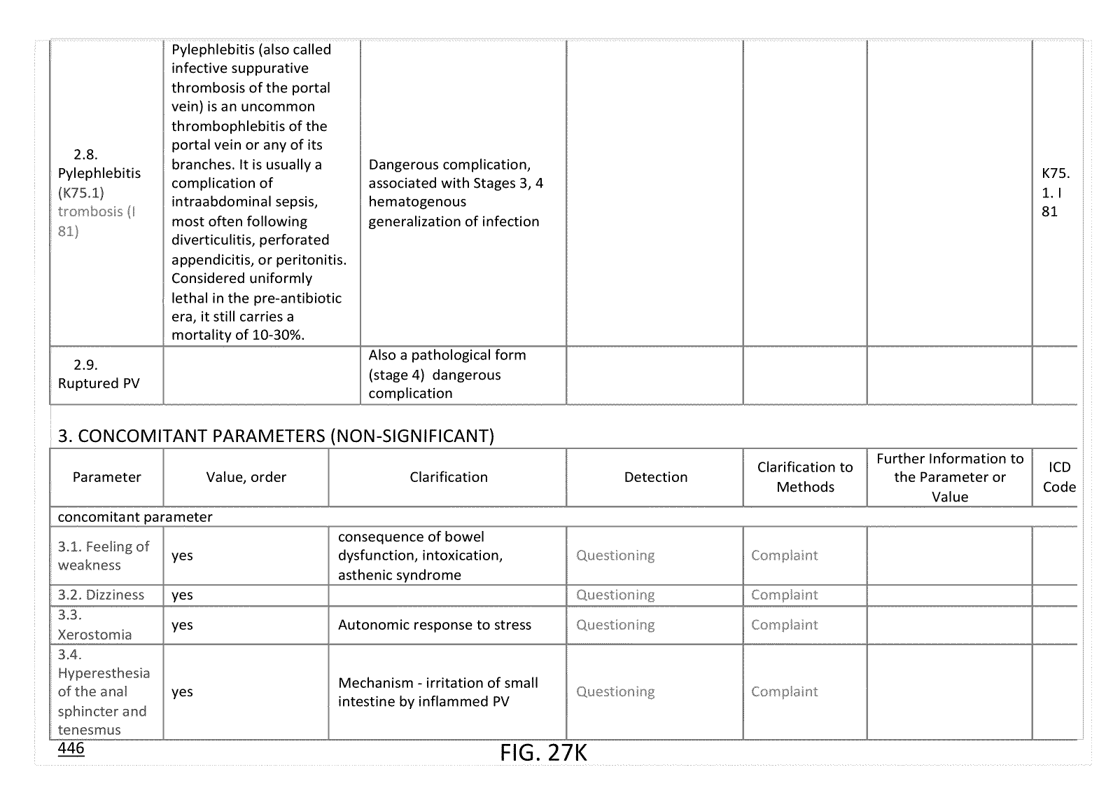

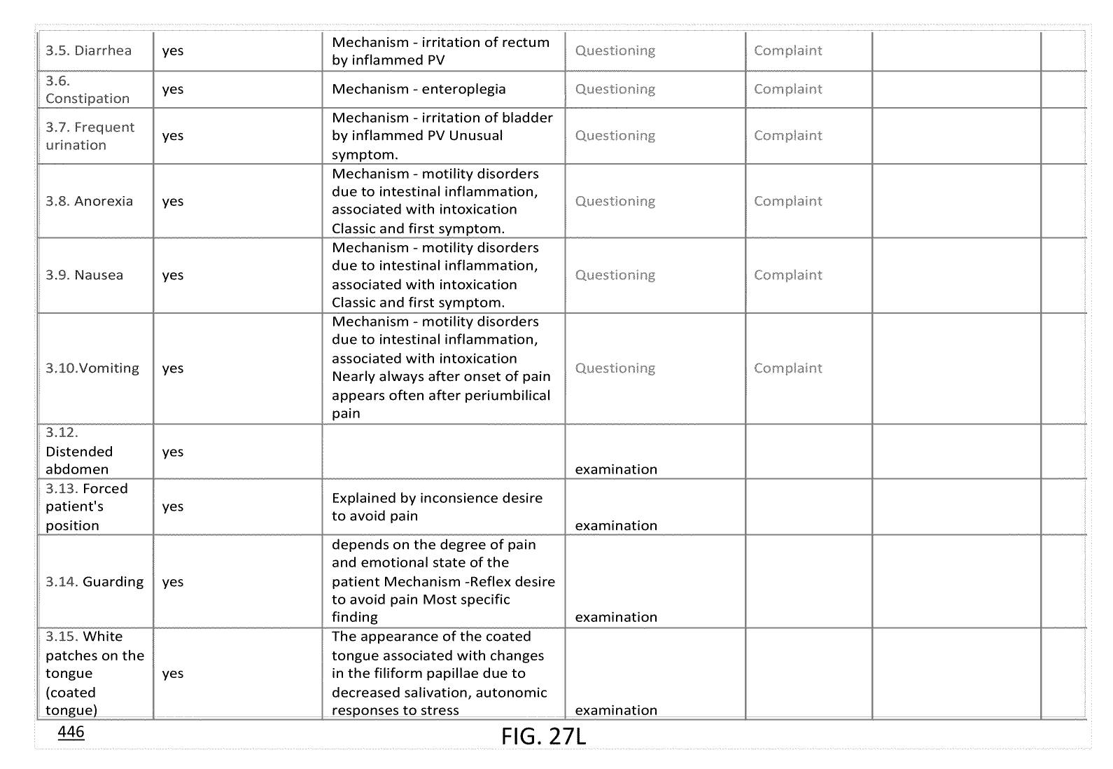

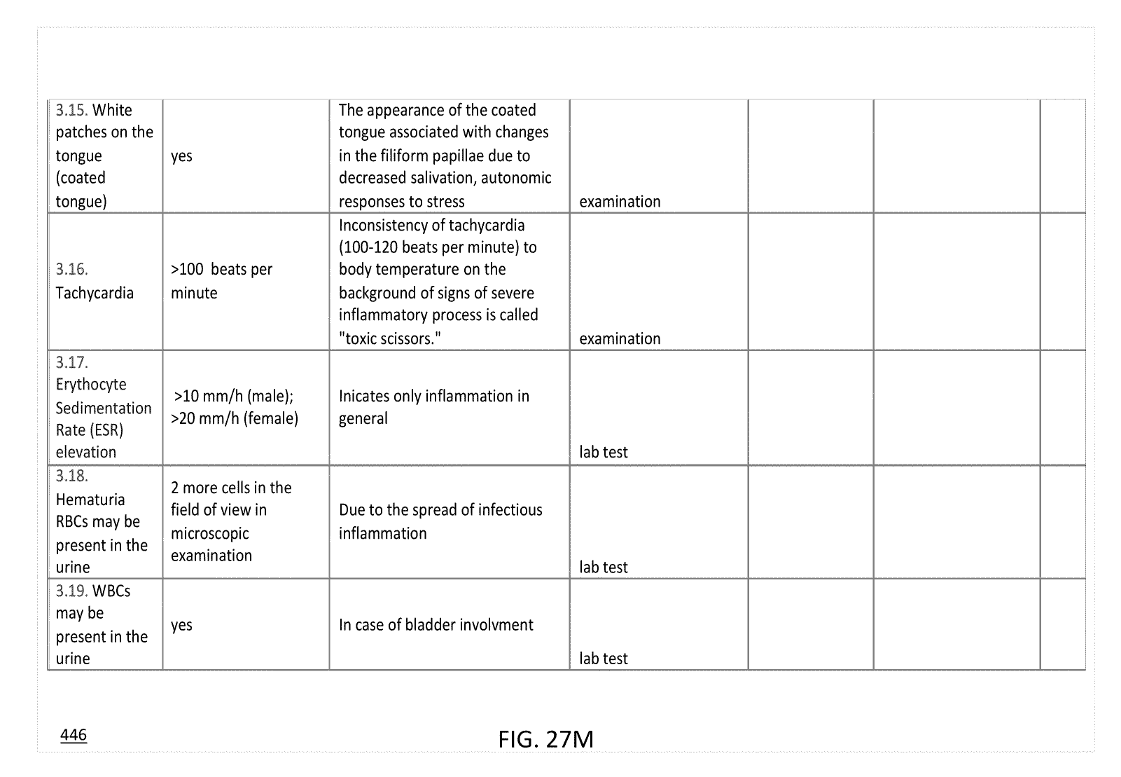

FIGS. 27A-M are block diagrams illustrating an exemplary clinical parameter form with Appendicitis 446.

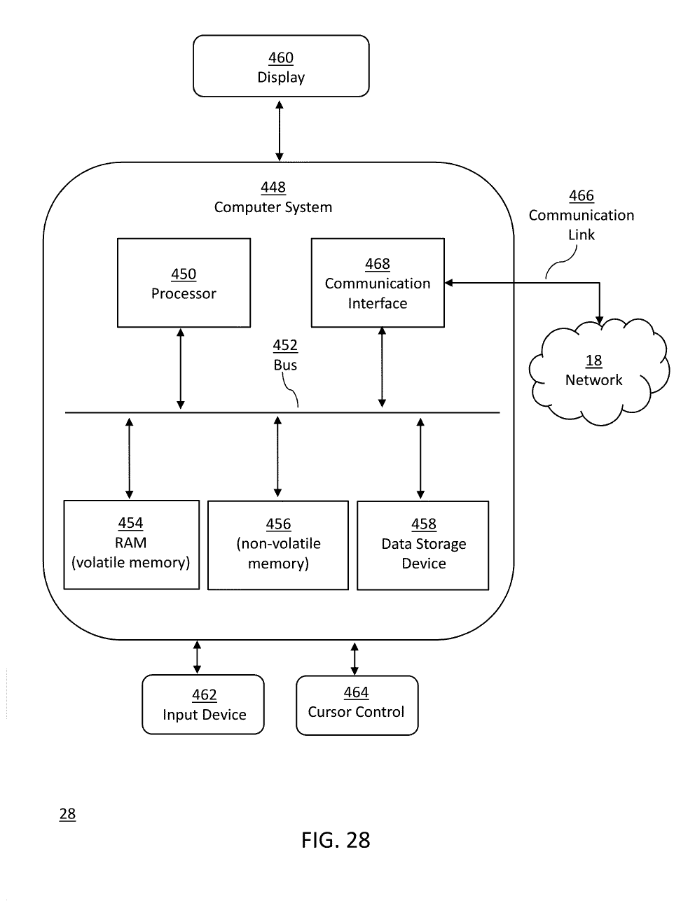

FIG. 28 is a block diagram that illustrates an exemplary computing device 28 for use in the global medical data analysis system 10. A computer system 448 includes a processor 450 for processing information, and the processor 450 is coupled to a bus 452 or other communication medium for sending and receiving information. The processor 450 may be an example of the processor 450 of FIG. 28, or another processor that is used to perform various functions described herein. In some cases, the computer system 448 may be used to implement the processor 450 as a system-on-a-chip integrated circuit. The computer system 448 also includes the main memory 454, such as a random access memory (RAM) or other dynamic storage device, coupled to the bus 452 for storing information and instructions to be executed by the processor 450. The main memory 454 also may be used for storing temporary variables or other intermediate information during execution of instructions by the processor 450. The computer system 448 further includes a read only memory (ROM) 456 or other static storage device coupled to the bus 452 for storing static information and instructions for the processor 450. A data storage device 458, such as a magnetic disk (e.g., a hard disk drive), an optical disk, or a flash memory, is provided and coupled to the bus 452 for storing information and instructions. The computer system 448 (e.g., desktops, laptops, tablets) may operate on any operating system platform using Windows® by Microsoft Corporation, MacOS or iOS by Apple Inc., Linux, UNIX, and/or Android by Google Inc.

The computer system 448 may be coupled via the bus 452 to a display 460, such as a flat panel for displaying information to a user. An input device 462, including alphanumeric, pen or finger touchscreen input, and other keys, is coupled to the bus 452 for communicating information and command selections to the processor 450. Another type of user input device is cursor control 464, such as a mouse (either wired or wireless), a trackball, a laser remote mouse control, or cursor direction keys for communicating direction information and command selections to the processor 450 and for controlling cursor movement on the display 460. This input device typically has two degrees of freedom in two axes, a first axis (e.g., x) and a second axis (e.g., y), that allows the device to specify positions in a plane.

The processes and modules described with respect to FIGS. 1-28 can be continuously improved over a period of time with the collection and analysis of additional data such that the intelligent medical engine 14 is capable of functioning like an electronic medical doctor that provides a recommended treatment with a high degree of reliability and effectiveness based on a patient's objective medical data.

The computer system 448 may be used for performing various functions (e.g., computations, calculations, etc.) in accordance with the embodiments described herein. According to one embodiment, such use is provided by the computer system 448 in response to the processor 450 executing one or more sequences of one or more instructions contained in the main memory 454. Such instructions may be read into the main memory 454 from another computer-readable medium, such as a data storage device 458. Execution of the sequences of instructions contained in the main memory 454 causes the processor 450 to perform the process steps described herein. One or more processors in a multi-processing arrangement may also be employed to execute the sequences of instructions contained in the main memory 454. In alternative embodiments, hard-wired circuitry may be used in place of or in combination with software instructions to implement the disclosure. Thus, embodiments of the disclosure are not limited to any specific combination of hardware circuitry and software.

The term “computer-readable medium” as used herein refers to any medium that participates in providing instructions to the processor 450 for execution. Common forms of computer-readable media include, but are not limited to, non-volatile media, volatile media, transmission media, a floppy disk, a flexible disk, a hard disk, magnetic tape, any other magnetic medium, a CD-ROM, a DVD, a Blu-ray Disc, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read. Non-volatile media includes, for example, optical or magnetic disks, such as the data storage device 458. Volatile media includes dynamic memory, such as the main memory 454. Transmission media includes coaxial cables, copper wire, and fiber optics. Transmission media can also take the form of acoustic or light waves, such as those generated during radio wave and infrared data communications. Transmission media can also include wireless networks, such as WiFi and cellular networks.

Various forms of computer-readable media may be involved in carrying one or more sequences of one or more instructions to the processor 450 for execution. For example, the instructions may initially be carried on a magnetic disk of a remote computer. The remote computer can load the instructions into its dynamic memory and send the instructions over a communication link 466. The computer system 448 includes a communication interface 468 for receiving the data on the communication link 466. The bus 452 carries the data to the main memory 454, from which the processor 450 retrieves and executes the instructions. The instructions received by the main memory 454 may optionally be stored on the data storage device 458 either before or after execution by the processor 450.

The communication interface 468, which is coupled to the bus 452, provides a two-way data communication coupling to the communication link 466 that is connected to a network 18. For example, the communication interface 468 may be implemented in a variety of ways, including but not limited to communications interfaces for communicating over an integrated services digital network (ISDN), a local area network (LAN), a Wireless Local Area Network (WLAN), a Wide Area Network (WAN), Bluetooth, and a cellular data network (e.g. 3G, 4G, 5G, and beyond). In wireless links, the communication interface 468 sends and receives electrical, electromagnetic, or optical signals that carry data streams representing various types of information.

The medical main server 12 can be implemented as a networked computer system or a dedicated computer system operating in a client-server architecture or in a cloud-computing environment. In one embodiment, the cloud computer is a browser-based operating system communicating through an Internet-based computing network that involves the provision of dynamically scalable and often virtualized resources as a service over the Internet, such as iCloud® available from Apple Inc. of Cupertino, Calif., Amazon Web Services (IaaS) and Elastic Compute Cloud (EC2) available from Amazon.com, Inc. of Seattle, Wash., SaaS and PaaS available from Google Inc. of Mountain View, Calif., Microsoft Azure Service Platform (Paas) available from Microsoft Corporation of Redmond, Wash., Sun Open Cloud Platform available from Oracle Corporation of Redwood City, Calif., and other cloud computing service providers.

The web browser is a software application for retrieving, presenting, and traversing a Uniform Resource Identifier (URI) on the World Wide Web provided by the cloud computer or web servers. One common type of URI begins with Hypertext Transfer Protocol (HTTP) and identifies a resource to be retrieved over the HTTP. A web browser may include, but is not limited to, browsers running on personal computer operating systems and browsers running on mobile phone platforms. The first type of web browsers may include Microsoft's Internet Explorer, Apple's Safari, Google's Chrome, and Mozilla's Firefox. The second type of web browsers may include the iPhone OS, Google Android, Nokia S60, and Palm WebOS. Examples of a URI include a web page, an image, a video, or other type of content.

The network 18 can be implemented as a wireless network, a wired network protocol or any suitable communication protocols, such as 3G (3rd generation mobile telecommunications), 4G (fourth-generation of cellular wireless standards), long term evolution (LTE), 5G, a wide area network (WAN), Wi-Fi™ like wireless local area network (WLAN) 802.11n, or a local area network (LAN) connection (internetwork—connected to either WAN or LAN), Ethernet, Bluebooth™, high frequency systems (e.g., 900 MHz, 2.4 GHz, and 5.6 GHz communication systems), infrared, transmission control protocol/internet protocol (TCP/IP) (e.g., any of the protocols used in each of the TCP/IP layers), hypertext transfer protocol (HTTP), BitTorrent™, file transfer protocol (FTP), real time transport protocol (RTP), real time streaming protocol (RTSP), secure shell protocol (SSH), any other communications protocol and other types of networks like a satellite, a cable network, or an optical network set-top boxes (STBs). A SmartAuto includes an auto vehicle with a processor, a memory, a screen, with connection capabilities of Wireless Local Area Network (WLAN) and Wide Area Network (WAN), or an auto vehicle with a telecommunication slot connectable to a mobile device, such as an iPod, iPhone, or iPad. A SmartTV includes a television system having a telecommunication medium for transmitting and receiving moving video images (either monochromatic or color), still images and sound. The television system operates as a television, a computer, an entertainment center, and a storage device. The telecommunication medium of the television system includes a television set, television programming, television transmission, cable programming, cable transmission, satellite programming, satellite transmission, Internet programming, and Internet transmission.

Some portions of the above description describe the embodiments in terms of algorithmic descriptions and processes, e.g. as with the description within FIGS. 1-28. These operations (e.g., the processes described above), while described functionally, computationally, or logically, are understood to be implemented by computer programs or equivalent electrical circuits, microcode, or the like. The computer programs are typically embedded as instructions that can be stored on a tangible computer readable storage medium (e.g., flash drive disk, or memory) and are executable by a processor, for example, as described in FIGS. 1-28. Furthermore, it has also proven convenient at times to refer to these arrangements of operations as modules, without loss of generality. The operations described and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to “an inclusive or” and “not to an exclusive or”. For example, a condition A or B is satisfied by any one of the following: A is true (or present) and B is false (or not present), A is false (or not present) and B is true (or present), and both A and B are true (or present).

The terms “a” or “an,” as used herein, are defined as one or more than one. The term “plurality,” as used herein, is defined as two or more than two. The term “another,” as used herein, is defined as at least a second or more.

The term “subject” as used herein can be used to refer to an asymptomatic or symptomatic patient. A patient may be asymptomatic or symptomatic for one or more diseases or conditions.

The disclosure can be implemented in numerous ways, including as a computational method of process, an apparatus, and a system. In this specification, these implementations, or any other form that the disclosure may take, may be referred to as techniques. In general, the order of the connections of disclosed apparatus may be altered within the scope of the disclosure.

The present disclosure has been described in particular detail with respect to one possible embodiment. Those skilled in the art will appreciate that the disclosure may be practiced in other embodiments. First, the particular naming of the components, capitalization of terms, the attributes, data structures, or any other programming or structural aspect is not mandatory or significant, and the mechanisms that implement the disclosure or its features may have different names, formats, or protocols. Further, the system may be implemented via a combination of hardware and software, as described, or entirely in hardware elements. In addition, the particular division of functionality between the various system components described herein is merely exemplary, and not mandatory; functions performed by a single system component may instead be performed by multiple components, and functions performed by multiple components may instead be performed by a single component.

An ordinary artisan should require no additional explanation in developing the methods and systems described herein but may find some possibly helpful guidance in the preparation of these methods and systems by examining standard reference works in the relevant art.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

### EXAMPLES

The examples illustrate exemplary methods provided herein. These examples are not intended, nor are they to be construed, as limiting the scope of the disclosure. It will be clear that the methods can be practiced otherwise than as particularly described herein. Numerous modifications and variations are possible in view of the teachings herein and, therefore, are within the scope of the disclosure.

When a new cancer patient visits a health care provider, the new patient's medical history, lab work, and images from CT, X-ray, PET scan, and mammogram are gathered and inputted into the computer system. If further tests need to be performed such as lab work for tumor markers, they are performed and the results inputted into the computer system. Once all the information regarding the patient is entered into the computer system, the physician can use the process provided by the computer system disclosed herein to obtain a course of treatment for the patient. The computer-implemented method comprises degrouping a plurality of patients' objective medical data to classify the data into subgroups. The objective medical data includes patients' parameters. The computer system recommends an optimal course of treatment including a treatment protocol and treatment plan based on all the new patient's medical information.

### Example 1

### Determining a Course of Treatment for a Patient with Breast Cancer

For breast cancer, the first level parameters may include tumor features such as the following: (1) invasive or in situ; (2) if invasive, whether the tumor has metastasized; (3) ductal or lobular; (4) stage; and (5) grade.

The second level parameters may include the presence of tumor markers, such as estrogen receptor (ER), progesterone receptor (PR), human epidermal growth factor receptor 2 (HER2), cancer antigen 15-3 (CA 15-3), cancer antigen 27.29 (CA 27.29), and carcinoembryonic antigen (CEA), urokinase plasminogen activator (uPA), and plasminogen activator inhibitor (PAI-1).

The third level parameters may include the patient's general conditions such as age, personal history of breast cancer (if recurrence) and ovarian cancer, family history of breast cancer, inherited risk and genetic risk (presence of mutations in breast cancer genes 1 or 2 (BRCA 1 or 2)), exposure to estrogen and progesterone, hormone replacement therapy after menopause, oral contraceptives, and race and ethnicity.

The fourth level parameters may include the lifestyle and habits of the patient such as weight, level of physical activity, alcohol consumption, and food consumption (fruits and vegetables vs. animal fats).

The conventional course of treatment for a breast cancer patient who tests positive for ER and PR is hormone therapy. Depending on all the parameters associated with the patient, the computer system can recommend a specific hormone therapy such as a specific aromatase inhibitor, a selective estrogen receptor modulator, or an estrogen receptor downregulator. However, also depending on the other parameters associated with the patient, the computer system can recommend a specific hormone therapy and an additional course of treatment for the patient. The computer system can recommend hormone therapy in addition to surgically removing the ovaries and fallopian tubes as a preventative measure.

A triple negative breast cancer patient (a patient whose breast cancer cells that do not express the genes for ER, PR, and HER2) would not benefit from hormone therapy. Depending on all the parameters associated with the patient, the computer system can recommend chemotherapy, radiation therapy, surgery, or a combination thereof based on the computational analysis of medical data in the system. For example, the computer system can recommend mastectomy over lumpectomy as a form of surgery. Alternatively, the computer system can recommend a specific dosage of chemotherapy.

### Example 2

### Determining Course of Treatment for a Patient with Lung Cancer

For lung cancer, the first level parameters may include: (1) type; (2) stage; and (3) grade.

The second level parameters may include presence of mutations of oncogenes for determining whether a patient would benefit from NSCLC targeted therapies. Such oncogenes include (1) epidermal growth factor receptor (EGFR); (2) Kirsten rat sarcoma onocogene homolog (KRAS); and (3) anaplastic lymphoma kinase (ALK). The second level parameters may also include markers of neuroendocrine differentiation of small cell lung cancer, such as (1) creatine kinase-BB, (2) chromogranin, and (3) neuron specific enolase; and of small peptide hormones, such as (1) gastrin-releasing peptide, (2) calcitonin, and (3) serotonin.

The third level parameters may include the patient's general conditions such as age, personal history of lung cancer, family history of lung cancer, and race and ethnicity.

The fourth level parameters may include the lifestyle and habits of the patient such as weight, level of physical activity, alcohol consumption, smoking habits, exposure to second-hand smoke, and food consumption (fruits and vegetables vs. animal fats).

Lung cancer patients are usually treated by chemotherapy, surgery, radiation therapy, and/or targeted therapy. Depending on all the parameters associated with the patient, the computer system can recommend a combination of therapies as the course of treatment for the lung cancer patient based on the computational analysis of the medical data in the system. For example, chemotherapy may be recommended before or after surgery, and chemotherapy may be recommended in combination with radiation therapy. The computer system can also recommend a specific surgery such as lobectomy, segmentectomy, or pneumonectomy.

Depending on whether the patient has a mutation in an oncogene, the computer system can recommend targeted therapies that block the oncogene. For example, erlotinib and gefitinib are drugs that have been used to block EGFR. Gilotrif is a tyrosine kinase inhibitor that stops uncontrolled cell growth caused by a mutation in the EGFR gene. Crizotinib is used to treat advanced NSCLC that has a mutation in the ALK gene.

What is claimed and desired to be secured by Letters Patent of the United States is:

1. A computer-implemented method for processing electronic medical records, comprising:
storing a plurality of objective medical data for a plurality of patients, each patient's objective medical data being structured into multiple elements for use in storing the objective medical data, each patient's objective medical data containing at least parameters of the patient, diseases of the patients, treatments that the patient underwent and outcomes of the treatments;
degrouping the plurality of patients' objective medical data to classify the plurality of objective medical data into subgroups, the classifying step including at least one level of classifications based on each patient's parameters, disease, and treatment that each patient underwent for the disease, and the outcome of the treatment, iteratively repeating the process, once for each subgroup in each level, until a set of subgroups smaller than the previously generated subgroups are identified wherein the patients in the smaller subgroups have substantially similar clinically-relevant parameters and substantially similar outcomes;
receiving a new patient's disease template with the new patient's objective medical data based on the patient's disease, the new patient's template including at least the clinically-relevant parameters of the new patient, and at least one disease of the new patient; and
matching the new patient's parameters and disease to the corresponding parameters and disease of the degrouped subgroups to select the most similar ones and determine the likely outcomes of potential treatments for the new patient based on the outcomes of treatments for the patients in the subgroups.

2. The method of claim 1, wherein the degrouping of the plurality of patients' objective medical data into subgroups, as well as the classifying step of matching the new patient's disease template includes multiple levels of classifications beginning with a first set of parameters, followed by a second set of parameters, and continuing this iterative process until a small similar group is identified with consistent outcomes for the treatment of the diseases, and filtered relative to the new patient's objective medical data.

3. The method of claim 1, wherein the degrouping is repeated when a plurality of objective medical data corresponding to new or existing patients is added to the storage of the system so as to create a significant change in the entropy of any subgroups, said change to be deemed significant if larger than three percent (3%).

4. The method of claim 1, wherein the subgroups produced by degrouping will be merged into larger groups if there is no statistically significant difference in the patients' response to the resulting treatment, where significance is determined by a two-tailed t-test at the p<0.05 level.

5. The method of claim 1, wherein the patient's response to treatment is a vector of responses corresponding to a trajectory over time, rather than a single value.

6. The method of claim 1, wherein the degrouping step comprises the use of the entropy (H) of a group of patients G and is computed from the following equation, wherein p(t(qᵢ)=R) is the probability that a patient qᵢ receiving treatment t will have outcome R, and H(G) is the entropy of the group of patients G:
$$H ( G ) = - {\sum }_{i = 1 , … \vert G \vert} p ( t ( {q}_{i} ) = R ) {log}_{2} ( p ( t ( {q}_{i} ) = R ) ) .$$

7. The method of claim 6, wherein the degrouping step comprises the use of conditional entropy for each subgroup of patients G when a particular attribute a has a value above a threshold value and is computed from the following equation, wherein x₁ through xₙ are one or more selected patient parameters:
H(G|x₁>thresh(x₁), . . . ,xₖ>thresh(xₖ).

8. The method of claim 6, wherein the degrouping step comprises the use of conditional entropy for each subgroup of patients G when a particular attribute a has a value below a threshold value and is computed from the following equation, wherein x₁ through xₙ, are one or more selected patient parameters:
H(G|x₁>thresh(x₁), . . . ,xₖ<thresh(xₖ).

9. The method of claim 6, wherein the degrouping step comprises the use of conditional entropy for each subgroup of patients G when a particular attribute a has a value equal to a threshold value and is computed from the following equation, wherein x₁ through xₙ, are one or more selected patient parameters:
H(G|x₁>thresh(x₁), . . . ,xₖ=thresh(xₖ)).

10. The method of claim 7, wherein the degrouping process determines an attribute that maximally reduces the total entropy, represented by the following equation, wherein the argmax operator selects the one or more patient parameters xᵢ from larger set of patient parameters X that maximize the reduction in entropy, and I(G,A) is the information gain:
I(G,A)=H(G)−Argmaxₓ_{ᵢ}_{εX}[H(G|x₁>thresh(x₁), . . . ,xₖ>thresh(xₖ)].

11. The method of claim 8, wherein the degrouping process determines an attribute that maximally reduces the total entropy, represented by the following equation, wherein the argmax operator selects the one or more patient parameters xᵢ from larger set of patient parameters X that maximize the reduction in entropy, and I(G,A) is the information gain:
I(G,A)=H(G)−Argmaxₓ_{ᵢ}_{εX}[H(G|x₁>thresh(x₁), . . . ,xₖ<thresh(xₖ)].

12. The method of claim 9, wherein the degrouping process determines an attribute that maximally reduces the total entropy, represented by the following equation, wherein the argmax operator selects the one or more patient parameters xᵢ from larger set of patient parameters X that maximize the reduction in entropy, and I(G,A) is the information gain:
I(G,A)=H(G)−Argmaxₓ_{ᵢ}_{εX}[H(G|x₁>thresh(x₁), . . . ,xₖ=thresh(xₖ)].

13. The method of claim 1, wherein the matching of the parameters of the new patient with the parameters of the degrouped subgroups is calculated by calculating the differences between respective parameters of the new patient and subgroup, and then summing these differences, and selecting the subgroup with the minimal sum of differences to the new patient's parameters.

14. The method of claim 1, wherein the matching of the parameters of the new patient with the parameters of the degrouped subgroups is calculated by counting the number of differences between respective parameters of the new patient and subgroup, and selecting the subgroup with the fewest different parameters to the new patient's parameters.

15. The method of claim 1, wherein the matching of the parameters of the new patient with the parameters of the degrouped subgroups is calculated by calculating the differences between respective parameters of the new patient and subgroup, and then summing the squares of these differences, and selecting the subgroup with the smallest sum of squared differences to the new patient's parameters.

16. The method of claim 1, wherein the sum of differences between the parameters yᵢ of patient Q and the parameters g(xᵢ) of subgroup G and where p is a mathematical norm, by default set to 1, is calculated by:
BestMatch(Q,G)=Argmin_{g}_{ⱼ}_{εG}[Σ_{i=1, . . . ,k}∥gⱼ(xᵢ_{_{—}})−yᵢ∥ₚ].

17. The method of claim 1, prior to receiving the new patient's template, further comprising degrouping the plurality of patients' objective medical data to classify the plurality of objective medical data into subgroups, the classifying step including at least one level of classifications based on each patient's parameters, disease, and treatment that each patient underwent for the disease, and the outcome of the treatment, iteratively repeating the process for each subgroup until a set of smaller subgroups are identified wherein the patients in the smaller subgroups have substantially similar parameters and substantially similar outcomes.

18. The method of claim 1, wherein the parameters of the patient are augmented by attributes derived from the original parameters by automated processes of transformations and combinations of the original patient parameters.

19. The method of claim 18, wherein the patient parameters are transformed into normalized ranges for the patient population as a whole, the normalization computation for attribute a and parameter p, corresponding to the equation:
$$a = \frac{actual ( p ) - min ( p )}{max ( p ) - min ( p )}$$

20. The method in claim 19, wherein the normalization is over the patient population in a subgroup.

21. The method of claim 20, wherein the patient parameters are transformed into percentiles for the patient population as a whole.

22. The method of claim 21, wherein the percentiles apply to the population of patients in a subgroup.

23. The method of claim 1, wherein the first level patient parameters comprise parameters related to the primary disease and to the general clinical conditions of the patient, and a second set of parameters related to secondary disease.

24. The method of claim 23, wherein the general clinical condition of the patient is measured by the Karnofsky scale.

25. A computer implemented method of identifying a course of treatment for a new patient, the method comprising:
storing a plurality of objective medical data for a plurality of patients in a computer system, each patient's objective medical data being structured into multiple elements for use in storing the objective medical data, each patient's objective medical data containing at least parameters of the patient, diseases of the patients, treatments that the patient underwent and outcomes of the treatments;
degrouping the plurality of patients' objective medical data to classify the plurality of objective medical data into subgroups, the classifying step including at least one level of classifications based on each patient's parameters, disease, and treatment that each patient underwent for the disease, and the outcome of the treatment, iteratively repeating the process for each subgroup until a set of smaller subgroups are identified wherein the patients in the smaller subgroups have substantially similar clinically-relevant parameters and substantially similar outcomes;
receiving and inputting a new patient's disease template with the new patient's objective medical data based on the patient's disease into the computer system, the new patient's template including at least the clinically-relevant parameters of the new patient, and at least one disease of the new patient; and
matching the new patient's parameters and disease to the corresponding parameters and disease of the degrouped subgroups to select the most similar ones and determine the likely outcomes of potential treatments for the new patient based on the outcomes of treatments for the patients in the subgroups to obtain a course of treatment for the new patient.

26. The method of claim 25, wherein the first level patient parameters comprise parameters related to the primary disease and to the general clinical conditions of the patient, and a second set of parameters related to secondary disease.

27. The method of claim 26, wherein the general clinical condition of the patient is measured by the Karnofsky scale.

28. The method of claim 27, wherein the process comprises degrouping based on multiple different sets of parameters, wherein each set of parameters defines a level for degrouping and the degrouping proceeds sequentially starting at the first level.

29. The method of claim 27, wherein the new patient has been diagnosed with cancer, cardiovascular disease, neurological disease, or an autoimmune disease.

30. The method of claim 29, wherein the cancer is lung cancer, prostate cancer, liver cancer, breast cancer, leukemia, ovarian cancer, pancreatic cancer, skin cancer, or colon cancer.

31. The method of claim 30, wherein the first set of parameters comprise: type of cancer cells; the stage of cancer; and the grade of cancer.

32. The method of claim 31, wherein the second set of parameters comprise the presence of specific tumor markers and complications associated with the cancer.

33. The method of claim 32, wherein the third set of parameters comprise the new patient's age, personal medical history with cancer, inherited risk and genetic risk for cancer, race, and ethnicity.

34. The method of claim 33, wherein the fourth set of parameters comprise the new patient's weight, level of physical activity, alcohol consumption, smoking habits, exposure to second-hand smoke, and food consumption.

35. The method of claim 34, wherein the cardiovascular disease is heart failure.

36. The method of claim 35, wherein the first set of parameters comprise: type of heart failure; stage of heart disease; and grade of heart disease.

37. The method of claim 36, wherein the second level parameters comprise presence of markers associated with heart disease and complications associated with heart disease.

38. The method of claim 37, wherein the third level parameters include the new patient's age, personal history of heart disease, family history of heart disease, diabetes, high blood pressure, dyslipidemia/hypercholesterolemia, and race and ethnicity.

39. The method of claim 38, wherein the fourth level parameters include the patient's weight, level of physical activity, smoking habits, alcohol consumption, food intake, and stress level of job.

40. The method of claim 27, wherein the objective medical data obtained for the new patient comprises one or more of the following: new patient's symptoms, medical history, laboratory test results, and physician's notes.

41. The method of claim 27, wherein the degrouping step comprises the use of the entropy (H) of a group of patients G and is computed from the following equation, wherein p(t(qᵢ)=R) is the probability that a patient qᵢ receiving treatment t will have outcome R, and H(G) is the entropy of the group of patients G:
H(G)=−Σ_{i=1, . . . |G|}p(t(qᵢ)=log₂(p(t(qᵢ)=R)).

42. The method of claim 41, wherein the degrouping step comprises the use of conditional entropy for each subgroup of patients G when a particular attribute a has a value above a threshold value and is computed from the following equation, wherein x₁ through xₙ are one or more selected patient parameters:
H(G|x₁>thresh(x₁), . . . ,xₖ>thresh(xₖ).

43. The method of claim 41, wherein the degrouping step comprises the use of conditional entropy for each subgroup of patients G when a particular attribute a has a value below a threshold value and is computed from the following equation, wherein x₁ through xₙ are one or more selected patient parameters:
H(G|x₁>thresh(x₁), . . . ,xₖ<thresh(xₖ).

44. The method of claim 41, wherein the degrouping step comprises the use of conditional entropy for each subgroup of patients G when a particular attribute a has a value equal to a threshold value and is computed from the following equation, wherein x₁ through xₙ are one or more selected patient parameters:
H(G|x₁>thresh(x₁), . . . ,xₖ=thresh(xₖ)).

45. The method of claim 42, wherein the degrouping process determines an attribute that maximally reduces the total entropy, represented by the following equation, wherein the argmax operator selects the one or more patient parameters xᵢ from larger set of patient parameters X that maximize the reduction in entropy, and I(G,A) is the information gain:
I(G,A)=H(G)−Argmaxₓ_{ᵢ}_{εX}[H(G|x₁>thresh(x₁), . . . ,xₖ>thresh(xₖ)].

46. The method of claim 43, wherein the degrouping process determines an attribute that maximally reduces the total entropy, represented by the following equation, wherein the argmax operator selects the one or more patient parameters xᵢ from larger set of patient parameters X that maximize the reduction in entropy, and I(G,A) is the information gain:
I(G,A)=H(G)−Argmaxₓ_{ᵢ}_{εX}[H(G|x₁>thresh(x₁), . . . ,xₖ<thresh(xₖ)].

47. The method of claim 44, wherein the degrouping process determines an attribute that maximally reduces the total entropy, represented by the following equation, wherein the argmax operator selects the one or more patient parameters xᵢ from larger set of patient parameters X that maximize the reduction in entropy, and I(G,A) is the information gain:
I(G,A)=H(G)−Argmaxₓ_{ᵢ}_{εX}[H(G|x₁>thresh(x₁), . . . ,xₖ=thresh(xₖ)].

48. The method of claim 27, wherein the matching of the parameters of the new patient with the parameters of the degrouped subgroups is calculated by calculating the differences between respective parameters of the new patient and subgroup, and then summing these differences, and selecting the subgroup with the minimal sum of differences to the new patient's parameters.

49. The method of claim 27, wherein the matching of the parameters of the new patient with the parameters of the degrouped subgroups is calculated by counting the number of differences between respective parameters of the new patient and subgroup, and selecting the subgroup with the fewest different parameters to the new patient's parameters.

50. The method of claim 27, wherein the matching of the parameters of the new patient with the parameters of the degrouped subgroups is calculated by calculating the differences between respective parameters of the new patient and subgroup, and then summing the squares of these differences, and selecting the subgroup with the smallest sum of squared differences to the new patient's parameters.

51. The method of claim 27, wherein the sum of differences between the parameters of patient Q and those of subgroup G is calculated by:
BestMatch(Q,G)=Argmin_{g}_{ⱼ}_{εG}[Σ_{i=1, . . . ,k}∥gⱼ(xᵢ_{_{—}})−yᵢ∥ₚ].

52. The method of claim 27, prior to degrouping the new patient's objective medical data, further comprising degrouping the plurality of patients' objective medical data to classify the plurality of objective medical data into subgroups, the classifying step including at least one level of classifications based on each patient's parameters, disease, and treatment that each patient underwent for the disease, and the outcome of the treatment, iteratively repeating the process for each subgroup until a set of smaller subgroups are identified wherein the patients in the smaller subgroups have substantially similar parameters and substantially similar outcomes.

53. The method of claim 27, wherein the parameters of the patient are augmented by attributes derived from the original parameters by automated processes of transformations and combinations of the original patient parameters.

54. The method of claim 53, wherein the patient parameters are transformed into normalized ranges for the patient population as a whole, the normalization computation for attribute a and parameter p, corresponding to the equation:
a=(actual(p)−min [symbol] (p))/(max [symbol] (p)−min [symbol] (p))min

[symbol]

55. The method in claim 54, wherein the normalization is over the patient population in a subgroup.

56. The method of claim 55, wherein the patient parameters are transformed into percentiles for the patient population as a whole

57. The method of claim 56, wherein the percentiles apply to the population of patients in a subgroup

58. The method of claim 27, wherein the method provides an estimate of a degree of likelihood that the course of treatment for the new patient improves the patient's clinical condition.

59. The method of claim 27, wherein the method provides a plurality of potential course of treatments for the new patient.

60. The method of claim 27, wherein the new patient's objective data is stored in the computer system.

61. The method of claim 27, wherein the identified course of treatment is transmitted to a health care provider.

62. A computer-implemented method for processing electronic medical records, comprising:
storing a plurality of objective medical data for a plurality of patients, each patient's objective medical data being structured into multiple elements for use in storing the objective medical data, each patient's objective medical data containing at least parameters of the patient, diseases of the patients, treatments that the patient underwent and outcomes of the treatments;
degrouping the plurality of patients' objective medical data to classify the plurality of objective medical data into subgroups, the classifying step including at least one level of classifications based on each patient's parameters, disease, and treatment that each patient underwent for the disease, and the outcome of the treatment, iteratively repeating the process for each subgroup until a set of smaller subgroups are identified wherein the patients in the smaller subgroups have substantially similar clinically-relevant parameters and substantially similar outcomes;
receiving an individual patient's disease template with the new patient's objective medical data based on the patient's disease, the new patient's template including at least the clinically-relevant parameters of the new patient, and at least one disease of the new patient; and
matching the individual patient's parameters and disease to the corresponding parameters and disease of the degrouped subgroups to select the most similar ones and determine the likely outcomes of potential treatments for the new patient based on the outcomes of treatments for the patients in the subgroups.

63. A computer-implemented method for processing electronic medical records, comprising:
storing a plurality of objective medical data for a plurality of patients, each patient's objective medical data being structured into multiple elements for use in storing the objective medical data;
receiving an individual patient's template with the patient's objective medical data based on the patient's disease; and
degrouping the patient's objective medical data with the plurality of objective medical data to classify the plurality of objective medical data into subgroups, wherein the classifying step comprises multiple levels of classifications beginning with a first set of parameters, followed by an additional sets of parameters, and continuing this process until matching the patient's parameters and disease to the degrouped subgroups to determine the likely outcomes of the potential treatments for the patient based on the outcomes of treatments for the patients in the subgroups.

64. The method of claim 63, wherein the degrouping the plurality of objective medical data into a first subgroup is based on the first set of parameters.

65. The method of claim 54, wherein the degrouping the plurality of objective medical data in the first subgroup into a second subgroup based on the second set of parameters, the second subgroup having a lesser number of objective medical data relative to the first subgroup.

66. The method of claim 65, wherein the additional step of degrouping the plurality of objective medical data in the second subgroup into a third subgroup based on the third set of parameters, the third subgroup having a lesser number of objective medical data relative to the second subgroup.

67. A method of identifying a course of treatment for a new patient, the method comprising:
receiving and inputting a new patient's disease template with the new patient's objective medical data based on the patient's disease into a computer system, the new patient's template including at least the clinically-relevant parameters of the new patient, and at least one disease of the new patient;
degrouping a plurality of patients' objective medical data stored in a computer system to classify the plurality of objective medical data into subgroups, the classifying step including at least one level of classifications based on each patient's parameters, disease, and treatment that each patient underwent for the disease, and the outcome of the treatment, iteratively repeating the process for each subgroup until a set of smaller subgroups are identified wherein the patients in the smaller subgroups have substantially similar clinically-relevant parameters and substantially similar outcomes; and
matching the new patient's parameters and disease to the corresponding parameters and disease of the degrouped subgroups to select the most similar ones and determine the likely outcomes of potential treatments for the new patient based on the outcomes of treatments for the patients in the subgroups to obtain a course of treatment for the new patient.

68. A system, comprising:
a storing module configured to store a plurality of objective medical data for a plurality of patients, each patient's objective medical data being structured into multiple elements for use in storing the objective medical data, each patient's objective medical data containing at least parameters of the patient, diseases of the patients, treatments that the patient underwent and outcomes of the treatments;
a degrouping module, communicatively coupled to the storing module, configured to degroup the plurality of patients' objective medical data to classify the plurality of objective medical data into subgroups, the classifying step including at least one level of classifications based on each patient's parameters, disease, and treatment that each patient underwent for the disease, and the outcome of the treatment, iteratively repeating the process, once for each subgroup in each level, until a set of subgroups smaller than the previously generated subgroups are identified wherein the patients in the smaller subgroups have substantially similar clinically-relevant parameters and substantially similar outcomes;
an input module configured to receive a new patient's disease template with the new patient's objective medical data based on the patient's disease, the new patient's template including at least the clinically-relevant parameters of the new patient, and at least one disease of the new patient; and
a matching module, communicatively coupled to the degrouping module and the input module, configured to match the new patient's parameters and disease to the corresponding parameters and disease of the degrouped subgroups to select the most similar ones and determine the likely outcomes of potential treatments for the new patient based on the outcomes of treatments for the patients in the subgroups.

69. A computer program product, comprising: a non-transitory computer-readable medium having computer-readable program instructions embodied therein that when executed by a computer cause the computer to process return transactions, the computer-readable program instructions comprising:
computer-readable program instructions to store module configured to store a plurality of objective medical data for a plurality of patients, each patient's objective medical data being structured into multiple elements for use in storing the objective medical data, each patient's objective medical data containing at least parameters of the patient, diseases of the patients, treatments that the patient underwent and outcomes of the treatments;
computer-readable program instructions to degroup the plurality of patients' objective medical data to classify the plurality of objective medical data into subgroups, the classifying step including at least one level of classifications based on each patient's parameters, disease, and treatment that each patient underwent for the disease, and the outcome of the treatment, iteratively repeating the process, once for each subgroup in each level, until a set of subgroups smaller than the previously generated subgroups are identified wherein the patients in the smaller subgroups have substantially similar clinically-relevant parameters and substantially similar outcomes;
computer-readable program instructions to receive a new patient's disease template with the new patient's objective medical data based on the patient's disease, the new patient's template including at least the clinically-relevant parameters of the new patient, and at least one disease of the new patient; and
computer-readable program instructions to match the new patient's parameters and disease to the corresponding parameters and disease of the degrouped subgroups to select the most similar ones and determine the likely outcomes of potential treatments for the new patient based on the outcomes of treatments for the patients in the subgroups.
